(19) United States
(12) Patent Application Publication
(10) Pub. No.: US 2008/0240673 A1
(43) Pub. Date: Oct. 2, 2008

(54) PLAYBACK APPARATUS, PLAYBACK METHOD, DISTRIBUTION SERVER, DISTRIBUTION METHOD, RECORDING MEDIUM AND INTEGRATED CIRCUIT

(76) Inventors: Sanzo Ugawa, Osaka (JP); Senichi Onoda, Osaka (JP); Toshihisa Nakano, Osaka (JP); Shunji Harada, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/056,579

(22) Filed: Mar. 27, 2008

(30) Foreign Application Priority Data
Mar. 30, 2007 (JP) 2007-092013

(51) Int. Cl. H04N 5/93

(52) U.S. Cl. 386/55; 386/E05.028

(57) ABSTRACT

The present invention aims at providing a playback apparatus that performs playback control so as to prevent, in playback of content recorded on a recording medium, a decline of the value of the recording medium and content.

In the case of having failed in reading of content data from the recording medium, as well as in the case of determining the necessity of content data replacement, the playback apparatus of the present invention acquires, from the distribution server, pieces of partial content data corresponding to locations at and following the reading failure, as well as pieces of replacement content data corresponding to locations whose data needs to be replaced. The playback apparatus plays back content data recorded on the recording medium and partial content data and replacement content data acquired from the content distribution server.

This application is based on an application No. 2007-092013 filed in Japan, the content of which is hereby incorporated by reference.

### BACKGROUND OF THE INVENTION

1. Field of the Invention

The present invention relates to a technology for playing back digital content stored in a high-capacity recording medium, such as an optical disk, and especially relates to a technology for allowing to provide a high-capacity recording medium whose value to the user is not changed over a period of time.

2. Description of the Related Art

Package media in which movies or other types of digital content (hereinafter, simply referred to as “content”) are recorded on optical discs, such as Blu-ray Disk (registered trademark) ROM (BD-ROM), are available for users. BD-ROM is sold at the moment as a bare disk, i.e. the disk not housed in a cartridge. Because housed in no cartridge, a bare disk has a disadvantage in that the disk body is easily damaged. If the disk body is damaged, a playback apparatus is not able to read data on the disk, and accordingly the user cannot watch and/or listen to the content purchased.

It is sometimes the case that content recorded in BD-ROM includes, besides main content like a movie, additional content such as making scenes from the movie, cast interviews, director's commentary and advertisements. Advertisements of new package media release, preview of movies and the like often include video, audio and text which are associated with a date. Such additional content is beneficial for neither the users nor the advertisers if it is played back after the certain date. For example, repeatedly showing an advertisement of a movie which was released months ago brings no benefit to the users, and it is rarely useful for the advertisers to keep advertising old movies.

Thus, BD-ROM purchased by a user has problems that the value of the disk declines if the disk body is damaged, and that the value of the content also declines over time.

[Patent Reference 1] Japanese Laid-Open Patent Application No. 2006-129169

[Patent Reference 2] Japanese Laid-Open Patent Application No. H10-341389

### SUMMARY OF THE INVENTION

The present invention has been made in view of the above-mentioned problems, and aims at providing a playback apparatus, a playback method, a distribution server, a distribution method, a recording medium and an integrated circuit, all of which perform playback control that prevents a decline of the value in disk as well as in content when the recording medium recording the content thereon is played back.

In order to realize the above-mentioned objective, the present invention is a playback apparatus comprising: a reading unit operable to read, from a portable recording medium, part of 1^{st} content recorded thereon; a storage unit operable to store therein 2^{nd} content pertaining to the part of 1^{st} content; a judgment unit operable to make a suitability judgment on whether the part of 1^{st} content is suitable for playback; and a playback unit operable to (i) play back the part of 1^{st} content in the case where the suitability judgment is made affirmatively, and (ii) play back the 2^{nd} content in the case where the suitability judgment is made negatively.

According to the structure, in the process of playing back the 1^{st} content recorded on the recording medium, the playback apparatus is capable of, in the case where the 1^{st} content includes a part inappropriate for playback, switching the playback to playback of the 2^{nd} content without playback of the inappropriate part.

Here, the playback apparatus may further comprise: a detection unit operable to, during playback of the 1^{st} content, detect failure of the reading unit to read the 1^{st} content; and an acquisition unit operable to, in the case where the failure is detected, externally acquire data corresponding to a location, within the 1^{st} content, at which the failure has occurred, and record the data in the storage unit as the 2^{nd} content.

According to the structure, in the case of failing in content data reading due to damages on the recording medium, the playback apparatus externally acquires data for playback locations at and following the reading failure, and therefore does not need to store therein backup data for the entire content.

Additionally, in the case of failing in content data reading, the playback apparatus is capable of playing back the entire content by switching playback from the 1^{st} content to the 2^{nd} content. Herewith, even if the recording medium becomes damaged, the value of the recording medium remains unchanged from the viewpoint of the user who watches and listens to the content.

Here, the playback apparatus may further comprise: a replacement condition storage unit operable to store therein a replacement condition indicating a condition in which the part of 1^{st} content is to be replaced. In this case, the acquisition unit further makes a playback-state judgment on whether playback state of the 1^{st} content meets the replacement condition, and externally acquires replacement data corresponding to the part of 1^{st} content in the case where the playback-state judgment is made affirmatively and records the replacement data in the storage unit as 3^{rd} content. The playback unit further plays back the 3^{rd} content in the case where the suitability judgment is made negatively.

According to the structure, the playback apparatus is capable of performing the playback by replacing inappropriate content with appropriate one in accordance with a playback state of the content.

Here, the replacement condition storage unit may further store therein an expiration time of the replacement condition in correspondence with the replacement condition. In this case, the playback apparatus further comprises: an update unit operable to judge validity of the replacement condition based on the expiration time, and externally acquire a new replacement condition in the case where the replacement condition is determined invalid and update the replacement condition stored in the replacement condition storage unit with the new replacement condition.

A replacement condition stored in the replacement condition storage unit may become inappropriate over time. According to the above structure, however, the playback apparatus is capable of updating the replacement condition, and therefore is able to always determine the necessity of content replacement based on an appropriate replacement condition.

Here, the replacement condition may include a condition indicating an end of a playback available period with respect to the part of 1^{st} content. In this case, the acquisition unit makes the playback-state judgment affirmatively in the case where playback date and time, which are the playback state, exceed the end of the playback available period.

The structure realizes playback in which content that becomes inappropriate for playback because of the playback date and time is replaced with appropriate content.

For example, advertisements of new package media release, preview of movies and the like often include video, audio and text which are associated with a date. Advertisements including such temporal elements are beneficial for neither the users nor the advertisers if they are played back after the certain date. Here, according to the playback apparatus of the present invention, it is possible to replace content according to playback date and time, and therefore is able to always acquire and play back the latest advertisements.

Therefore, even if time has elapsed after purchase of the recording medium, the value of content (e.g. advertisement) remains unchanged from the viewpoint of the user who watches and listens to the content.

Here, the replacement condition may indicate an available number of times that the part of 1^{st} content can be played back. In this case, the acquisition unit makes the playback-state judgment affirmatively in the case where a number of playback times of the 1^{st} content, which is the playback state, exceeds the available number of times.

The structure realizes playback in which content that becomes inappropriate for playback because of the number of playback times of the content is replaced with appropriate content.

The structure can be used as a mechanism to limit the number of playback times of, for example, high-value content. On the other hand, the structure can also be used as a mechanism to perform replacement of new content in view of the case where the user views the same content a number of times and eventually becomes bored with it.

Here, prior to playback of the 1^{st} content performed by the playback unit, the update unit may judge the validity of the replacement condition, and externally acquire the new replacement condition in the case where the replacement condition is determined invalid and update the replacement condition stored in the replacement condition storage unit with the new replacement condition. In this case, the acquisition unit makes the playback-state judgment using the replacement condition stored in the replacement condition storage unit and acquires the 2^{nd} content.

According to the structure, the playback apparatus has already had, at the time of content playback, the 2^{nd} content necessary for replacement. Herewith, it is possible to play back the entire content seamlessly.

Here, the judgment unit may make the suitability judgment negatively in the case where the 2^{nd} content has been stored in the storage unit.

According to the structure, the playback apparatus judges whether part of the 1^{st} content is suitable for playback, by determining whether the 2^{nd} content has been recorded in the storage unit. Accordingly, with respect to the part for which the 2^{nd} content has been acquired, detection of reading failure does not have to be conducted and also check of a replacement condition does not have to be conducted. Therefore, it is possible to play back the entire content seamlessly.

Here, the playback apparatus may further comprise: a detection unit operable to, before playback of the 1^{st} content, detect failure of the reading unit to read the 1^{st} content; and an acquisition unit operable to, in the case where the failure is detected, externally acquire the 2^{nd} content corresponding to a location, within the 1^{st} content, at which the failure has occurred, and record the 2^{nd} content in the storage unit. In this case, the judgment unit makes the suitability judgment negatively in the case where the 2^{nd} content has been stored in the storage unit. The playback unit starts playback of the 1^{st} content after the acquisition unit completes the acquisition of the 2^{nd} content.

According to the structure, the playback apparatus has already had, at the time of content playback, the 2^{nd} content corresponding to a reading failure location. Herewith, it is possible to play back the entire content seamlessly.

Additionally, in order to realize the above-mentioned objective, the present invention is a playback apparatus comprising: a reading unit operable to read, from a portable recording medium, part of 1^{st} content recorded thereon; a judgment unit operable to make a suitability judgment, during playback of the 1^{st} content, on whether the part of 1^{st} content is suitable for playback; a receiving unit operable to receive 2^{nd} content pertaining to the part of 1^{st} content from an external server in the case where the suitability judgment is made negatively; and a playback unit operable to (i) play back the part of 1^{st} content in the case where the suitability judgment is made affirmatively, and (ii) play back the received 2^{nd} content in the case where the suitability judgment is made negatively

Assume that the playback apparatus has only a small storage area for storage of the 2^{nd} content or, further, does not have such a storage area. According to the above structure, in the process of playing back the 1^{st} content recorded on the recording medium, the playback apparatus is capable of, in the case where the 1^{st} content includes part inappropriate for playback, switching the playback to playback of the 2^{nd} content without playback of the inappropriate part.

In order to achieve the above-mentioned objective, the present invention is a distribution server for delivering data to a playback apparatus that plays back 1^{st} content recorded on a portable recording medium. The distribution server comprises: a storage unit storing therein 2^{nd} content pertaining to the 1^{st} content; a receiving unit operable to receive, from the playback apparatus, a data request that includes location information indicating a location within the 1^{st} content; and a transmitting unit operable to transmit, to the playback apparatus, part of the 2^{nd} content corresponding to part of the 1^{st} content, the part of the 1^{st} content including the location indicated by the location information.

According to the structure, the distribution server is capable of providing the playback apparatus with the 2^{nd} content corresponding to part inappropriate for playback. Herewith, in the process of playing back the 1^{st} content, the playback apparatus is capable of, in the case where the 1^{st} content includes part inappropriate for playback, switching the playback to playback of the 2^{nd} content which is acquired from the distribution server, without playback of the inappropriate part.

Here, the distribution server may further comprise: a judgment unit operable to make a transmission judgment on whether to transmit the part of the 2^{nd} content to the playback apparatus. In this case, the transmitting unit transmits the part of the 2^{nd} content to the playback apparatus only when the transmission judgment is made affirmatively

That is, the distribution server does not provide the playback apparatus with the 2^{nd} content unconditionally, and has a judgment unit that judges whether to provide the 2^{nd} content. Accordingly, the distribution server is capable of refusing transmission of the 2^{nd} content in response to a request from an invalid playback apparatus.

Here, the data request may include a piece of apparatus identification information used for identifying the playback apparatus and a piece of medium identification information used for identifying the recording medium. In this case, the storage unit further stores therein one or more pieces of medium identification information respectively used for identifying one or more recording media used by the playback apparatus, the one or more pieces of medium identification information being stored in correspondence with the piece of apparatus identification information. The judgment unit makes the transmission judgment affirmatively in the case where the piece of medium identification information included in the data request is stored in the storage unit in correspondence with the piece of apparatus identification information.

According to the structure, it is possible to provide the 2^{nd} content for a playback terminal having been registered in advance, and refuse to provide the 2^{nd} content for an invalid playback terminal which has not been registered.

Here, the data request may include a piece of apparatus identification information used for identifying the playback apparatus. In this case, the storage unit further stores therein a data size of data having previously been transmitted to the playback apparatus, the data size being stored in correspondence with the piece of apparatus identification information. The judgment unit makes the transmission judgment affirmatively in the case where the data size is equal to or less than a predetermined value.

According to the structure, it is possible to refuse to provide the 2^{nd} content with respect to an invalid playback terminal, for example, attempting to acquire a large amount of the 2^{nd} content.

Here, the storage unit may further store therein a replacement condition that indicates a condition in which the part of 1^{st} content is to be replaced and corresponds to playback state of the 1^{st} content. In this case, the transmitting unit further transmits the replacement condition to the playback apparatus.

According to the structure, the distribution server is possible to provide the playback apparatus with a replacement condition used for judging the necessity of content replacement.

Also, the replacement condition stored in the playback apparatus may become inappropriate over time. According to the present invention, it is possible to transmit a new replacement condition from the distribution server to the playback apparatus, and therefore the playback apparatus is always able to determine the necessity of content replacement based on an appropriate replacement condition.

Here, the distribution may further comprise: a reception unit operable to receive an update instruction for updating the 2^{nd} content in the storage unit; and a data update unit operable to update the 2^{nd} content in response to the update instruction.

According to the structure, the 2^{nd} content held in the distribution server may become inappropriate over time. However, even in this case, since the distribution sever of the present invention is able to update the 2^{nd} content, it is possible to always provide the playback apparatus with appropriate 2^{nd} content.

### BRIEF DESCRIPTION OF THE DRAWINGS

These and other objects, advantageous effects and features of the invention will become apparent from the following description thereof taken in conjunction with the accompanying drawings which illustrate specific embodiments of the invention.

In the drawings:

FIG. 1 shows a structure of a content playback system 1 according to Embodiment 1;

FIG. 2 shows information recorded on a recording medium 10;

FIG. 3 shows a specific example of information recorded on the recording medium 10;

FIG. 4 is a functional block diagram functionally showing a structure of a playback terminal 20;

FIG. 5 shows information recorded in a terminal information storage unit 204;

FIG. 6 shows information recorded in a restoration data storage unit 205;

FIG. 7 is a functional block diagram functionally showing a structure of a terminal control unit 206;

FIG. 8 is a functional block diagram functionally showing a structure of a content distribution server 30;

FIG. 9 shows information recorded in a playback terminal information storage unit 303;

FIG. 10 shows information recorded in a content storage unit 304;

FIG. 11 is a functional block diagram functionally showing a structure of a server control unit 305;

FIG. 12 is a flowchart showing overall operation of the playback terminal 20

FIG. 13 is a flowchart showing operation of a terminal registration process performed by the playback terminal 20;

FIG. 14 is a flowchart showing operation of a data acquisition process performed by the playback terminal 20;

FIG. 15 is a flowchart showing operation of a data playback process performed by the playback terminal 20;

FIG. 16 is a flowchart showing operation of a restoration data acquisition process performed by the playback terminal 20;

FIG. 17 is a flowchart showing overall operation of the content distribution server 30;

FIG. 18 is a flowchart showing operation of a restoration data transmission process performed by the content distribution server 30;

FIG. 19 is a functional block diagram functionally showing a structure of a playback terminal 20a included in a content playback system 2 according to Embodiment 2;

FIG. 20 is a flowchart showing overall operation of the playback terminal 20a;

FIG. 21 is a flowchart showing operation of a reading check process performed by the playback terminal 20a;

FIG. 22 is a functional block diagram functionally showing a structure of a playback terminal 20b included in a content playback system 3 according to Embodiment 3;

FIG. 23 is a flowchart showing overall operation of the playback terminal 20b;

FIG. 24 is a flowchart showing operation of a data acquisition process performed by the playback terminal 20b;

FIG. 25 shows a structure of a content playback system 4 according to Embodiment 4;

FIG. 26 shows information recorded on a recording medium 1000;

FIG. 27 shows a data structure of content replacement information 1006;

FIG. 28 is a functional block diagram functionally showing a structure of a playback terminal 2000;

FIG. 29 shows a part of information recorded in a terminal information storage unit 2004;

FIG. 30 shows a part of information recorded in a restoration data/replacement data storage unit 2005;

FIG. 31 is a functional block diagram functionally showing a structure of a terminal control unit 2006;

FIG. 32 is a functional block diagram functionally showing a structure of a content distribution server 3000;

FIG. 33 shows a part of information recorded in a content storage unit 3004;

FIG. 34 shows information recorded in a replacement table update data storage unit 3006;

FIG. 35 is a flowchart showing overall operation of the playback terminal 2000;

FIG. 36 is a flowchart showing operation of a terminal registration process performed by the playback terminal 2000;

FIG. 37 is a flowchart showing operation of a content replacement table update process performed by the playback terminal 2000;

FIG. 38 is a flowchart showing operation of a replacement data acquisition process performed by the playback terminal 2000;

FIG. 39 is a flowchart showing operation of a data acquisition process performed by the playback terminal 2000;

FIG. 40 is a flowchart showing operation of a data playback process performed by the playback terminal 2000;

FIG. 41 is a flowchart showing overall operation of the content distribution server 3000;

FIG. 42 is a flowchart showing operation of an update data transmission process performed by the content distribution server 3000;

FIG. 43 is a flowchart showing operation of a replacement data transmission process performed by the content distribution server 3000;

FIG. 44 is a functional block diagram functionally showing a structure of a playback terminal 2000a included in a content playback system 5 according to Embodiment 5;

FIG. 45 is a flowchart showing overall operation of the playback terminal 2000a;

FIG. 46 is a functional block diagram functionally showing a structure of a playback terminal 2000b included in a content playback system 6 according to Embodiment 6;

FIG. 47 is a flowchart showing overall operation of the playback terminal 2000b; and

FIG. 48 is a flowchart showing operation of a data acquisition process performed by the playback terminal 2000b.

### DESCRIPTION OF THE PREFERRED EMBODIMENTS

The following describes embodiments of the present invention in reference to drawings.

### Embodiment 1

Here, a description is given of a content playback system 1 as Embodiment 1 of the present invention.

<Structure>

1. Overall Structure of Content Playback System 1

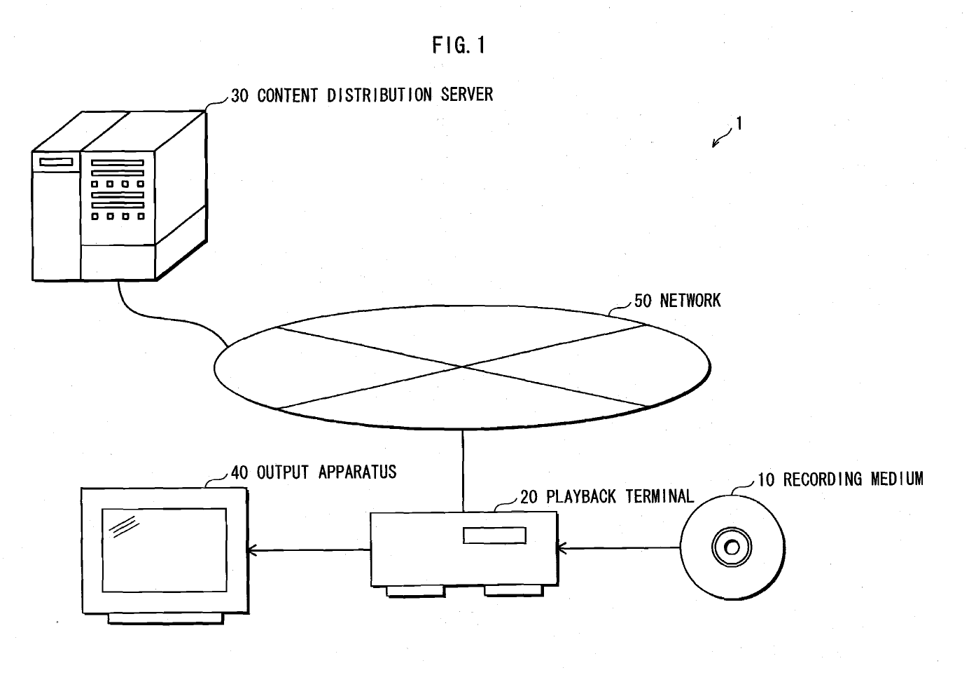

FIG. 1 shows an overall structure of the content playback system 1.

As shown in the figure, the content playback system 1 includes a recording medium 10, a playback terminal 20, a content distribution server 30 and an output apparatus 40. The playback terminal 20 and content distribution server 30 are connected via a communication channel.

The content playback system 1 is a system in which the playback terminal 20 plays back content recorded on the recording medium 10.

The recording medium 10 is a recording medium on which content is recorded, and is considered to be a BD-ROM in the case of the present embodiment. Also in the present embodiment, the content recorded on the recording medium 10 is considered to be video and audio digital data.

The playback terminal 20 is an apparatus for reading the content from the recording medium 10 and playing it back. The playback terminal 20 is considered to be a BD player in the present embodiment. The playback terminal 20 has, in addition to the function of playing back the content read from the recording medium 10, a function of communicating the content distribution server 30 via the communication channel 50. If failing in data reading from the recording medium 10, the playback terminal 20 acquires, from the content distribution server 30 via the communication channel 50, data for locations at and following failure in data reading, and records the acquired data.

In all playback sessions following after data reading failure occurs, the playback terminal 20 plays back, for locations at and after which data reading failure has previously occurred, data acquired from the content distribution server 30. For locations other than those of the data reading failure, the playback terminal 20 plays back data of the recording medium 10.

The content distribution server 30 is an apparatus for providing content to the playback terminal 20 via the communication channel 50. After receiving, from the playback terminal 20, a notification requesting data transmission, the content distribution server 30 judges whether to consent to the content transmission to the playback terminal 20. When determining to consent, the content distribution server 30 transmits, to the playback terminal 20, data for locations at and following failure in data reading. When determining to refuse the content transmission, the content distribution server 30 transmits, to the playback terminal 20, refusal data indicating refusal of the content transmission.

The output apparatus 40 is an apparatus for outputting content data output from the playback terminal 20, and is specifically speaking a TV, a display or a speaker.

The communication channel 50 is a communication channel used for communicating information between the playback terminal 20 and the content distribution server 30. In the present embodiment, the communication channel 50 is considered to be the Internet.

2. Data Structure of Recording Medium 10

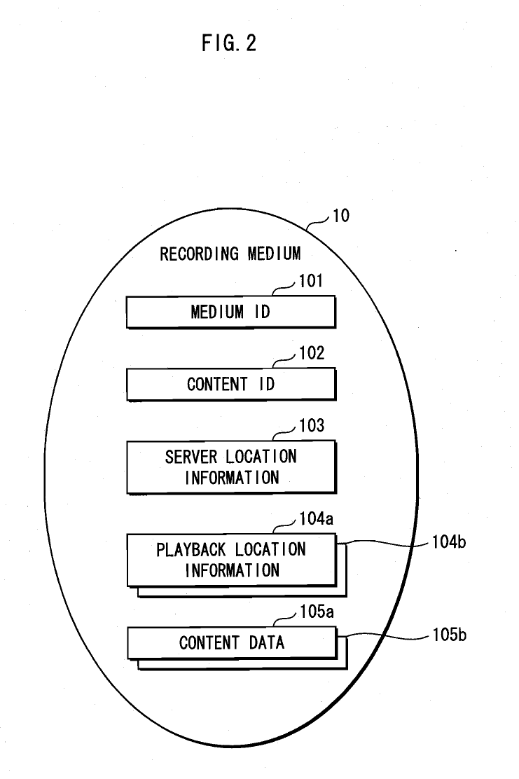

FIG. 2 shows information recorded on the recording medium 10.

As shown in the figure, the recording medium 10 records thereon: a medium ID 101; a content ID 102; server location information 103; multiple pieces of playback location information 104a, . . . , and 104b; and multiple pieces of content data 105a, . . . , and 105b.

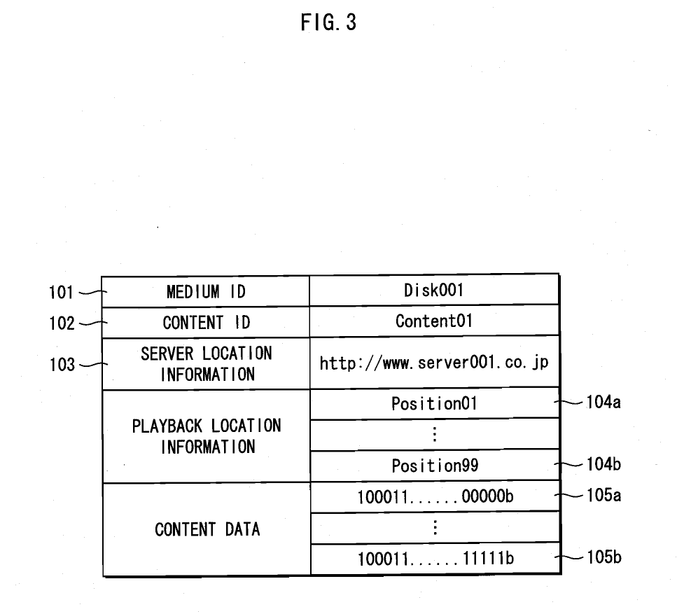

FIG. 3 shows a specific example of each item recorded on the recording medium 10. In reference to FIG. 3, a more detailed description is given of the individual items recorded on the recording medium 10.

The medium ID 101 is identification information for identifying the recording medium 10. One specific example of the medium ID 101 is a manufacturing number of the recording medium 10. In the present embodiment, the medium ID 101 of the recording medium 10 is “Disk001” as shown in FIG. 3.

The content ID 102 is identification information for identifying content recorded on the recording medium 10. As to the content ID 102, a different ID is assigned to each piece of content. Accordingly, in the case where multiple pieces of content are recorded on the recording medium 10, multiple content IDs are recorded thereon. In the present embodiment, the content ID 102 is “Content01” as shown in FIG. 3.

The server location information 103 is information indicating a location of, on the network, the content distribution server 30 that distributes restoration data corresponding to the content recorded on the recording medium 10. In the present embodiment, a URL “http://www.server001.co.jp” is used as the server location information 103, as shown in FIG. 3. The restoration data is hereinafter described.

Next, a description is given of the playback location information and content data.

The content recorded on the recording medium 10 is composed of multiple pieces of content data, which have been formed by dividing the content data into predetermined units. And to each piece of content data, a piece of playback location information has been made to correspond. Each piece of playback location information indicates a location of, within the content, its corresponding piece of content data. With these pieces of playback location information, the playback order of the respective pieces of content data can be also understood.

For example, in the specific example shown in FIG. 3, the piece of playback location information 104a and the piece of content data 105a are in correspondence, and “Position01” indicates a location of the corresponding piece of content data 105a. Similarly, the piece of playback location information 104b and the piece of content data 105b are in correspondence, and “Position99” indicates a location of the corresponding piece of content data 105b. One specific example of a piece of playback location information is a playback time of each piece of content data elapsing from the starting point of the content.

Note that the descriptions “100011 . . . 00000b” of the piece of content data 105a, “100011 . . . 11111b” of the piece of content data 105b and the like indicate digital data of the content.

Although FIG. 3 shows the medium ID and others as character strings for ease of explanation, a different data structure may be used in an actual implementation. For example, it is common to express each in binary digit data having a predetermined bit number.

3. Structure of Playback Terminal 20

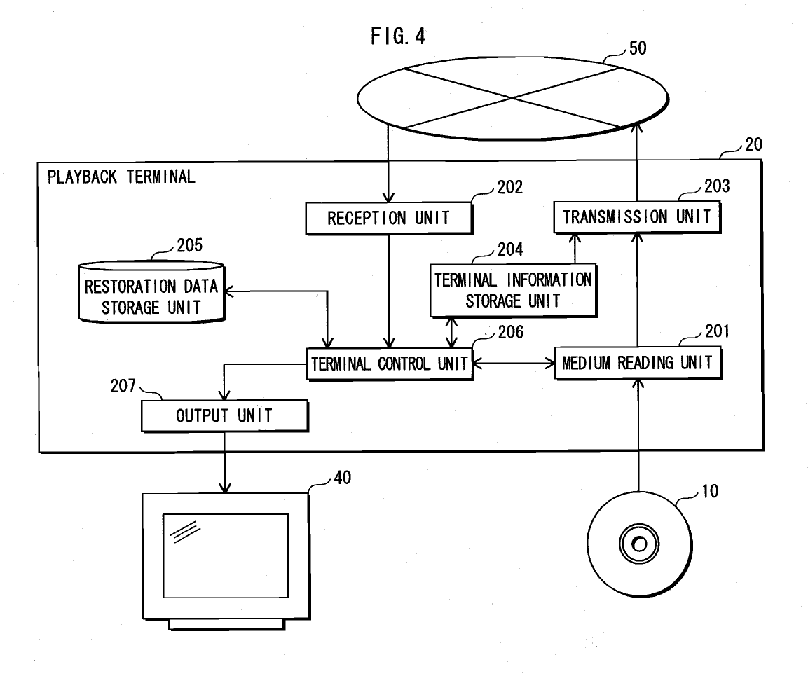

FIG. 4 is a functional block diagram functionally showing the structure of the playback terminal 20.

As shown in the figure, the playback terminal 20 includes a medium reading unit 201, a reception unit 202, a transmission unit 203, a terminal information storage unit 204, a restoration data storage unit 205, a terminal control unit 206 and an output unit 207.

The playback terminal 20 is, specifically speaking, a computer system composed of a CPU, ROM, RAM, a hard-disk unit and the like. The playback terminal 20 fulfills its functions when the CPU executes a computer program recorded in the ROM, RAM or hard-disk unit.

(1) Medium Reading Unit 201

The medium reading unit 201 is, specifically speaking, a BD-ROM drive.

According to instructions of the terminal control unit 206, the medium reading unit 201 reads, from the recording medium 10, the medium ID 101, content ID 102, server location information 103, pieces of playback location information 104a, . . . , and 104b, and pieces of content data 105a, . . . , and 105b.

(2) Reception Unit 202 and Transmission Unit 203

The reception unit 202 and transmission unit 203 are realized by network connection units.

The reception unit 202 receives information from the content distribution server 30 via the communication channel 50, and the transmission unit 203 transmits information to the content distribution server 30 via the communication channel 50.

Specifically speaking, the reception unit 202 receives, from the content distribution server 30, restoration data or refusal data indicating refusal to transmit the restoration data.

Specifically speaking, the transmission unit 203 transmits, to the content distribution server 30, a registration request and a restoration data request.

The registration request is information transmitted to the content distribution server 30 when the recording medium 10 is played back on the playback terminal 20 for the first time. The registration request is information indicating that “the playback terminal 20 is an apparatus for playing back the recording medium 10.” Specifically speaking, the registration request includes a terminal ID 211 stored in the terminal information storage unit 204 and the medium ID 101 of the recording medium 10.

The restoration data request is information to be transmitted to the content distribution server 30 in the case when data reading from the recording medium 10 has been failed. The restoration data request is information requesting for content for locations at and following data reading failure. The restoration data request includes the terminal ID 211, medium ID 101, content ID 102 and a piece of playback location information that indicates a location at which data reading failure has occurred.

(3) Terminal Information Storage Unit 204

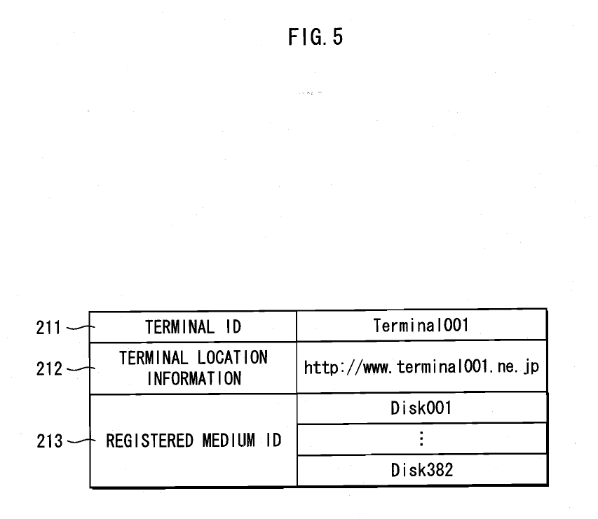

The terminal information storage unit 204 is, specifically speaking, realized by a flash memory, and stores therein terminal-unique data shown in FIG. 5.

As shown in figure, the terminal-unique data includes the terminal ID 211, terminal location information 212, and a registered medium ID 213.

The terminal ID 211 is identification information for identifying the playback terminal 20. Specifically speaking, it is a manufacturing number assigned to the playback terminal 20. In the present embodiment, “Terminal001” is used as the terminal ID 211.

The terminal location information 212 is information indicating a location of the playback terminal 20 on the network. In the present embodiment, a URL of the playback terminal 20 “http://www.terminal001.ne.jp” is used as the terminal location information 212.

The registered medium ID 213 includes a medium ID of a recording medium having been previously played back by the playback terminal 20. In the case where the playback terminal 20 has previously played multiple recording media, the registered medium ID 213 includes multiple medium IDs. The specific example of FIG. 5 shows that the registered medium ID 213 includes medium IDs such as “Disk001” and “Disk382”.

(4) Restoration Data Storage Unit 205

The restoration data storage unit 205 is, specifically speaking, realized by a hard-disk unit, and stores therein restoration data received from the content distribution server 30.

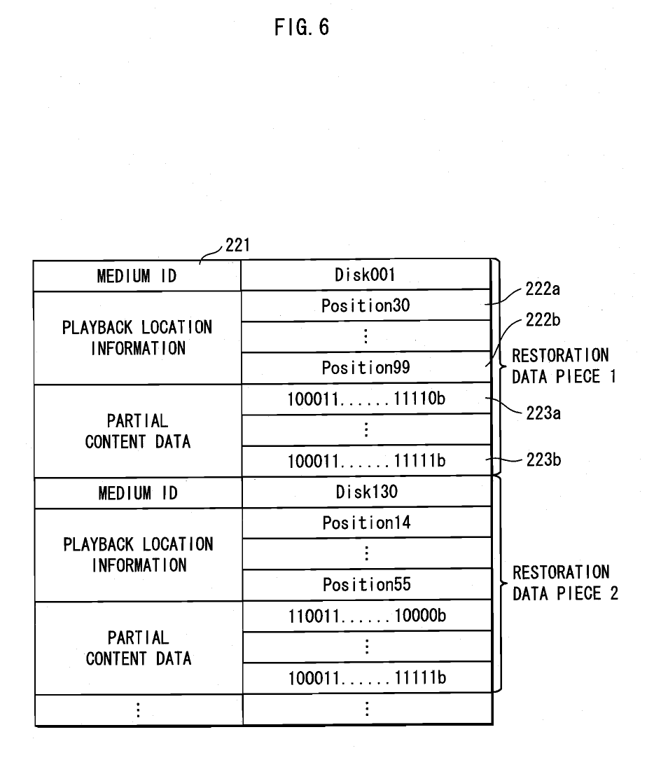

FIG. 6 shows a specific data structure of the restoration data recorded in the restoration data storage unit 205.

As shown in the figure, multiple pieces of restoration data including restoration data pieces 1 and 2 are recorded in the restoration data storage unit 205. Each piece of restoration data is composed of a medium ID, one or more pieces of playback location information and one or more pieces of partial content data.

The medium ID indicates a recording medium from which the playback terminal 20 has previously failed to read data. For example, as the medium ID 221 included in the restoration data piece 1 is “Disk001”, it indicates the recording medium 10 (see FIG. 3).

Pieces of playback location information and pieces of partial content data are in one-to-one correspondence with each other, and each piece of playback location information indicates a location of, within the content, its corresponding piece of partial content data. For example, a piece of playback location information 222a corresponds to a piece of partial content data 223a, and indicates a location of the piece of partial content data 223a. A piece of playback location information 222b corresponds to apiece of partial content data 223b, and indicates a location of the piece of partial content data 223b.

Note that, in the present embodiment and all the following embodiments, content recorded on a recording medium is referred to as “(a piece of) content data”, and content that a playback terminal acquires from a content distribution server is referred to as “(a piece of) partial content data”.

Pieces of partial content data are data created by dividing the content into predetermined units, like pieces of content data explained in the description of FIG. 3. The predetermined unit is the same as that of the content data. In addition, a piece of partial content data has the same content as a piece of content data that has the same piece of playback location information.

Pieces of playback location information and partial content data included in a piece of restoration data include playback location information and partial content data for locations at and following previous failure in data reading from the recording medium.

For example, according to FIG. 6, the restoration data piece 1 includes pieces of playback location information starting from “Position30” and ending at “Position99” and their corresponding pieces of partial content data. Therefore, it can be seen that the playback terminal 20 has previously failed in reading of content data at the playback location “Position30” during playback of the recording medium 10.

(5) Terminal Control Unit 206

The terminal control unit 206 controls each functional block making up of the playback terminal 20, and realizes common control necessary for playing back content as well as characteristic functions related to the present invention. The terminal control unit 206 is composed of a CPU, ROM, RAM and the like, and realizes various functions by executing a control program recorded in, for example, the ROM using the CPU and RAM. In addition, the terminal control unit 206 may be implemented by hardware.

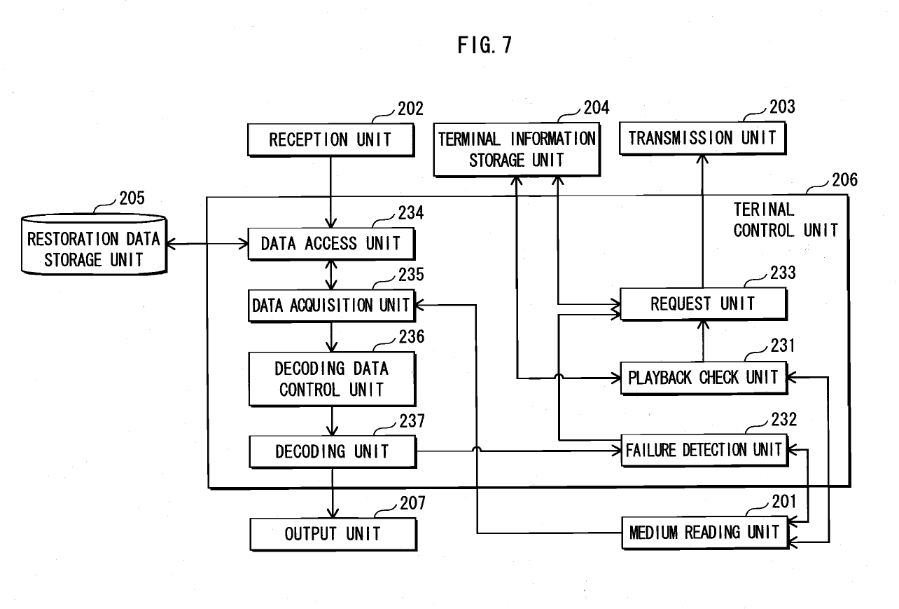

FIG. 7 is a functional block diagram functionally showing the internal structure of the terminal control unit 206.

As shown in the figure, the terminal control unit 206 includes a playback check unit 231, a failure detection unit 232, a request unit 233, a data access unit 234, a data acquisition unit 235, a decoding data control unit 236 and a decoding unit 237.

At the time of playback of the recording medium 10, the playback check unit 231 checks whether the recording medium 10 is to be played back on the playback terminal 20 for the first time. Specifically speaking, the playback check unit 231 checks whether the medium ID 101 (Disk001) read by the medium reading unit 201 is included in the registered medium ID 213 recorded in the terminal information storage unit 204.

As a result of the check, if the medium ID 101 is not included in the registered medium ID 213, the playback check unit 231 determines that the recording medium 10 is to be played back for the first time, and records the medium ID 101 by adding it to the registered medium ID 213. Furthermore, when determining that the recording medium 10 is to be played back for the first time, the playback check unit 231 outputs, along with the medium ID 101, an instruction for creating a registration request to the request unit 233 in order to register, to the content distribution server 30, the playback terminal 20 as an apparatus which plays back the recording medium 10.

The failure detection unit 232 detects failure by the medium reading unit 201 in reading of the recording medium 10. Specifically speaking, the failure detection unit 232 determines reading failure when content data received from the medium reading unit 201 is in a different format from a correct format. Furthermore, when receiving from the decoding unit 237 a notice indicating failure of decoding content data, the failure detection unit 237 determines that reading has been failed. These are cases where reading of content data has been failed mainly due to damages on the disk. Note that the failure detection unit 232 may detect not only reading failure due to damages on the disk but also reading failure due to a problem in the medium reading unit 201.

When having detected reading failure, the failure detection unit 232 outputs to the request unit 233, along with the medium ID 101 as well as a piece of playback location information which indicates a location of the reading failure, an instruction for creating a restoration data request in order to request the content distribution server 30 for restoration data.

In response to the instruction from the playback check unit 231, the request unit 233 creates a registration request. The registration request is a request that is created when the recording medium 10 is to be played back on the playback terminal 20 for the first time. As mentioned above, the registration request is a request for registering the playback terminal 20 to the content distribution server 30 as an apparatus which plays the recording medium 10. The request unit 233 creates a registration request including the medium ID 101 received from the playback check unit 231 and the terminal ID 211 of the playback terminal 20 that is recorded in the terminal information storage unit 204.

Furthermore, in response to an instruction from the failure detection unit 232, the request unit 233 creates a restoration data request. The restoration data request is a request created when the playback terminal 20 has failed in playback of the recording medium 10. As mentioned above, the restoration data request is for requesting the content distribution server 30 to deliver restoration data including partial content data for playback locations at and following failure in reading. The request unit 233 creates a restoration data request including the medium ID 101 received from the failure detection unit 232, the content ID 102 of content with which reading failure has occurred, a piece of playback location information indicating a location of the reading failure, the terminal ID 221 read from the terminal information storage unit 204, and the terminal location information 222.

A registration request and a restoration data request created by the request unit 233 are transmitted to the content distribution server 30 via the transmission unit 203 and communication channel 50. At this point, the transmission unit 203 transmits the registration request and restoration data request to the content distribution server 30 using the server location information 103 (see FIG. 3) recorded on the recording medium 10.

After the reception unit 202 receives restoration data from the content distribution server 30, the data access unit 234 receives the restoration data from the reception unit 202 and records it in the restoration data storage unit 205.

In response to a request from the data acquisition unit 235, the data access unit 234 reads playback location information and partial content data from the restoration data storage unit 205. The data access unit 234 outputs the read playback location information and partial content data to the data acquisition unit 235.

At the start of the process of playing back content, the data acquisition unit 235 acquires content data recorded in the recording medium 10, or partial content data recorded in the restoration data storing unit 205.

Furthermore, during playback of the content data 105 recorded on the recording medium 10, the data acquisition unit 235 acquires, from the medium reading unit 201, the medium ID 101 of th recording medium 10 and a piece of playback location information indicating a location being currently played back. In addition, during playback of partial content data recorded in the restoration data storage unit 205, the data acquisition unit 235 acquires a medium ID corresponding to a piece of partial content data being played back and a piece of playback location information indicating a location being currently played back.

In the case where a medium ID corresponding to content data to be played back and playback location information are not recorded in the restoration data storage unit 205, the data acquisition unit 235 reads, from the recording medium 10, content data corresponding to the playback location information, and outputs the content data together with the playback location information to the decoding data control unit 236. On the other hand, in the case where a medium ID corresponding to content data to be played back and playback location information are recorded in the restoration data storage unit 205, the data acquisition unit 235 reads, from the restoration data storage unit 205, partial content data corresponding to the playback location information, and outputs the partial content data together with the playback location information to the decoding data control unit 236.

As mentioned above, in the restoration data storage unit 205, pieces of playback location information for locations at and following reading failure and their corresponding pieces of partial content data are recorded with respect to content which has previously failed in being read from a recording medium.

That is, the data acquisition unit 235 acquires partial content data recorded in the restoration data storage unit 205 for a playback location at which reading failure has previously occurred. On the other hand, the data acquisition unit 235 acquires content data recorded in the recording medium 10 for a playback location at which reading has been successful.

The decoding data control unit 236 acquires, from the data acquisition unit 235, playback location information and content data, or playback location information and partial content data.

Depending on process loads on the data acquisition unit 235, changes may occur in the data amount output to the decoding data control unit 236 from the data acquisition unit 235 and in the playback order of content data and partial content data. Accordingly, in case of such changes, the decoding data control unit 236 has a function of buffering some pieces of content data and partial content data and then outputting them.

Furthermore, the decoding data control unit 236 rearranges the buffered pieces of content data and partial content data into a correct playback order based on playback location information, and then outputs them to the decoding unit 237.

Note that, if a steady amount of data is always sent from the data acquisition unit 235 in accordance with the playback order, the decoding data control unit 236 does not have to have the buffering function and the function of rearranging the playback order. In this case, a design can be adopted in which pieces of content data and partial content data are directly output to the decoding unit 237 from the data acquisition unit 235 without the decoding data control unit 236 involved.

The decoding unit 237 decodes separately video and audio included in content data and partial content data, and outputs the decoded video signal and audio signal to the output unit 207.

(6) Output Unit 207

The output unit 207 receives decoded video signal and audio signal from the decoding unit 237, and outputs the received video signal and audio signal to the output apparatus 40.

Thus concludes the description of the structure of the playback terminal 20. Note that the internal structure of the terminal control unit 206 shown in FIG. 7 can be incorporated into an integrated circuit. Also, when the restoration data storage unit 205 and terminal information storage unit 204 are realized by not a hard disk but a flash memory or the like, it is possible to incorporate also these units into an integrated circuit.

4. Structure of Content Distribution Server 30

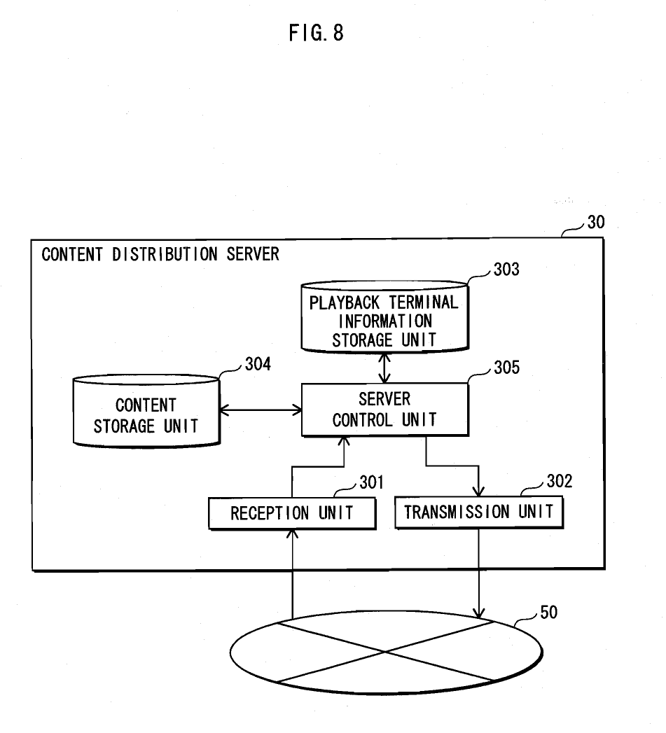

FIG. 8 is a functional block diagram functionally showing the structure of the content distribution server 30.

As shown in the figure, the content distribution server 30 includes a reception unit 301, a transmission unit 302, a playback terminal information storage unit 303, a content storage unit 304 and a server control unit 305.

The content distribution server 30 is, specifically speaking, a computer system composed of a CPU, ROM, RAM, a hard-disk unit and the like. The content distribution server 30 fulfills its functions when the CPU executes a computer program recorded in the ROM, RAM or hard-disk unit.

(1) Reception Unit 301 and Transmission Unit 302

The reception unit 301 and transmission unit 302 are realized by network connection units.

The reception unit 301 receives information from the playback terminal 20 via the communication channel 50, and the transmission unit 302 transmits information to the playback terminal 20 via the communication channel 50.

Specifically speaking, the reception unit 301 receives a registration request and a restoration data request from the playback terminal 20.

Specifically speaking, the transmission unit 302 receives, from the server control unit 305, a restoration data and terminal location information, or refusal data indicating refusal to transmit the restoration data and terminal location information, and transmits the restoration data or refusal data to a playback terminal indicated by the received terminal location information.

(2) Playback Terminal Information Storage Unit 303

The playback terminal information storage unit 303 is realized by a hard disk or a flash memory.

The playback terminal information storage unit 303 records therein management information regarding, for example, transmission state of partial content data with respect to each playback terminal.

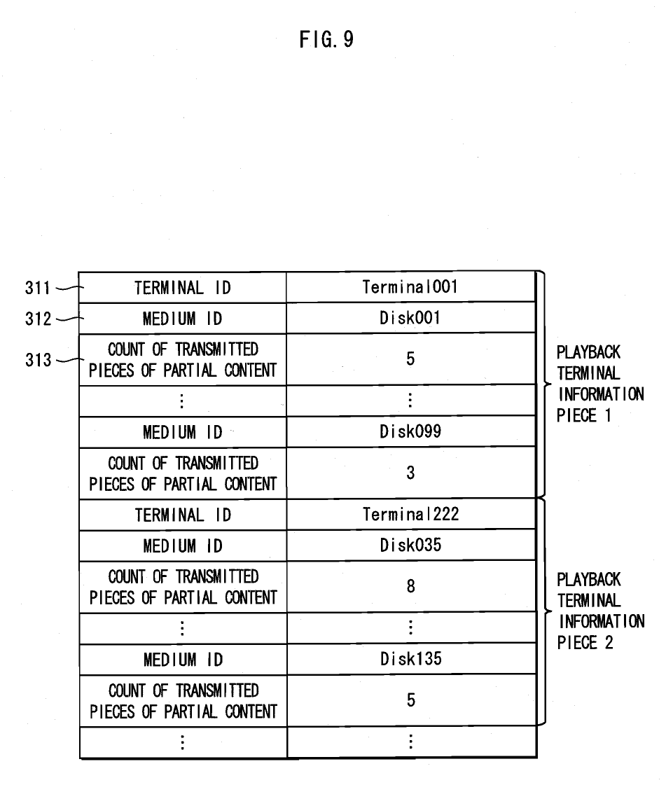

FIG. 9 shows management information recorded on the terminal information storage unit 303.

As shown in the figure, the management information includes multiple pieces of playback terminal information including playback terminal information pieces 1 and 2. Pieces of playback terminal information are recorded with respect to each playback terminal, and each piece of playback terminal information includes a terminal ID and at least one pair of a medium ID and the count of transmitted pieces of partial content.

The terminal ID is information for identifying a registered playback terminal. The medium ID is information for identifying a recording medium to be played back on a registered playback terminal. The count of transmitted pieces of partial content is information indicating, within partial content data corresponding to content data recorded on a recording medium identified by a corresponding medium ID, the number of pieces of partial content data having been transmitted to a registered playback terminal. In the case where no piece of partial content data has been transmitted to a registered playback terminal from the content distribution server 30, “0” is written in the count of transmitted pieces of partial content.

In the specific example shown in FIG. 9, as the terminal ID 311 included in the playback terminal information piece 1 is “Terminal001”, the playback terminal information piece 1 is information corresponding to the playback terminal 20 (see FIG. 3). Also, the playback terminal information piece 1 includes the medium ID “Disk001” (312) and the count of transmitted pieces of partial content “5” (313) corresponding to the medium ID 312. This indicates that five pieces of partial content data corresponding to content data recorded on the recording medium 10 have been transmitted to the playback terminal 20 from the content distribution server 30.

Note that the count of transmitted pieces of partial content is used to judge whether to transmit partial content data to a playback terminal from which a restoration data request has been sent. A detailed explanation of the judgment is given hereinafter.

(3) Content Storage Unit 304

The content storage unit 304 is realized by a hard disk or a flash memory.

The content storage unit 304 records therein partial content data delivered by the content distributions server 30 and management information regarding the partial content data. Also, the content storage unit 304 reads, from among the recorded partial content data, partial content data to be transmitted to the playback terminal 20 in accordance with an instruction from the server control unit 305.

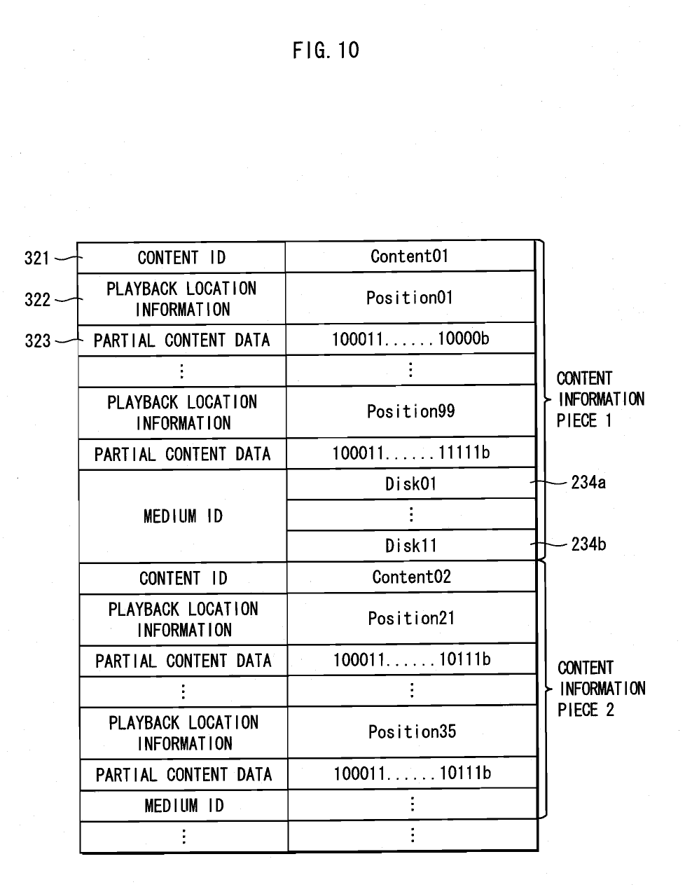

FIG. 10 shows a data structure of information recorded in the content storage unit 304. As shown in the figure, multiple pieces of content information, including content information pieces 1 and 2, are recorded in the content storage unit 304.

Each piece of content information includes a content ID, multiple pieces of playback location information, multiple pieces of partial content data, and one or more medium IDs.

The content ID is information for identifying content which can be delivered by the content distribution server 30. In the specific example shown in FIG. 10, the content ID 321 included in the content information piece 1 is “Content01”.

Pieces of playback location information and pieces of partial content data here are the same as those explained in the description of FIG. 6. Namely, pieces of playback location information are in one-to-one correspondence with pieces of partial content data. Pieces of partial content data are data created by dividing the content into predetermined units, and a piece of playback location information indicates where in the playback order its corresponding piece of partial content data is located. For example, in the specific example of FIG. 10, a playback location information piece 322 corresponds to a partial content data piece 323, and indicates where in the playback order the partial content data piece 323 is located.

Assume that, in the present embodiment, the format of the content ID 321 included in the content information piece 1 is the same as that of the content ID 102 included in the content information piece 1. In addition, assume that the format of each piece of playback location information included in the content information piece 1 is the same as that of each piece of playback location information recorded in the recording medium 10.

Here, the content information piece 1 includes all pieces of partial content data corresponding to all pieces of content data recorded in the recording medium 10. This is in order to allow appropriate pieces of partial content data to be delivered if the playback terminal 20 fails in data reading at any location on the recording medium 10.

The medium IDs included in each piece of content information are information for identifying recording media which record the content. For example, in FIG. 10, the content information piece 1 includes a medium ID “Disk01” (234a), . . . , and a medium ID “Disk11” (234b). This means that content identified by the content ID “Content01” is recorded, for example, on a recording medium identified by the medium ID “Disk01”, and a recording medium identified by the medium ID “Disk11”.

The medium IDs included in each piece of content information are used for judging whether a restoration data request has been transmitted from a playback terminal playing back a valid recording medium. A detailed explanation of the judgment is given hereinafter.

Assume that, in the present embodiment, the format of a medium ID included in each piece of content information is the same as that of the medium ID 101 recorded on the recording medium 10.

(4) Server Control Unit 305

The server control unit 305 controls the entire content distribution server 30, and realizes common control necessary for playing back content as well as characteristic functions related to the present invention. The server control unit 305 realizes various functions by executing a control program recorded in, for example, the ROM using the CPU and RAM. In addition, the server control unit 305 may be implemented by hardware.

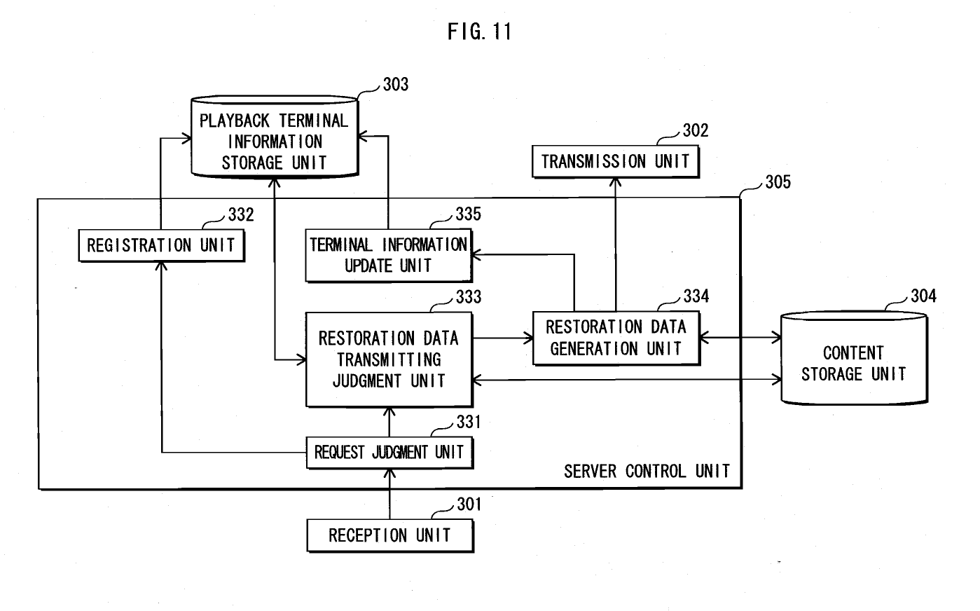

FIG. 11 is a functional block diagram functionally showing the internal structure of the server control unit 305.

As shown in the figure, the server control unit 305 includes a request judgment unit 331, a registration unit 332, a restoration data transmitting judgment unit 333, a restoration data generation unit 334 and a terminal information update unit 335.

The request judgment unit 331 receives a request received by the reception unit 301 from the playback terminal 20, and judges the received request is either a registration request or a restoration data request.

Specifically speaking, the request judgment unit 331 judges whether terminal location information is included in the received request. In the case where terminal location information is included in the received request, the request judgment unit 331 determines that the received request is a restoration data request; in the case where no terminal location information is included, the request judgment unit 331 determines that the received request is a registration request. In addition, as another embodiment, each request may have information attached thereto, which indicates whether the request is a registration request or a restoration data request.

As a result of the judgment, if it is a registration request, the request judgment unit 311 outputs the received request to the registration unit 332. As a result of the judgment, if it is a restoration data request, the request judgment unit 331 outputs the received request to the restoration data transmitting judgment unit 333 and restoration data generation unit 334.

When receiving a registration request from the request judgment unit 331, the registration unit 332 performs the following registration process.

First, the registration unit 332 judges whether playback terminal information including a terminal ID which is included in the received registration request has already been recorded in the playback terminal information storage unit 303.

When the playback terminal information has already been recorded, the registration unit 332 determines that a registered playback terminal is requesting a registration as having played back a new recording medium. In this case, the registration unit 332 records a medium ID included in the registration request by adding it to playback terminal information including the terminal ID. Furthermore, the registration unit 332 records therein the count of transmitted pieces of partial content indicating “0” in correspondence with the medium ID.

On the other hand, when the playback terminal information has yet to be recorded, the registration unit 332 judges that a registration is requested from a non-registered playback terminal. In this case, the registration unit 332 generates new playback terminal information which includes the medium ID and a terminal ID included in the registration request, and registers the playback terminal information to the playback terminal information storage unit 303. Furthermore, the registration unit 332 records therein the count of transmitted pieces of partial content indicating “0” in correspondence with the medium ID.

When receiving a restoration data request from the request judgment unit 331, the restoration data transmitting judgment unit 333 judges whether requested restoration data could be transmitted to the playback terminal 20. Specifically speaking, the restoration data transmitting judgment unit 333 examines the following items to thereby determine whether to consent to or refuse transmission of the restoration data.

First, the restoration data transmitting judgment unit 333 examines whether the same information as the medium ID and a terminal ID included in the restoration data request has been recorded in the playback terminal information storage unit 303. The same information having not been recorded means that it is a request from a non-registered playback terminal for partial content data corresponding to a non-registered recording medium. Accordingly, the restoration data transmitting judgment unit 333 judges the request to be invalid and determines to refuse transmission of the restoration data.

Then, in the case of determining that the same information as the medium ID and a terminal ID included in the restoration data request has been recorded in the playback terminal information storage unit 303, the restoration data transmitting judgment unit 333 examines whether the count of transmitted pieces of partial content that has been recorded in correspondence with the medium ID is equal to or more than a predetermined count (hereinafter, referred to as “transmission upper limit count”) or not.

In the present embodiment, the upper limit of pieces of partial content data that can be acquired by the playback terminal is set with respect to each recording medium, and the restoration data transmitting judgment unit 333 preliminarily records therein the transmission upper limit count. When the count of pieces of partial content data having previously been transmitted to the playback terminal that is making a restoration data request exceeds the stored transmission upper limit count, the restoration data transmitting judgment unit 333 determines to refuse transmission of the restoration data.

More specifically, the restoration data transmitting judgment unit 333 searches in the playback terminal information storage unit 303, using a terminal ID included in the restoration data request, for playback terminal information having the same terminal ID. When the playback terminal information is found, the restoration data transmitting judgment unit 333 searches for, using a medium ID included in the restoration data request, the count of transmitted pieces of restoration data stored in correspondence with the same medium ID. The restoration data transmitted judgment unit 333 determines to refuse transmission of the restoration data if the count of transmitted pieces of restoration data found by the search exceeds the transmission upper limit count prestored in the restoration data transmitting judgment unit 333.

Furthermore, the restoration data transmitting judgment unit 333 examines if, in the content storage unit 304, a content ID included in the restoration data request is in correspondence with a medium ID included in the restoration data request. That the correspondence has not been established means that the request is made for restoration data pertaining to content which is not stored on a recording medium played on the playback terminal 20. Accordingly, the restoration data transmitting judgment unit 333 judges the request to be invalid and determines to refuse transmission of the restoration data.

When not making a determination of refusing transmission of the restoration data in any of the above-mentioned judgments, the restoration data transmitting judgment unit 333 determines to consent to transmission of the restoration data.

After finishing the judgment on whether to transmit the restoration data, the restoration data transmitting judgment unit 333 notifies the judgment result to the restoration data generation unit 334. Here, when a notification of transmission consent is to be made, the restoration data transmitting judgment unit 333 outputs the restoration data request along with the notification to the restoration data generation unit 334.

After receiving the notification of transmission consent for the restoration data from the restoration data transmitting judgment unit 333, the restoration data generation unit 334 performs a process of generating restoration data to be transmitted to the playback terminal 20 in the following manner.

The restoration data generation unit 334 determines, within the content storage unit 304, a piece of content information having a content ID included in the restoration data request.

After determining a piece of content information, the restoration data generation unit 334 reads, from the determined piece of content information, all pieces of partial content data for locations at and following a location indicated by a piece of playback location information included in the restoration data request and pieces of playback location information corresponding to the respective pieces of partial content data.

Then, the restoration data generation unit 334 generates restoration data including the read pieces of partial content data and playback location information. Subsequently, the restoration data generation unit 334 outputs the generated restoration data and terminal location information included in the restoration data request to the transmission unit 302.

Furthermore, in order to update the storage content of the playback terminal information storage unit 303, the restoration data generation unit 334 outputs to the terminal information update unit 335, the count of pieces of partial content data included in the generated restoration data and a terminal ID and a medium ID included in the restoration data request.

On the other hand, when the restoration data generation unit 334 receives a notification of transmission refusal for the restoration data from the restoration data transmitting judgment unit 333, the restoration data generation unit 334 generates refusal data indicating refusal of the restoration data transmission. Subsequently, the restoration data generation unit 334 outputs the generated refusal data and terminal location information included in the restoration data request to the transmission unit 302.

The terminal information update unit 335 updates information stored in the playback terminal information storage unit 303.

Specifically speaking, after receiving the count of pieces of partial content data, a terminal ID and a medium ID from the restoration data generation unit 334, the terminal information update unit 335 determines apiece of playback terminal information including the received terminal ID. After determining a piece of playback terminal information, the terminal information update unit 335 determines the count of transmitted pieces of partial content recorded in correspondence with the medium ID received from the restoration date generation unit 334. After determining the count of transmitted pieces of partial content, the terminal information update unit 335 adds the count of pieces of partial content data received from the restoration date generation unit 334 to the determined count of transmitted pieces of partial content, and then overwrites the original count of transmitted pieces of partial content with the newly added count.

The structure of the server control unit 305 having been described can be incorporated into an integrated circuit. Also, when the content storage unit 304 and playback terminal information storage unit 303 are realized by not a hard-disk but a flash memory or the like, it is possible to incorporate also these units into an integrated circuit.

<Operation>

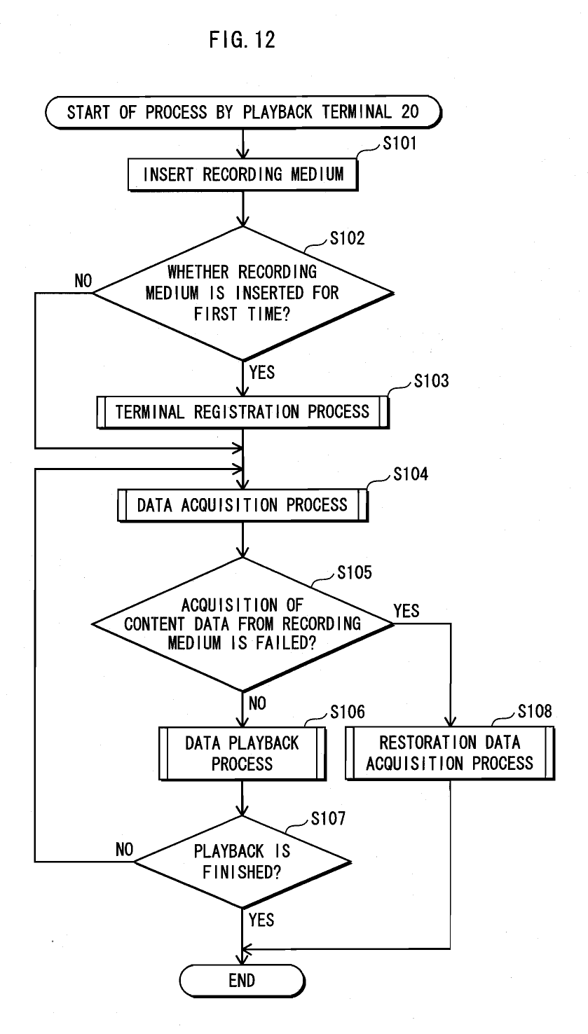

Here, operation of the content playback system 1 is described with the use of flowcharts shown in FIGS. 12-18.

1. Operation of Playback Terminal 20

(Operation of Overall Processes Performed by Playback Terminal 20)

FIG. 12 is a flowchart showing operation of the overall processes performed by the playback terminal 20.

When the recording medium 10 is inserted into the playback terminal 20 (Step S101), the playback check unit 231 checks whether the recording medium 10 is to be played back for the first time.

In the case where the recording medium 10 is to be played back for the first time (Step S102: YES), the playback terminal 20 performs a terminal registration process (Step S103) and moves onto Step S104.

In the case where the recording medium 10 is to be played back not for the first time (Step S102: NO), after the terminal registration process of Step S103 is finished, the playback terminal 20 performs a data acquisition process (Step S104).

Next, in the case of not failing in data reading while acquiring content data from the recording medium 10 (Step S105: NO), the playback terminal 20 performs a data playback process (Step S106). Subsequently, the playback terminal 20 judges whether playback of the content is finished, and when the playback is finished (Step S107: YES), the playback terminal 20 finishes the process. In the case where the playback is not finished (Step S107: NO), the playback terminal 20 advances the playback location and continues the data playback process of Step S106.

Note that the process of advancing the playback location is realized as common content playback control executed by the terminal control unit 206. More specifically, when content data read from the recording medium 10 is being played back, the medium reading unit 201 performs the process of advancing the playback location, and when partial content data read from the restoration data storage unit 205 is being played back, the data access unit 234 performs the process of advancing the playback location.

In the case of failing in data reading while acquiring content data from the recording medium 10 (Step S105: YES), the playback terminal 20 performs a restoration data acquisition process (Step S108) and then ends the process.

(Operation of Terminal Registration Process)

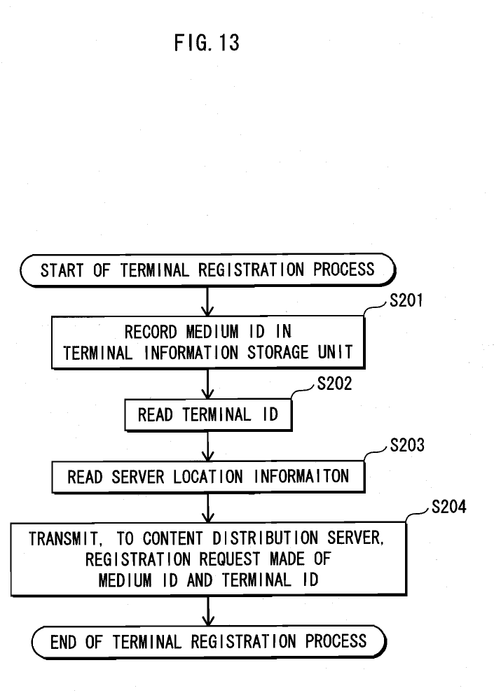

FIG. 13 is a flowchart showing operation of the terminal registration process performed by the playback terminal 20. Note that the operation shown in this figure is a detail of Step S103 of FIG. 12.

First, the playback check unit 231 adds the medium ID 101 of the recording medium 10 to the registered medium ID 213 of the terminal information storage unit 204 (Step S201).

Subsequently, the request unit 233 reads the terminal ID 211 recorded in the terminal information storage unit 204 (Step S202), and creates a registration request composed of the read terminal ID 211 and the medium ID 101 of the recording medium 10.

Next, the medium reading unit 201 reads the server location information 103 from the recording medium 10 (Step S203).

Then, the transmission unit 203 transmits the registration request composed of the terminal ID 211 and the medium ID 101 to the content distribution server 30 indicated by the server location information 103 (Step S204).

(Operation of Data Acquisition Process)

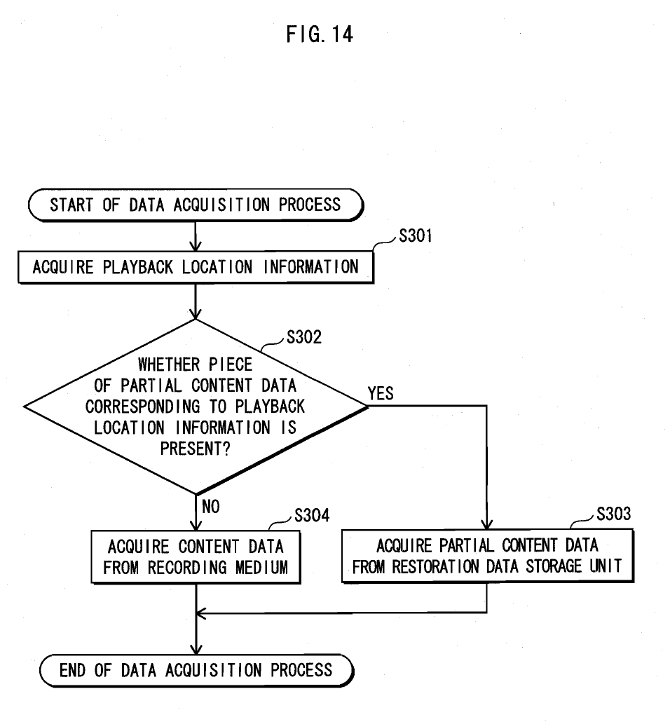

FIG. 14 is a flowchart showing operation of the data acquisition process performed by the playback terminal 20. Note that the operation shown in this figure is a detail of Step S104 of FIG. 12.

First, the playback terminal 20 acquires playback location information which indicates a location, within content, currently being played back (Step S301). As has been described, the process of acquiring playback location information is realized as common content playback control executed by the terminal control unit 206, and the medium reading unit 201 or data access unit 234 performs the process in accordance with instructions from the terminal control unit 206.

Subsequently, the data acquisition unit 235 checks if partial content data corresponding to the acquired playback location information is present in the restoration data storage unit 205. In the restoration data storage unit 205, pieces of partial content data for locations at and following failure in data reading from the recording medium 10 are stored.

The checking process performed by the data acquisition unit 235 is, specifically speaking, realized by checking if both medium ID and playback location information received from the medium reading unit 201 have been recorded in the restoration data storage unit 205.

In the case where a piece of partial content data corresponding to the playback location information is present in the restoration data storage unit 205 (Step S302: YES), the data acquisition unit 235 acquires it from the restoration data storage unit 205 (Step S303) and then outputs it to the decoding data control unit 236.

On the other hand, in the case where a piece of partial content data corresponding to the playback location information is not present in the restoration data storage unit 205 (Step S302: NO), the data acquisition unit 235 acquires a piece of content data corresponding to the playback location information from the recording medium 10 (Step S304) and outputs it to the decoding data control unit 236.

(Operation of Data Playback Process)

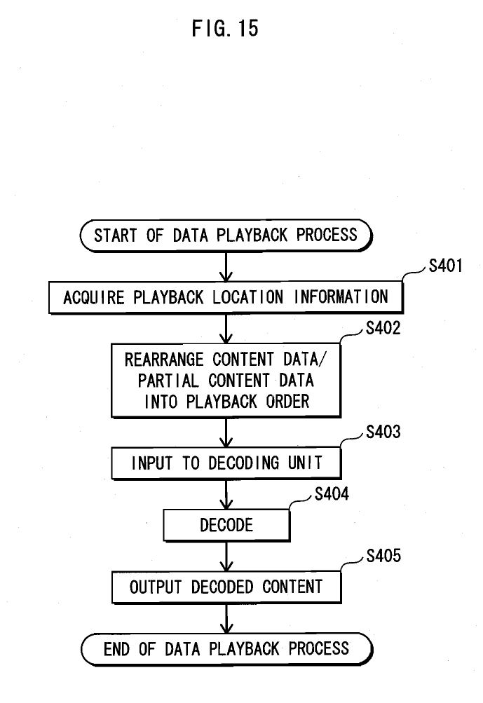

FIG. 15 is a flowchart showing operation of the data playback process performed by the playback terminal 20. Note that the operation shown in this figure is a detail of Step S106 of FIG. 12.

First, the decoding data control unit 236 acquires playback location information of buffered pieces of content data and partial content data (Step S401).

Subsequently, according to the acquired playback location information, the decoding data control unit 236 rearranges those pieces of content data and partial content data into a proper playback order (Step S402). Then, the pieces of content data and partial content data are output to the decoding unit 237 in the proper playback order (Step S403).

The decoding unit 237 decodes the received pieces of content data and partial content data (Step S404) and outputs them to the output apparatus 40 (Step S405).

As has been explained in the description of the decoding data control unit 236, if a steady amount of data is always sent from the data acquisition unit 235 in accordance with the playback order, the buffering and rearranging processes by the decoding data control unit 236 are not required. In such a case, Steps S401 and S402 can be omitted.

(Operation of Restoration Data Acquisition Process)

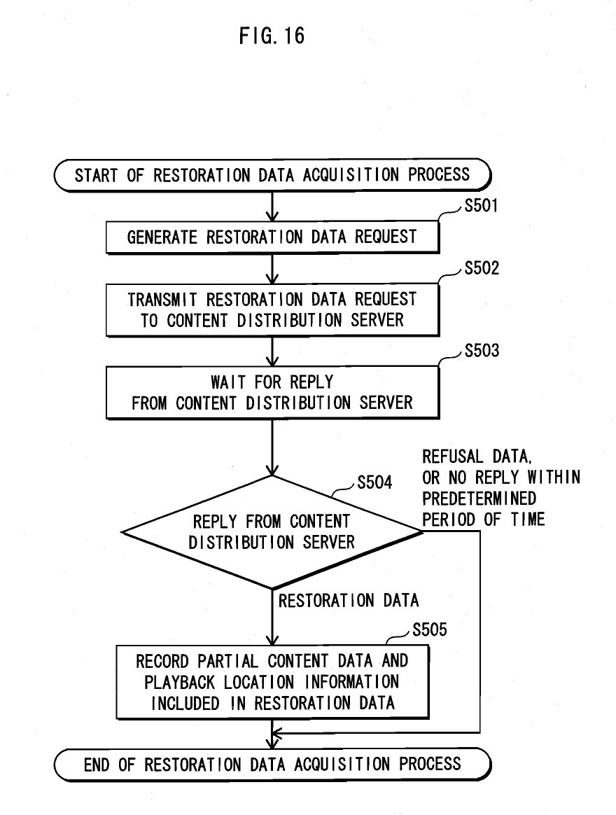

FIG. 16 is a flowchart showing operation of the restoration data acquisition process performed by the playback terminal 20. Note that the operation shown in this figure is a detail of S108 of FIG. 12.

First, the request unit 233 generates a restoration data request including: a medium ID received from the failure detection unit 121; a content ID of content with which reading failure has occurred; playback location information indicating a location at which reading failure has occurred; and a terminal ID and terminal location information read from the terminal information storage unit 204 (Step S501). The transmission unit 203 transmits the restoration data request generated at Step S501 to the content distribution server 30 (Step S502).

Subsequently, the playback terminal 20 waits for a reply from the content distribution server 30 (Step S503).

In the case when the reply from the content distribution server 30 is refusal data, or when no reply is made from the content distribution server 30 within a predetermined period of time (Step S504: “refusal data, or no reply within a predetermined period of time”), the playback terminal 20 ends the process.

In the case when the reply from the content distribution server 30 is restoration data (Step S504: “restoration data”), the data access unit 234 records, in the restoration data storage unit 205, pieces of partial content data and playback location information included in the restoration data (Step S505).

Note that it may be designed to have a structure in which, in the case when the reply from the content distribution server 30 is refusal data, the output unit 207 makes to the user a notification indicating failure in acquiring the restoration data and then the playback terminal 20 ends the process.

In addition, in the case where information indicating a reason of request refusal (e.g. “the request was invalid”; and “transmission of pieces of partial content data would result in exceedance of an allowed count for transmission”) is included in the refusal data, the output unit 207 may notify the user of the reason.

Also in the case where no reply is made from the content distribution server 30 within a predetermined period of time, the output unit 207 may make to the user a notification indicating failure in communicating with the content distribution server 30 before the playback terminal 20 ends the process.

Furthermore, in the case where the reply from the content distribution server 30 is restoration data, the output unit 207 may make to the user a notification indicating success in acquiring the restoration data.

2. Operation of Content Distribution Server 30

(Operation of Overall Process Performed by Content Distribution Serve 30)

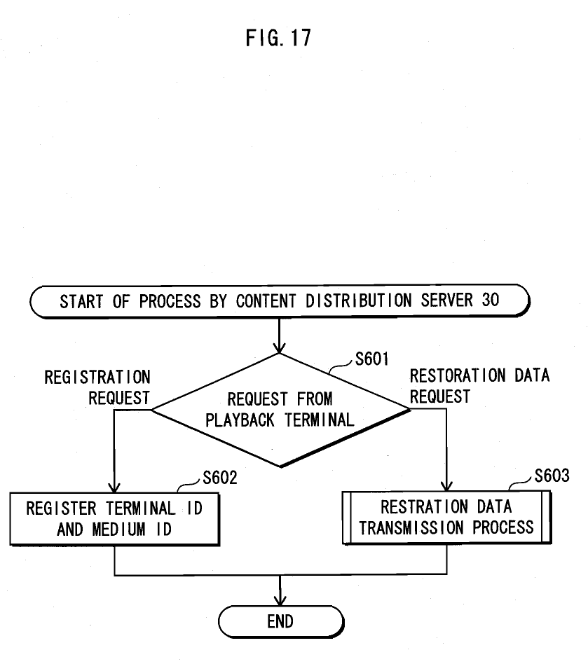

FIG. 17 is a flowchart showing operation of overall processes performed by the content distributions server 30.

The content distribution server 30 waits for a request from the playback terminal 20, and when the content distribution server 30 receives a request from the playback terminal 20, the request judgment unit 331 judges whether the request is a registration request or restoration data request.

The request received from the playback terminal 20 is a registration request (Step S601: “registration request”, the registration unit 332 records a terminal ID and a medium ID included in the registration request in the playback terminal information storage unit 303 (Step S602), and then ends the process.

At Step S602, in the case where the terminal ID has already been recorded in the terminal information storage unit 303, the registration unit 332 adds thereto the medium ID in correspondence with the recorded terminal ID. In addition, the registration unit 332 adds, in the terminal information storage unit 303, the count of transmitted pieces of partial content that indicates “0” in corresponding with the medium ID. In the case where the terminal ID has not been recorded in the terminal information storage unit 303, the registration unit 332 records both the terminal ID and medium ID included in the registration request in the playback terminal information storage unit 303. Furthermore, the registration unit 332 records the count of transmitted pieces of partial content that indicates “0” in correspondence with the medium ID.

In the case where the request received from the playback terminal 20 is a restoration data request (Step S601: “restoration data request”), the content distribution server 30 performs a restoration data transmission process (Step S603), and then ends the process.

Although, in the present embodiment, data is not sent back to the playback terminal 20 in response to a registration request, it may instead be designed to have a structure in which a notification indicating the registration has been normally completed is made to the playback terminal 20 after the completion of the process of the registration unit 332.

(Operation of Restoration Data Transmission Process)

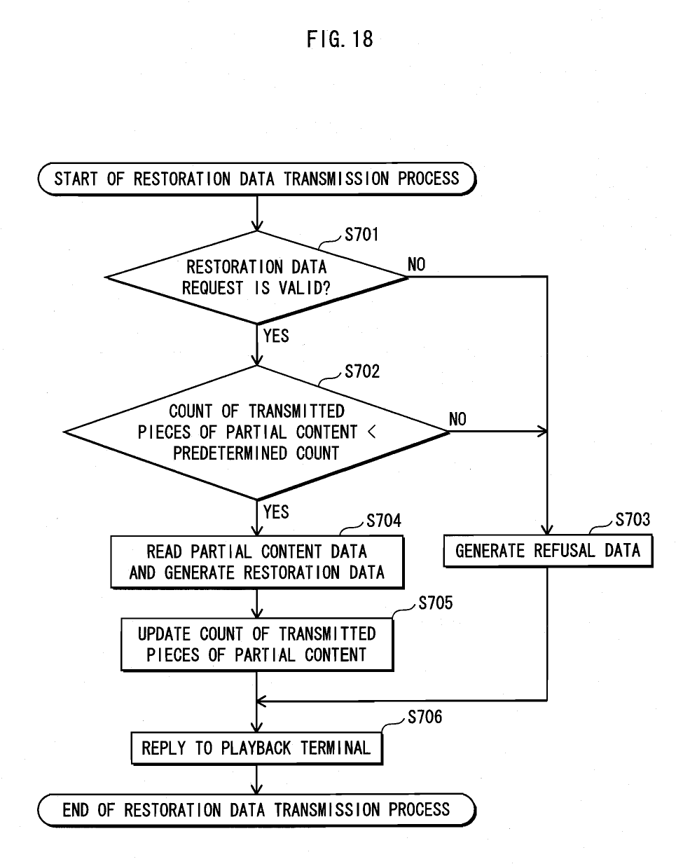

FIG. 18 is a flowchart showing operation of the restoration data transmission process performed by the content distribution server 30. Note that the operation shown in this figure is a detail of Step S603 of FIG. 17.

First, the restoration data transmitting judgment unit 333 judges validity of a restoration data request. Items judged by the restoration data transmitting judgment unit 333 are as follows.

The restoration data transmitting judgment unit 333 checks whether a terminal ID and a medium ID included in the restoration data request are recorded in the playback terminal information storage unit 303. When either one of them is not recorded, the restoration data transmitting judgment unit 333 determines the restoration data request to be invalid.

Also the restoration data transmitting judgment unit 333 checks whether a content ID and a medium ID included in the restoration data request are recorded in the content storage unit 304, in correspondence with each other. In the case where they are not recorded in correspondence with each other, the restoration data transmitting judgment unit 333 determines the restoration data request to be invalid.

In the case where the restoration data request is determined to be invalid (Step S701: NO), the restoration data transmitting judgment unit 333 sends a notification indicating a refusal of restoration data transmission to the restoration data generation unit 334, and then moves onto Step S703.

In the case where the restoration data request is determined to be valid (Step S701: YES), the restoration data transmitting judgment unit 333 checks the count of transmitted pieces of partial content recorded in correspondence with a terminal ID and a medium ID included in the restoration data request. In the case where the count of transmitted pieces of partial content is equal to or more than the transmission upper limit count (Step S702: NO), the restoration data transmitting judgment unit 333 sends a notification indicating a refusal of restoration data transmission to the restoration data generation unit 334, and then moves onto Step S703.

When receiving a notification indicating a refusal of restoration data transmission, the restoration data generation unit 334 generates refusal data (Step S703) and outputs the generated refusal data to the transmission unit 302.

In the case where the count of transmitted pieces of partial content is less than the transmission upper limit count (Step S702: YES), the restoration data transmitting judgment unit 333 sends, to the restoration data generation unit 334, a notification indicating consent to generate restoration data.

When receiving a notification indicating consent to transmit restoration data, the restoration data generation unit 334 reads, from the content storage unit 304, pieces of partial content data for locations at and following a location indicated by a piece of playback location information included in the restoration data request and pieces of playback location information corresponding to the respective pieces of partial content data, and then generates restoration data including those pieces of partial content data and playback location information (Step S704). The restoration data generation unit 334 outputs the generated restoration data to the transmission unit 302.

Next, the terminal information update unit 335 adds the count of pieces of partial content included in the restoration data to the count of transmitted pieces of partial content recorded in the playback terminal information storage unit 303 to thereby update the count of transmitted pieces of partial content (Step S705).

Then, the transmission unit 302 transmits restoration data or refusal data to the playback terminal 20 (Step S706).

Here, at Step S703 above, the same refusal data is generated either in the case where transmission of restoration data is denied by the judgment at Step S701 or in the case where transmission of restoration data is denied by the judgment at Step S702; however, since reasons for denying transmission of restoration data are different, refusal data including different information may be generated for each case.

As has been described, in the content playback system 1, if the playback terminal 20 fails in reading content data from the recording medium 10, the playback terminal 20 requests the content distribution server 30 for pieces of partial content data for locations at and following data reading failure. The content distribution server 30 generates restoration data including the requested pieces of partial content data, and sends the restoration data to the playback terminal 20. The playback terminal 20 records the restoration data acquired from the content distribution server 30 in the restoration data storage unit 205. In the case of playing back the recording medium 10 with which reading failure has occurred, the playback terminal 20 proceeds playback as comparing the location being currently played back and the location at which data reading failure has previously occurred. When the location being currently played back reaches at or beyond the location at which data reading failure has previously occurred, the playback terminal 20 switches to play back partial content data recorded in the restoration data storage unit 205.

According to such a structure, the playback terminal 20 is capable of playing back the entire content if having recorded, in the restoration data storage unit 205, only data for locations at and following data reading failure. Accordingly, the amount of backup data can be reduced as compared to the case where backup data of the entire content is recorded.

### Embodiment 2

Here is described a content playback system 2 as Embodiment 2 of the present invention.

In Embodiment 1, the playback terminal 20 requests the content distribution server 30 for restoration data when failing in data reading during playback of content recorded on a recording medium, and records inside the restoration data acquired from the content distribution server 30. Herewith, the playback terminal 20 is able to play back content seamlessly in subsequent playbacks after the playback with failure in reading the recording medium 10.

However, according to Embodiment 1, when reading failure occurs for the first time, content playback becomes suddenly interrupted in the middle. In this view, Embodiment 2 shows a content playback system capable of seamlessly playing back the entire content from the beginning to the end even if reading failure occurs for the first time.

Specifically speaking, the content playback system 2 of Embodiment 2 checks whether reading failure occurs prior to start of content playback. With the checking, if an occurrence of reading failure is detected, the playback terminal requests the content distribution server for restoration data, and records insides the restoration data acquired from the content distribution server. According to this structure, since failure in reading the recording medium is checked and acquisition of restoration data is completed before start of content playback, it is possible to seamlessly play back the entire content.

<Structure>

1. Overall Structure of Content Playback System 2

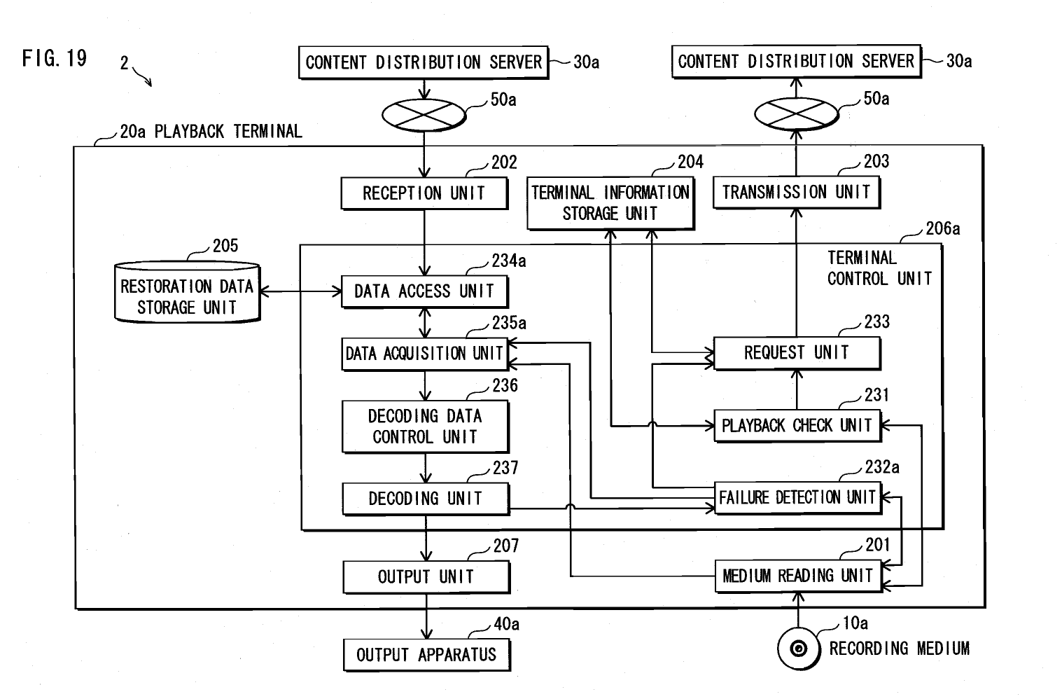

The content playback system 2 of Embodiment 2 includes a recording medium 10a, a playback terminal 20a, a content distribution server 30a and an output apparatus 40a. The playback terminal 20a and content distribution server 30a are connected via a communication channel 50a (See FIG. 19).

Since the recording medium 10a, content distribution server 30a, output apparatus 40a and communication channel 50a have the same structure and function as the recording medium 10, content distribution server 30, output apparatus 40 and communication channel 50, respectively, of Embodiment 1, their descriptions are omitted here.

The following describes the structure of the playback terminal 20a, which has a function different from its counterpart of Embodiment 1.

2. Structure of Playback Terminal 20a

FIG. 19 is a functional block diagram functionally showing the structure of the playback terminal 20a. Components to which the same reference symbols are given as in FIGS. 4 and 7 are functionally identical with those in Embodiment 1, and therefore their descriptions are omitted here. The playback terminal 20a is different from Embodiment 1 in the structures of a failure detection unit 232a, a data access unit 234a and data acquisition unit 235a.

(1) Failure Detection unit 232a

When the recording medium 10a is inserted into the playback terminal 20a, the failure detection unit 232a instructs the medium reading unit 201 to read content data recorded on the recording medium 10a.

Then, the failure detection unit 232a monitors the data reading performed by the medium reading unit 201. In the case when the medium reading unit 201 fails in content data reading, the failure detection unit 232a indicates the request unit 233 to create a restoration data request, as the failure detection unit 232 of Embodiment 1.

When reading of all the content data has been completed normally, the failure detection unit 232a informs the data acquisition unit 235a accordingly; when an abnormal termination occurs as a result of reading failure, the failure detection unit 232a informs the data acquisition unit 235a accordingly.

(2) Data Access Unit 234a

Having the same function as the data access unit 234 of Embodiment 1, the data access unit 234a also has a function of, when recording of restoration data is completed, informing the data acquisition unit 235a accordingly.

(3) Data Acquisition Unit 235a

Having the same function as the data acquisition unit 235 of Embodiment 1, the data acquisition unit 235a also has a function of controlling the timing of the start of data acquisition.

Specifically speaking, the data acquisition unit 235a starts acquiring data in the case of receiving, from the failure detection unit 232a, a notification indicating that the data reading has been completed normally as well as receiving, from the data access unit 234a, a notification indicating completion of restoration data recording. This is in order to prevent content from being played back before completion of restoration data recording in the case where the restoration data is necessary for content playback.

Note that, in the case of no failure in data reading from the recording medium 10a, the data acquisition unit 235a needs no partial content data, and therefore playback of content data of the recording medium 10a is started immediately after the failure detection unit 232a finishes checking the recording medium 10a.

<Operation>

Here is described operation of the content playback system 2 according to Embodiment 2.

As has been described above, the content playback system 2 differs from the content playback system 1 of Embodiment 1 in the structure of the playback terminal 20a. Accordingly, the following describes only the operation of the playback terminal 20a.

(Operation of Overall Processes Performed by Playback Terminal 20a)

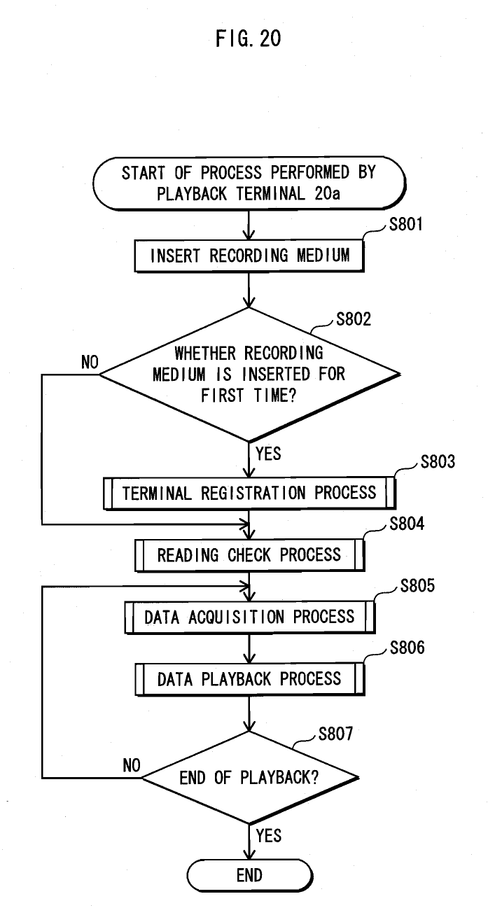

FIG. 20 is a flowchart showing operation of overall processes performed by the playback terminal 20a.

When the recording medium 10a is inserted into the playback terminal 20a (Step S801), the playback check unit 231 checks whether the recording medium 10a is to be played back for the first time.

In the case where the recording medium 10a is to be played back for the first time (Step S802: YES), the playback terminal 20a performs a terminal registration process (Step S803) and moves onto Step S804.

In the case where the recording medium 10a is to be played back not for the first time (Step S802: NO), after the terminal registration process of Step S803 is finished, the playback terminal 20a performs a reading check process (Step S804).

Then, the playback terminal 20a performs a data acquisition process for acquiring content data or partial content data to be played back from the recording medium 10a or the restoration data storage unit 205 (Step S805).

Details of Step S805 are largely similar to the flowchart of FIG. 14. Note however that Step S805 is different from Embodiment 1 in that the timing at which the data acquisition unit 235a starts the acquisition process is determined by a notification received from the failure detection unit 232a or data access unit 234a.

That is, in the reading check process at Step S804, if the data acquisition unit 235a receives from the failure detection unit 232a a notification indicating that reading of all the content data has been completed normally, the data acquisition unit 235a starts the data acquisition process right away. In the reading check process, if receiving from the failure detection unit 232a a notification indicating an occurrence of failure in content data reading, the data acquisition unit 235a waits for execution of the data acquisition process until receiving from the data access unit 234a a notification indicating completion of restoration data recording. Details of the data acquisition process are the same as those shown in the flowchart of FIG. 14, and accordingly their descriptions are omitted here.

Subsequently, the playback terminal 20a performs a data playback process for playing back the acquired content data or partial content data (Step S806). Since details of Step S806 are the same as those shown in the flowchart of FIG. 15, their descriptions are omitted here.

Then, in the case where playback of all the content is finished (Step S807: YES), the playback terminal 20a ends the process. In the case where playback of the content is not finished (Step S807: NO), the playback terminal 20a proceeds the playback location being currently played back, and returns to the data acquisition process of Step S805 to continue the content playback.

According to Embodiment 1, whether reading failure occurs during content playback is checked, and then in the case where reading failure occurs in the data acquisition process, the partial content data acquisition process is performed.

According to Embodiment 2, on the other hand, the processes of checking reading failure and the like are finished at Step S804 prior to the start of content playback, and therefore no reading failure basically occurs during content playback. Accordingly, the content distribution system does not basically need the process for checking reading failure during content playback.

Note however that the recording medium 10a may be damaged right after the reading check process, and therefore the content playback system 2 may have a function of checking reading failure during playback, as in Embodiment 1.

(Operation of Reading Check Process)

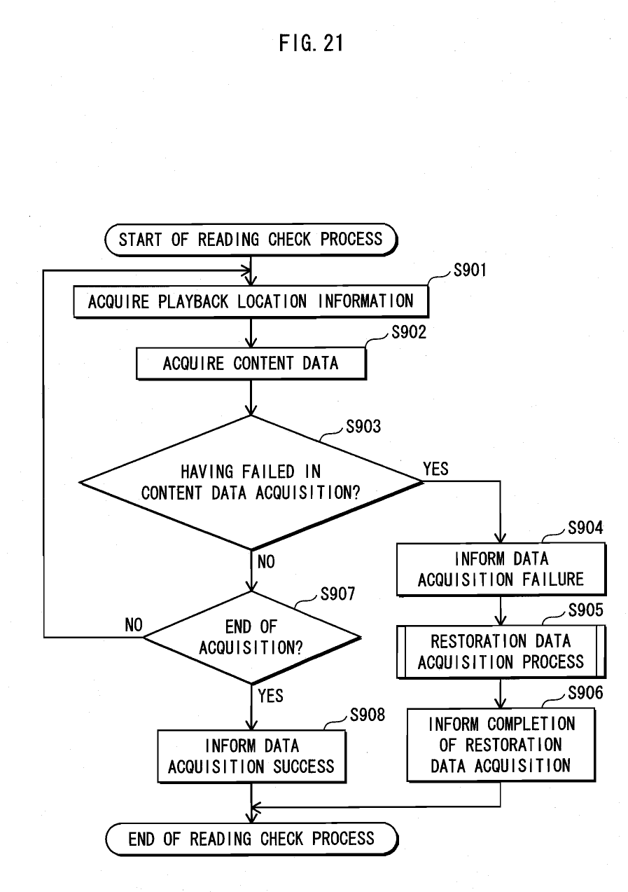

FIG. 21 is a flowchart showing operation of the reading check process performed by the playback terminal 20a. Note that the operation shown in this figure is a detail of Step S804 of FIG. 20.

First, the medium reading unit 201 acquires pieces of playback location information from the recording medium 10a (Step S901). The pieces of playback location information are acquired in accordance with the order starting, among pieces of content data recorded on the recording medium 10a, from the first piece of content data.

The medium reading unit 201 further acquires, from the recording medium 10a, pieces of content data corresponding to the pieces of playback location information (Step S902).

In the case when data reading is failed at either Step S901 or S902 (Step S903: YES), the failure detection unit 232a informs the data acquisition unit 235a of the data reading failure (Step S904). Furthermore, the failure detection unit 232a instructs the request unit 233 to create a restoration data request.

After receiving the instruction of creating a restoration data request, the request unit 233 performs the restoration data acquisition process (Step S905). Since details of Step S905 are the same as those shown in the flowchart of FIG. 16, their descriptions are omitted here.

When the restoration data acquisition process is completed, the data access unit 234a informs the data acquisition unit 235a about the completion of restoration data recording (Step S906).

On the other hand, data reading failure occurs at neither Step S901 nor S902 (Step S903: NO), the failure detection unit 232a checks whether all pieces of content data have been acquired. If the data acquisition has not been completed (Step S907: NO), the failure detection unit 232a advances the current playback location and then returns to Step S901 to continue acquisition of pieces of content data. If all pieces of content data have been acquired (Step S907: YES), the failure detection unit 232a informs the data acquisition unit 235a that data reading has been completed normally (Step S908).

As has been described, the playback terminal 20a of Embodiment 2 checks, prior to content playback, whether reading of the recording medium 10a is successful or not. In the case of reading failure, the playback terminal 20a acquires partial content data from the content distribution server 30a.

Herewith, when content of the recording medium 10a is played back, all data necessary for the playback is in place, and thus it is possible to have normal playback without interruption in the content even if the recording medium 10a is played back for the first time.

Note that, in the present embodiment, the failure detection unit 232a sends a notification to the data acquisition unit 235a when reading is completed normally as well as when reading is failed. However, a notification indicating normal completion may be omitted. In such a case, the data acquisition unit 235a may be designed so as not to start the data obtaining process until receiving a notification of reading failure from the failure detection unit 232a or receiving a notification indicating completion of restoration data acquisition from the data access unit 234a.

### Embodiment 3

Here is described a content playback system 3 as Embodiment 3 of the present invention.

In Embodiments 1 and 2 above, either the playback terminal 20 or 20a records restoration data in the restoration data storage unit 205, and then plays back content. In this case, for example, if reading failure occurs with respect to the entire recording medium, the data amount of partial content stored in the playback terminal is the same as in the case of recording the entire content.

In this view, Embodiment 3 shows a content playback system capable of reducing the recording amount of restoration data even if reading failure occurs with respect to the entire recording medium.

Specifically speaking, when reading failure occurs during content playback, the content playback system 3 sequentially receives, from the content distribution server, pieces of partial content data for locations at and following reading failure and sequentially streams the received pieces of partial content data. Herewith, the content playback system 3 is able to play back content seamlessly without accumulating restoration data in the playback terminal.

<Structure>

1. Overall Structure of Content Playback System 3

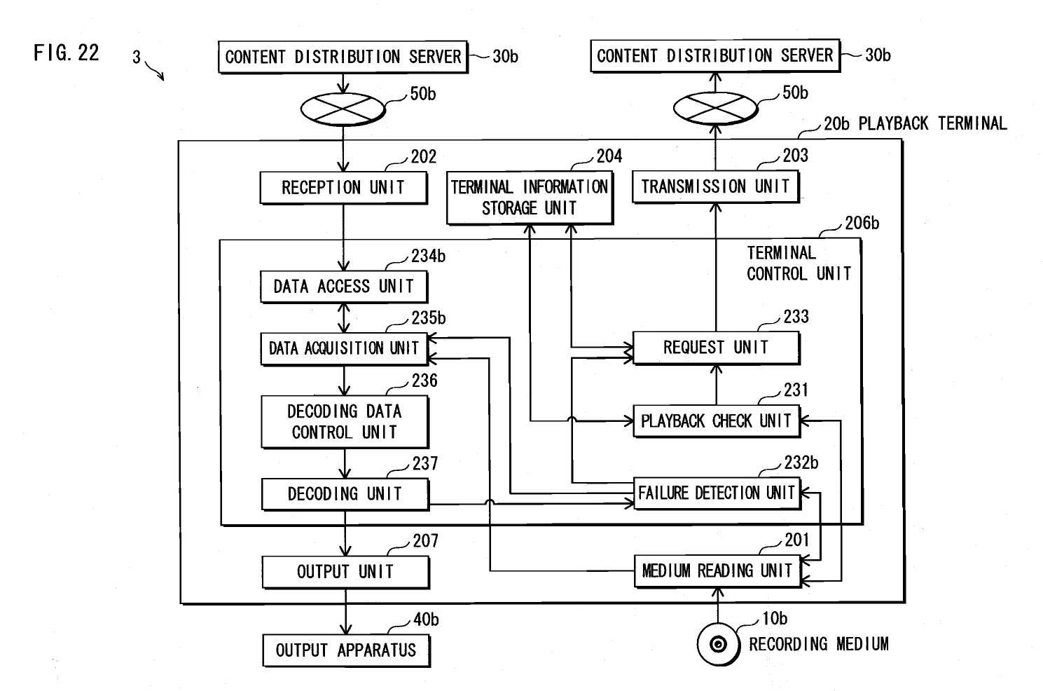

The content playback system 3 of Embodiment 3 includes a recording medium 10b, a playback terminal 20b, a content distribution server 30b and an output apparatus 40b. The playback terminal 20b and content distribution server 30b are connected via a communication channel 50b (See FIG. 22).

Since the recording medium 10b, content distribution server 30b, output apparatus 40b and communication channel 50b have the same structure and function as the recording medium 10, content distribution server 30, output apparatus 40 and communication channel 50, respectively, of Embodiment 1, their descriptions are omitted here.

The following describes the structure of the playback terminal 20b, which has a function different from its counterpart of Embodiment 1.

2. Structure of Playback Terminal 20b

FIG. 22 is a functional block diagram functionally showing the structure of the playback terminal 20b. Components to which the same reference symbols are given as in FIGS. 4 and 7 are functionally identical with those in Embodiment 1, and therefore their descriptions are omitted here.

The playback terminal 20b of the present embodiment is different from Embodiment 1 in the structures of a failure detection unit 232b, a data access unit 234b and a data acquisition unit 235b. Also according to the present embodiment, unlike Embodiments 1 and 2, the playback terminal 20b does not have to record restoration data received from the content distribution server 30b since it plays back the restoration data immediately after the reception. Accordingly, the playback terminal 20 does not have the restoration data storage unit 205.

(1) Failure Detection Unit 232b

Having the same function as the failure detection unit 232 of Embodiment 1, the failure detection unit 232b also has a function of, when detecting reading failure, outputting a notification of reading failure to the data acquisition unit 235b.

(2) Data Access Unit 234b

The data access unit 234b acquires restoration data from the content distribution server 30b via the reception unit 202, and sequentially sends out the acquired restoration data to the data acquisition unit 235b.

Restoration data does not necessarily reach the data access unit 234b from the content distribution server 30b in accordance with the rate of content playback, and therefore it is desirable that the data access unit 234b have a buffer for temporarily accumulating restoration data in order to eliminate fluctuation of the rate of restoration data reaching.

(3) Data Acquisition Unit 235b

The data acquisition unit 235b acquires content data or partial content data to be played back by the playback terminal 20b. Playing back either content data or partial content data depends on whether there is a notification of reading failure from the failure detection unit 232b.

Specifically speaking, until receiving a notification of reading failure from the failure detection unit 232b, the data acquisition unit 235b acquires content data and playback location information read by the medium reading unit 201 from the recording medium 10.

After receiving a notification of reading failure from the failure detection unit 232b, the data acquisition unit 235b acquires partial content data and playback location information from restoration data sequentially sent out from the data access unit 234b.

<Operation>

Here is described operation of the content playback system 3 according to Embodiment 3.

As has been described above, the content playback system 3 differs from the content playback system 1 of Embodiment 1 only in the structure of the playback terminal 20b. Accordingly, the following describes only the operation of the playback terminal 20b.

(Operation of Overall Processes Performed by Playback Terminal 20b)

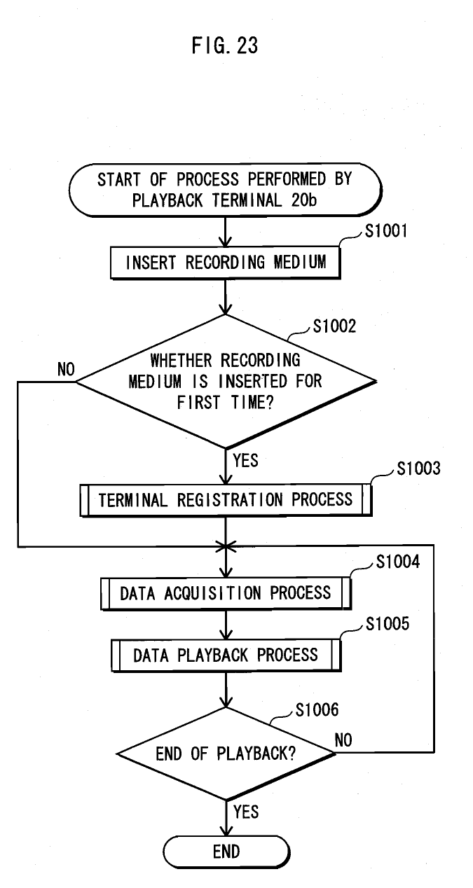

FIG. 23 is a flowchart showing operation of overall processes of the playback terminal 20b.

When the recording medium 10b is inserted into the playback terminal 20b (Step S1001), the playback check unit 231 checks whether the recording medium 10b is to be played back for the first time.

In the case where the recording medium 10b is to be played back for the first time (Step S1002: YES), the playback terminal 20b performs a terminal registration process (Step S1003) and moves onto Step S1004.

In the case where the recording medium 10b is to be played back not for the first time (Step S1002: NO), after the terminal registration process of Step S1003 is finished, the playback terminal 20b performs the data acquisition process (Step S1004).

Then, the playback terminal 20b performs a data playback process for playing back the content data or partial content data acquired at Step S1004 (Step S1005). Note that the process of Step S1005 is the same as that shown in the flowchart of FIG. 15, and accordingly the description is omitted here.

Then, in the case where playback of all the content is finished (Step S1006: YES), the playback terminal 20b ends the process. In the case where playback of the content is not finished (Step S1006: NO), the playback terminal 20b proceeds the playback location being currently played back, and returns to the data acquisition process of Step S1004 to continue the content playback.

(Operation of Data Acquisition Process)

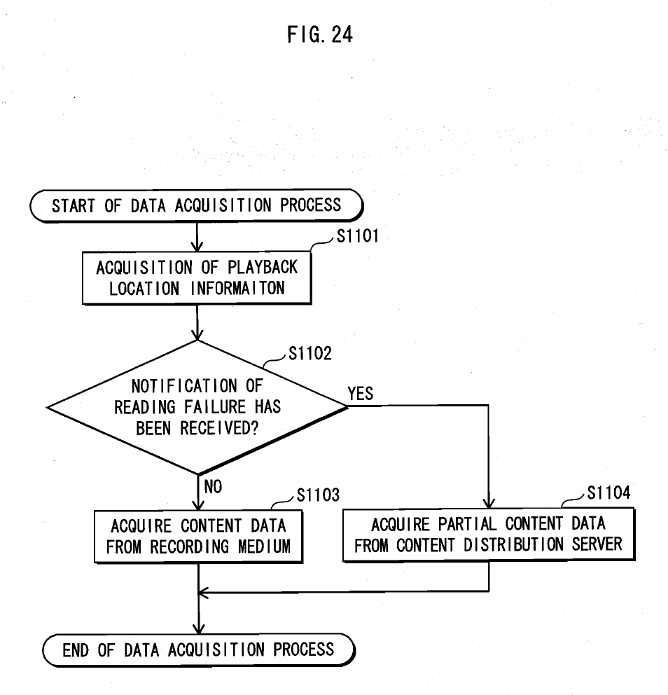

FIG. 24 is a flowchart showing operation of the data acquisition process performed by the playback terminal 20b. Note that the operation shown in this figure is a detail of Step S1004 of FIG. 23.

First, playback location information which indicates a location, within content, currently being played back is acquired (Step S1101). Here, the process of acquiring the playback location information is performed by the medium reading unit 201 when content data read from the recording medium 10b is being played back; it is performed by the data access unit 234b when partial content data acquired from the content distribution server 30b.

Subsequently, the data acquisition unit 235b checks whether a notification indicating reading failure on the recording medium 10b has been received from the failure detection unit. When a notification of reading failure has been received (Step S1102: YES) the data acquisition unit 235b acquires a piece of partial content data corresponding to the playback location information from the content distribution server 30b via the data access unit 234b, and outputs the piece of partial content data to the decoding data control unit 236. In the case a notification of reading failure is not received (Step S1102: NO), the data acquisition unit 235b acquires, from the recording medium 10b, a piece of content data corresponding to the playback location information, and outputs the piece of content data to the decoding data control unit 236.

As has been described, the playback terminal 20b of Embodiment 3 sequentially streams pieces of partial content data acquired from the content distribution server 30b during playback. Accordingly, even if failure in data reading from the recording medium 10b occurs, it is possible to normally and seamlessly play back content without accumulation of restoration data.

In the present embodiment, the playback terminal 20b acquires playback location information from the content distribution server 30b along with partial content data; however, the present invention is not limited to this structure. The playback terminal 20b may be designed to acquire only partial content data from the content distribution server 30b. It is because, in the present embodiment, data to be played back needs not to be rearranged since a piece of partial content data at a location of reading failure on the recording medium 10 is acquired as needed.

In the present embodiment, the playback terminal 20b does not record acquired pieces of partial content data; however, the present invention is not limited to this case. In order to eliminate fluctuation of the rate of pieces of partial content data reaching, a buffer may be provided to temporarily store therein the reached pieces of partial content data.

### Embodiment 4

Here is described a content playback system 4 as Embodiment 4 of the present invention.

<Structure>

1. Overall Structure of Content Playback System 4

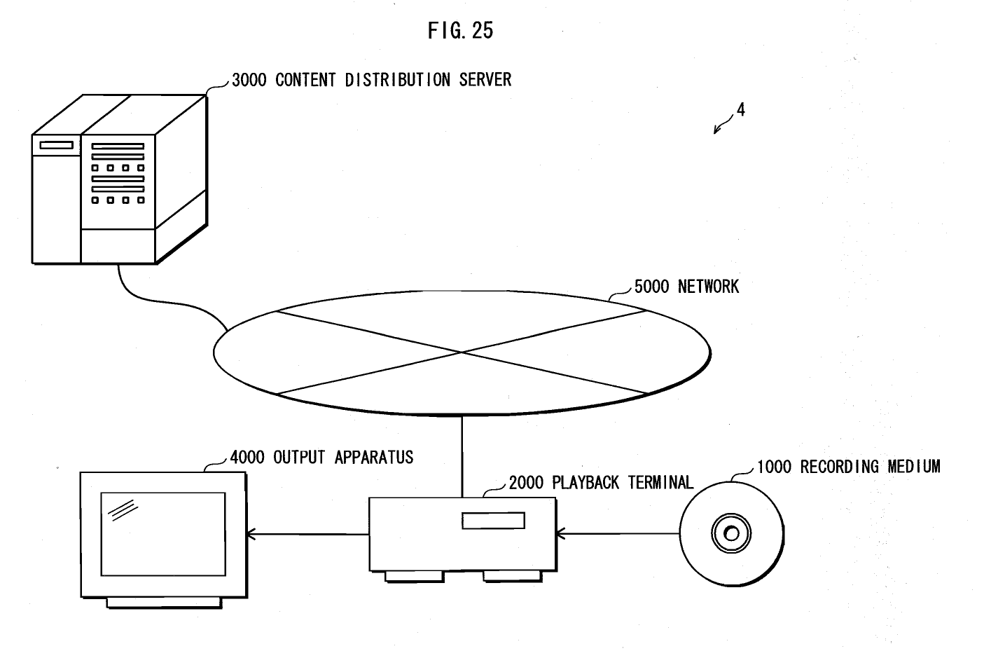

FIG. 25 shows the overall structure of the content playback system 4.

As shown in the figure, the content playback system 4 includes a recording medium 1000, a playback terminal 2000, a content distribution server 3000 and an output apparatus 4000. The playback terminal 2000 and content distributions server 3000 are connected via a communication channel 5000.

The content playback system 4 is a system in which the playback terminal 2000 plays back content recorded on the recording medium 1000, like the content playback system 1 according to Embodiment 1.

Having the same functions as the content playback system 1 of Embodiment 1, the content playback system 4 is also capable of, when the playback terminal 2000 plays back content data recorded on the recording medium 1000, replacing the content data with other data as necessary and playing back the replaced data.

The recording medium 1000 is a recording medium having thereon content recorded, and is considered to be a BD-ROM, like the recording medium 10.

The playback terminal 2000 is an apparatus for reading content from the recording medium 1000 and playing it back. The playback terminal 2000 is considered to be a BD player, like the playback terminal 20. If failing in data reading from the recording medium 1000, the playback terminal 2000 acquires, from the content distribution server 3000 via the communication channel 5000, data for locations at and following data reading failure, and records the acquired data. Furthermore, the playback terminal 2000 acquires replacement data from the content distribution server 3000 as necessary, and stores therein it.

In all playback sessions following data reading failure, the playback terminal 2000 plays back, for locations at and after which data reading failure has previously occurred, data acquired from the content distribution server 3000. For locations requiring data replacement, the playback terminal 2000 plays back replacement data acquired from the content distribution server 3000. For locations where no data reading failure has previously occurred and locations requiring no data replacement, the playback terminal 2000 plays back data of the recording medium 1000.

After receiving from the playback terminal 2000 a notification requesting content transmission, the content distribution server 3000 judges whether to consent to the content data transmission to the playback terminal 2000. When determining to consent to the transmission, the content distribution server 30 transmits to the playback terminal 2000 data for locations at and following data reading failure and replacement data. When determining to refuse the transmission, the content distribution server 30 transmits, to the playback terminal, refusal data indicating refusal of the content transmission.

The output apparatus 4000, like the output apparatus 40, is an apparatus for outputting content data output from the playback terminal 2000, and is specifically speaking a TV, a display, a speaker or the like.

The communication channel 5000 is a communication channel used for communicating information between the playback terminal 2000 and the content distribution server 3000. In the present embodiment, the communication channel 5000 is considered to be the Internet.

2. Data Structure of Recording Medium 1000

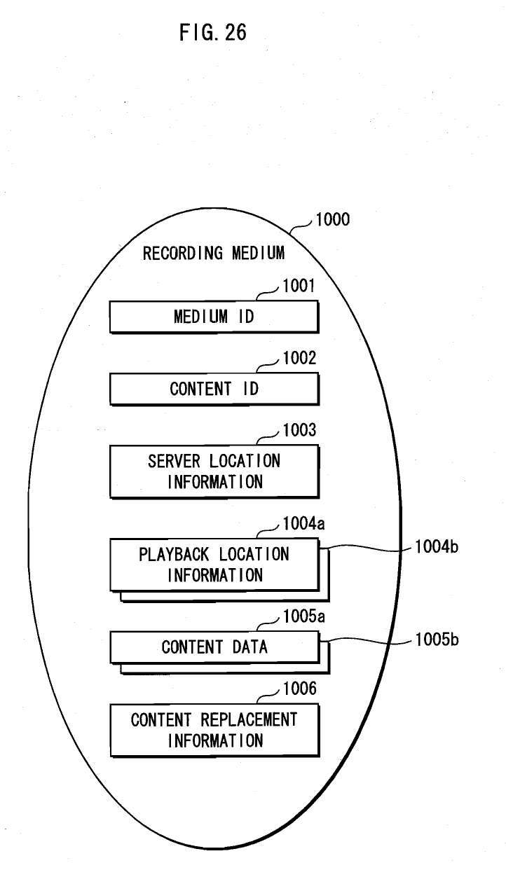

FIG. 26 shows information recorded on the recording medium 1000.

As shown in the figure, the recording medium 1000 records thereon: a medium ID 1001; a content ID 1002; server location information 1003; multiple pieces of playback location information 1004a, . . . , and 1004b; multiple pieces of content data 1005a, . . . , and 1005b; and content replacement information 1006.

The medium ID 1001, content ID 1002, server location information 1003, pieces of playback location information 1004a, . . . , and 1004b, and pieces of content data 1005a, . . . , and 1005b are the same as individual counterparts recorded in the recording medium 10 of Embodiment 1 (See FIGS. 2 and 3), and therefore the descriptions are omitted here.

The recording medium 1000 differs from the recording medium 10 of Embodiment 1 in recording therein the content replacement information 1006. The content replacement information 1006 is read by the playback terminal 2000 when the playback terminal 2000 plays back content recorded on the recording medium 1000, and used to judge the necessity of content data replacement.

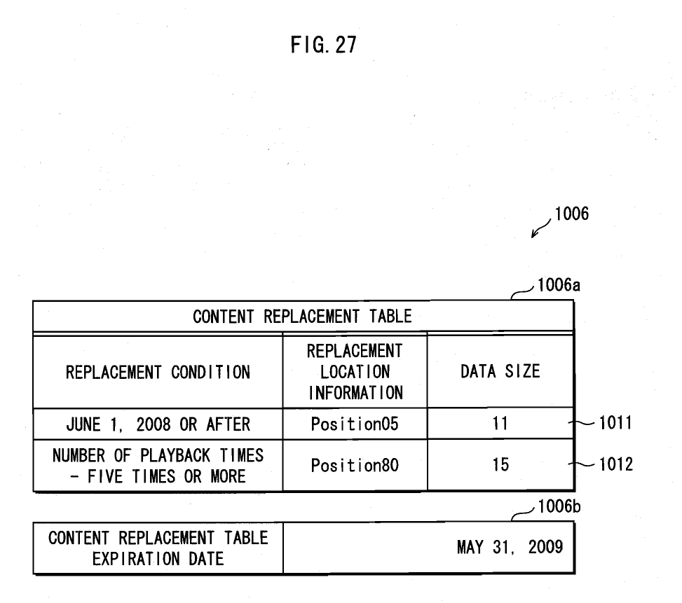

FIG. 27 shows a specific example of the content replacement information 1006. As shown in the figure, the content replacement information 1006 is made up of a content replacement table 1006a and a content replacement table 1006b.

The content replacement table 1006a includes two pieces of replacement information 1011 and 1012. Each piece of replacement information is made up of a replacement condition, replacement location information and a data size.

The replacement condition indicates a condition that requires replacement of content data included in the recording medium 1000. The replacement location information indicates the beginning of playback location of a piece of content data to be replaced. Assume that the format of the replacement location information is the same as those of the pieces of playback location information 1004a, and 1004b. The data size indicates the size of a piece of content data to be replaced. In the present embodiment, the count of pieces of content data is used as the data size.

The replacement condition of the piece of replacement information 1011 is “Jun. 1, 2008 or later”; the replacement location information, “Position05”; and the data size, “11”. These indicate that, in the case where content recorded on the recording medium 1000 is played back on Jun. 1, 2008 or later, it is necessary to replace eleven pieces of content data, which start from the playback location, Position05.

Also, the replacement condition of the piece of replacement information 1012 is “the number of playback times is 5 times or more”; the replacement location information, “Position80”; and the data size, “15”. These indicate that, in the case where content recorded on the recording medium 1000 has been played back five times or mote, it is necessary to replace fifteen pieces of content data, which start from the playback location, Position80.

The content replacement table expiration data 1006b indicates an expiration time of the content replacement table 1006a. Since the content replacement table expiration data 1006b is “May 31, 2009”, and therefore the playback terminal 2000 cannot judge the necessity of content data replacement using the content replacement table 1006a on and after Jun. 1, 2009.

3. Structure of Playback Terminal 2000

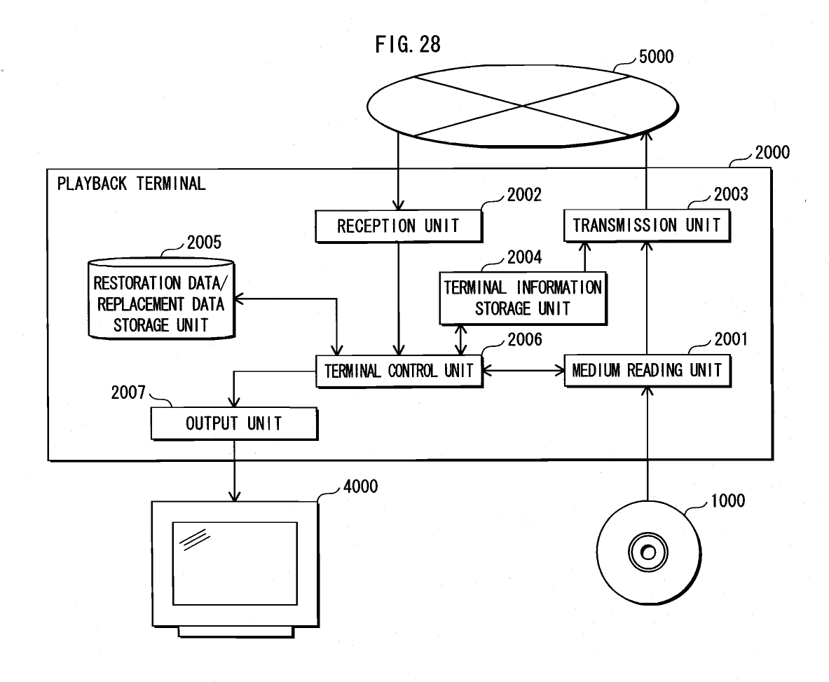

FIG. 28 is a functional block diagram functionally showing the structure of the playback terminal 2000.

As shown in the figure, the playback terminal 2000 includes a medium reading unit 2001, a reception unit 2002, a transmission unit 2003, a terminal information storage unit 2004, a restoration data/replacement data storage unit 2005, a terminal control unit 2006 and an output unit 2007.

The playback terminal 2000 is, specifically speaking, a computer system composed of a CPU, ROM, RAM, a hard-disk unit and the like. The playback terminal 2000 fulfills its functions when the CPU executes a computer program recorded in the ROM, RAM or hard-disk unit.

The playback terminal 2000 has the same functions as the playback terminal 20 of Embodiment 1. In addition to the same functions as the playback terminal 20, the playback terminal 2000 further has a function of obtaining pieces of replacement data from the content distribution server 3000 and performing playback while replacing pieces of content data with pieces of replacement data.

The following omits detailed explanations for the same functions as those of the playback terminal 20, and focuses on functions characteristic of the playback terminal 2000.

(1) Medium Reading Unit 2001

The medium reading unit 2001 is, specifically speaking, a BD-ROM drive.

According to instructions of the terminal control unit 2006, the medium reading unit 2001 reads, from the recording medium 1000, the medium ID 1001, content ID 1002, server location information 1003, pieces of playback location information 1004a, . . . , and 1004b, pieces of content data 1005a, . . . , and 1005b, and content replacement information 1006.

(2) Reception Unit 2002 and Transmission Unit 2003

The reception unit 2002 and transmission unit 2003 are realized by network connection units.

The reception unit 2002 receives, from the content distribution server 3000, restoration data, replacement data, refusal data and update data.

The transmission unit 2003 transmits, to the content distribution server 3000, a registration request, a restoration data request, a replacement data request and an update data request.

A replacement data request is information transmitted to the content distribution server 3000 when pieces of content data on the recording medium 1000 have to be replaced. A replacement data request includes: the terminal ID of the playback terminal 2000; the medium ID 1001; the content ID 1002; and replacement location information and data size indicating pieces of content data necessary to be replaced.

An update data request is information transmitted to the content distribution server 3000 when the expiration data of the content replacement table 1006a expires. An update data request includes the terminal ID of the playback terminal 2000, the medium ID 1001 and the content ID 1002.

(3) Terminal Information Storage Unit 2004

The terminal information storage unit 2004 is, specifically speaking, realized by a flash memory.

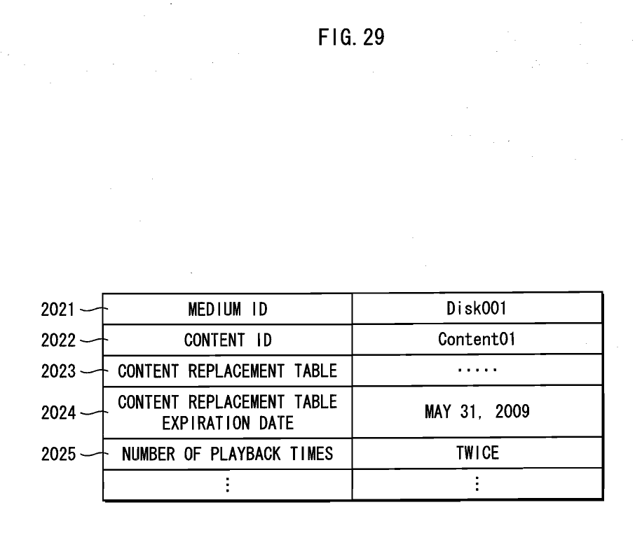

The terminal information storage unit 2004 stores therein various types of information shown in FIG. 29, in addition to the terminal-unique data of FIG. 5.

As shown in FIG. 29, the terminal information storage unit 2004 records therein a medium ID 2021, a content ID 2022, a content replacement table 2023, a content replacement table expiration data 2024, and number of playback times 2025. Note that FIG. 29 does not depict specific details of the content replacement table 2023; however, the content of the content replacement table 2023 is the same as that of the content replacement table 1006a shown in FIG. 27.

The medium ID 2021, content ID 2022, content replacement table 2023, and content replacement table expiration data 2024 are information read by the medium reading unit 2001 from the recording medium 1000.

The number of playback times 2025 is information indicating the number of times that a recording medium identified by the medium ID 2021 has been played back on the playback terminal 2000. According to the example of FIG. 29, since the number of playback times 2025 is “2”, it is understood that the recording medium 1000 has been played back on the playback terminal 2000 twice so far.

(4) Restoration Data/Replacement Data Storage Unit 2005

The restoration data/replacement data storage unit 2005 is, specifically speaking, realized by a hard-disk unit, and stores therein restoration data and replacement data received from the content distribution server 3000.

Note that the data structure of restoration data recorded in the restoration data/replacement data storage unit 2005 is the same as in Embodiment 1, and therefore the description is omitted here (See FIG. 6).

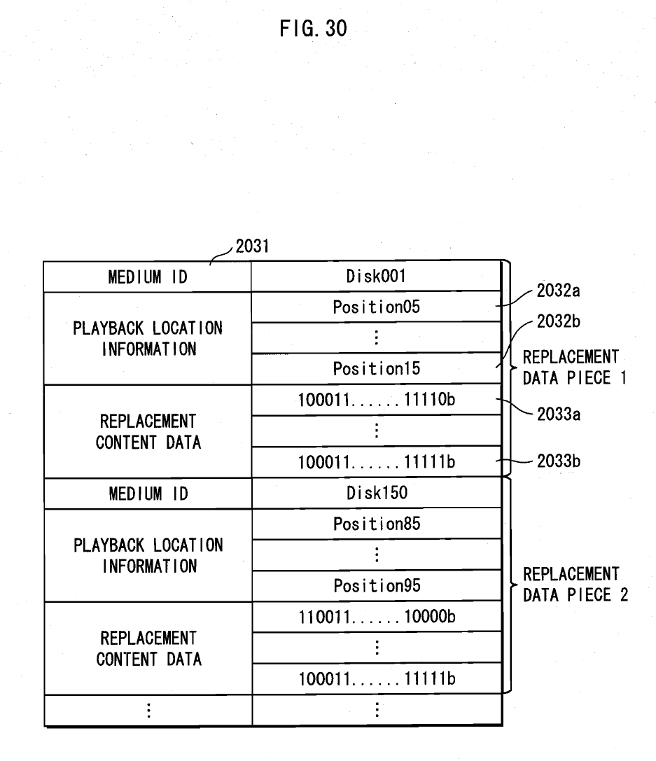

FIG. 30 shows a specific data structure of replacement data recorded in the restoration data/replacement data storage unit 2005.

As shown in the figure, in the restoration data/replacement data storage unit 2005, multiple pieces of replacement data, including replacement data pieces 1 and 2, are recorded. Each piece of replacement data is made up of a medium ID, one or more pieces of playback location information and one or more replacement content data.

The medium ID indicates a recording medium requiring content data replacement. Pieces of playback location information are in one-to-one correspondence with pieces of replacement content data. Each piece of playback location information indicates a location of, within the content, its corresponding piece of replacement content data. With these pieces of playback location information, the playback order of the respective pieces of content data can be also understood.

For example, a piece of playback location information 2032a corresponds to a piece of replacement content data 2033a, and indicates the location of the piece of replacement content data 2033a. A piece of playback location information 2032b corresponds to a piece of replacement content data 2033b, and indicates the location of the piece of replacement content data 2033b.

The replacement content data is pieces of data, which have been formed by dividing the content into predetermined units, like the content data and partial data of Embodiments 1-3.

A piece of replacement content data has a content that is different from that of a piece of content data and a piece of partial content data having the same playback location information.

Pieces of playback location information and pieces of replacement content data included in the replacement data include pieces of playback location information and pieces of replacement content data for a range requiring content data replacement.

A medium ID of the replacement data piece 1, “Disk001” (2031), is a medium ID identifying the recording medium 1000. Therefore, when playing back the recording medium 1000, the playback terminal 2000 plays back, instead of pieces of content data recorded on the recording medium 1000, the pieces of replacement content data 2033a, . . . , and 2033b for the region starting at a location indicated by the piece of playback location information “Position05” (2032a) and ending at a location indicated by the piece of playback location information “Position15” (2032b).

(5) Terminal Control Unit 2006

The terminal control unit 2006 is composed of a CPU, ROM, RAM and the like, and realizes various functions by executing a control program recorded in, for example, the ROM using the CPU and RAM.

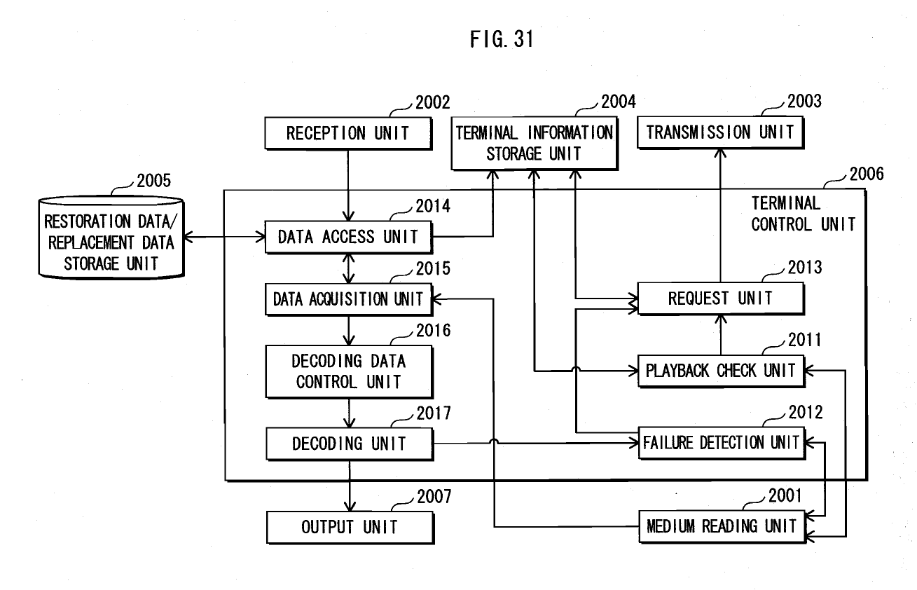

FIG. 31 is a functional block diagram functionally showing the internal structure of the terminal control unit 2006.

As shown in the figure, the terminal control unit 2006 is made up of a playback check unit 2011, a failure detection unit 2012, a request unit 2013, a data access unit 2014, a data acquisition unit 2015, a decoding data control unit 2016, and a decoding unit 2017.

The playback check unit 2011 has the following functions, in addition to functions that the playback check unit 231 of Embodiment 1 has.

In the case where the playback check unit 2011 is a recording medium to be played back for the first time, the playback check unit 2011 generates information shown in FIG. 29 and records it in the terminal information storage unit 2004. Specifically speaking, the playback check unit 2011 acquires, from the medium reading unit 2011, the medium ID 1001, content ID 1002 and content replacement information 1006 read by the medium reading unit 2001 from the recording medium, and generates the information of FIG. 29 by making the acquired information in correspondence with each other. At this point, the number of playback times is set to “0”.

The playback check unit 2011 also has a function of updating information having recorded in the terminal information storage unit 2004 when content recorded on the recording medium 1000 is played back. Specifically speaking, the playback check unit 2011 overwrites the information after adding 1 to the number of playback times having recorded in the terminal information storage unit 2004 each time when the content is played back.

The playback check unit 2011 also has a clock inside and manages the current date and time. At playback of the recording medium 1000, the playback check unit 2011 judges based on the content replacement table 2023 recorded in the terminal information storage unit 2004, whether it is necessary to acquire pieces of replacement content data from the content distribution server 3000. Note that, since being the same as the data of the content replacement table 1006a shown in FIG. 27, data of the content replacement table 2023 is explained here using FIG. 27.

The playback check unit 2011 extracts the piece of replacement information 1011 from the content replacement table 1006a, and further extracts the replacement condition “Jun. 1, 2008 or later” from the piece of replacement information 1011. Then, the playback check unit 2011 judges whether the current date and time meet the replacement condition. For example, if the current date and time managed inside is “Jun. 1, 2008”, the playback check unit 2011 determines the necessity of acquiring pieces of replacement content data. If the current date and time are “Apr. 15, 2008”, the playback check unit 2011 determines that it is not necessary to acquire pieces of replacement content data.

Next, the playback check unit 2011 extracts the piece of replacement information 1012 from the content replacement table 1006a, and further extracts the replacement condition “the number of playback times is 5 times or more” from the piece of replacement information 1012.

The playback check unit 2011 reads the number of playback times from the terminal information storage unit 2004. Then, the playback check unit 2011 judges whether the number of playback times read from the terminal information storage unit 2004 meets the replacement condition. For example, if the number of playback times read from the terminal information storage unit 2004 is “five times”, the playback check unit 2001 determines the necessity of acquiring pieces of replacement content data. If the number of playback times read from the terminal information storage unit 2004 is “twice”, the playback check unit 2011 determines that it is not necessary to acquire pieces of replacement content data.

When determining the necessity of acquiring pieces of replacement content data, the playback check unit 2011 outputs the following to the request unit 2013 together with an instruction to create a replacement data request: the medium ID 1001 and content ID 1002 read by the medium reading unit 2001 from the recording medium 1000; the terminal ID of the playback terminal 2000 read from the terminal information storage unit 2004; and replacement location information and data size extracted from the content replacement table 1006a.

Furthermore, the playback check unit 2011 judges the necessity of updating the content replacement table 1006a recorded in the terminal information storage unit 2004.

Specifically speaking, the playback check unit 2011 reads the content replacement table expiration time “May 31, 2009” (2024) from the terminal information storage unit 2004. Then, the playback check unit 2011 judges whether the current date and time have not exceeded the content replacement table expiration time. For example, if the current date and time managed inside are “Jun. 1, 2009”, the playback check unit 2011 determines the necessity of updating the content replacement table 1006a. If the current date and time are “May 31, 2009”, the playback check unit 2011 determines that an update of the content replacement table 1006a is not necessary.

When determining the necessity of updating the content replacement table 1006a, the playback check unit 2011 outputs the following to the request unit 2013 together with an instruction to create an update data request: the medium ID 1001 and content ID 1002 read by the medium reading unit 2001 from the recording medium 1000; and the terminal ID of the playback terminal 2000 read from the terminal information storage unit 2004.

The failure detection unit 2012 has the same function as that of the failure detection unit 232 of Embodiment 1.

When receiving an instruction from the playback check unit 2011, the request unit 2013 creates a registration request, a replacement data request, and an update data request. Also, as receiving an instruction from the failure detection unit 2012, the request unit 2013 creates a restoration data request.

The request unit 2013 transmits the created registration request, replacement data request, update data request, and restoration data request to the content distribution server 3000 via the transmission unit 2003 and communication channel 5000.

When receiving restoration data and replacement data from the content distribution server 3000 via the reception unit 2002, the data access unit 2014 records the received restoration data and replacement data in the restoration data/replacement data storage unit 2005.

When receiving update data from the content distribution server 3000 via the reception unit 2002, the data access unit 2014 updates, using the received update data, the content replacement table 2023 and content replacement table expiration time 2024 recorded in the terminal information storage unit 2004.

Specifically speaking, the data access unit 2014 determines, in the terminal information storage unit 2004, a content replacement table and a content replacement table expiration time corresponding to a content ID that matches a content ID included in the update data. The data access unit 2014 makes the replacement condition, replacement location information and data size included in the update data in correspondence with each other to thereby create a new piece of replacement information. Note that, in the case where the update data includes multiple sets of replacement condition, replacement location information and data size, the data access unit 2014 creates multiple new pieces replacement information. Then, the data access unit 2014 overwrites a piece of replacement information of the determined content replacement table with the new piece of replacement information. Furthermore, the data access unit 2014 overwrites the determined content replacement table expiration time with a content replacement table expiration data included in the update data.

In response to a request from the data acquisition unit 2015, the data access unit 2014 reads pieces of playback location information and partial content data from the restoration data/replacement data storage unit 2005, and outputs the read pieces of playback location information and partial content data to the data acquisition unit 2015. Furthermore, in response to a request from the data acquisition unit 2015, the data access unit 2014 reads pieces of playback location information and replacement content data from the restoration data/replacement storage unit 2005. The data access unit 234 outputs the read pieces of playback location information and replacement content data to the data acquisition unit 2015.

At content playback, the data acquisition unit 2015 acquires pieces of content data recorded on the recording medium 1000, or pieces of partial content data and replacement content data recorded in the restoration data/replacement data storage unit 2005.

Furthermore, during playback of a piece of content data recorded on the recording medium 1000, the data acquisition unit 2015 acquires, from the medium reading unit 2001, the medium ID 1001 of the recording medium 1000 and a piece of playback location information indicating a location being currently played back.

During playback of a piece of partial content data recorded in the restoration data/replacement data storage unit 2005, the data acquisition unit 2015 acquires, from the restoration data/replacement data storage unit 2005, a medium ID corresponding to the piece of partial content data being played back and a piece of playback location information indicating a location being currently played back.

During playback of a piece of replacement content data recorded in the restoration data/replacement data storage unit 2005, the data acquisition unit 2015 acquires, from the restoration data/replacement data storage unit 2005, a medium ID corresponding to the piece of replacement content data being played back and a piece of playback location information indicating a location being currently played back.

In the case where a medium ID corresponding to pieces of content data to be played back and pieces of playback location information are not recorded in the restoration data/replacement data storage unit 2005, the data acquisition unit 2015 reads pieces of content data corresponding to the pieces of playback location information from the recording medium 1000, and outputs the piece of content data to the decoding data control unit 2016 together with the piece of playback location information.

On the other hand, in the case where an medium ID corresponding to pieces of content data to be played back and pieces of playback location information are recorded in the restoration data/replacement data storage unit 2005, the data acquisition unit 2015 reads, from the restoration data/replacement data storage unit 2005, pieces of partial content data or pieces of replacement content data corresponding to the pieces of playback location information, and outputs the read pieces to the decoding data control unit 236 together with the pieces of playback location information.

The decoding data control unit 2016 acquires, from the data acquisition unit 2015, pieces of playback location information and pieces of content data, pieces of playback location information and pieces of partial content data, and pieces of playback location information and pieces of replacement content data. Then, the decoding data control unit 2016 respectively rearranges buffered pieces of content data, pieces of partial content data and replacement content data into a proper playback order in accordance with the pieces of playback location information, and then outputs them to the decoding unit 2017.

The decoding unit 2017 has the same function as that of the decoding unit 237 of Embodiment 1.

(6) Output Unit 2007

The output unit 2007 has the same function as that of the output unit 207 of Embodiment 1, and therefore the detailed explanation is omitted here.

Note that the internal structure of the terminal control unit 2006 shown in FIG. 31 can be incorporated into an integrated circuit. Also, when the restoration data/replacement data storage unit 2005 and terminal information storage unit 2004 are realized by not a hard-disk but a flash memory or the like, it is possible to incorporate also these units into an integrated circuit.

4. Structure of Content Distribution Server 3000

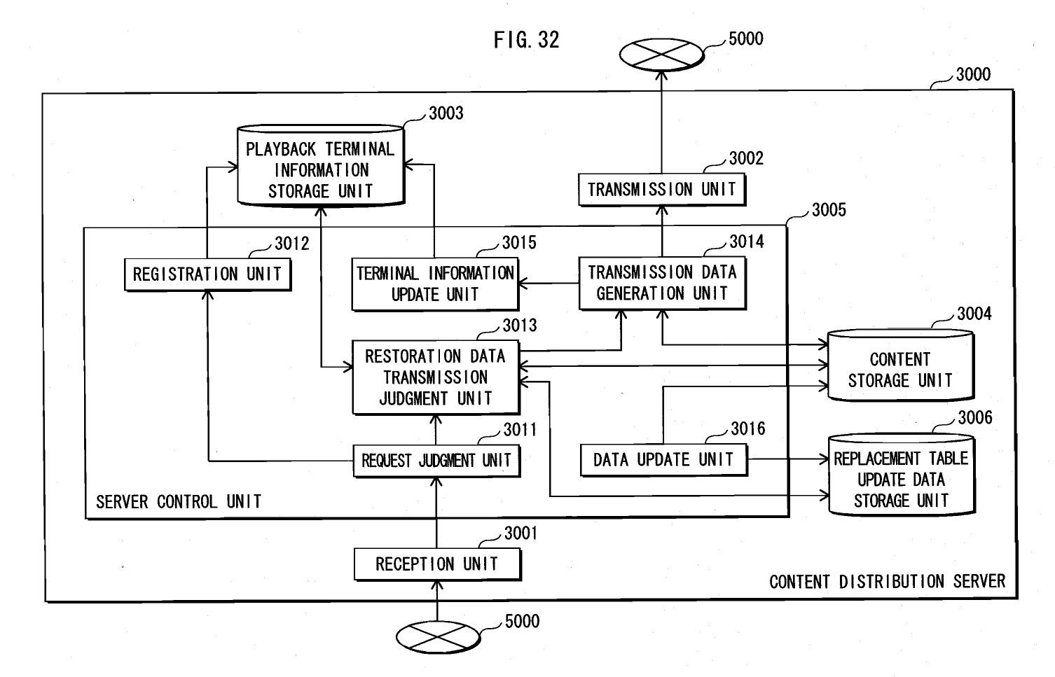

FIG. 32 is a functional block diagram functionally showing the structure of the content distribution server 3000.

As shown in the figure, the content distribution server 3000 includes a reception unit 3001, a transmission unit 3002, a playback terminal information storage unit 3003, a content storage unit 3004, a server control unit 3005, and a replacement table update data storage unit 3006.

The content distribution server 3000 is, specifically speaking, a computer system composed of a CPU, ROM, RAM, a hard-disk unit and the like. The content distribution server 3000 fulfills its functions when the CPU executes a computer program recorded in the ROM, RAM or hard-disk unit.

The content distribution server 3000 has the same function as that of the content distribution server 30 of Embodiment 1. In addition to the function that the content distribution server 30 has, the content distributions server 3000 also has a function of providing the playback terminal 2000 with pieces of replacement data and a function of providing the playback terminal 2000 with pieces of update data used for updating the content replacement table.

Accordingly, the following omits detailed explanations for the same functions as those of the content distribution server 30, and focuses on functions characteristic of the content distribution server 3000.

(1) Reception Unit 3001 and Transmission Unit 3002

The reception unit 3001 and transmission unit 3002 are realized by network connection units.

The reception unit 3001 receives, from the playback terminal 2000, a registration request, a restoration data request, a replacement data request and an update data request.

The transmission unit 3002 transmits, to the playback terminal 2000, restoration data, replacement data, refusal data and update data.

(2) Structure of Content Distribution Server 3003

The playback terminal information storage unit 3003 is realized by a hard disk or a flash memory. The layback terminal information storage unit 3003 has the same function as that of the playback terminal information storage unit 303 of Embodiment 1. That is, the playback terminal information storage unit 3003 records therein the management information shown in FIG. 9 and manages transmission state of partial content data with respect to each playback terminal.

(3) Content Storage Unit 3004

The content storage unit 3004 is realized by a hard disk or a flash memory.

The content storage unit 3004 records therein partial content data delivered by the content distributions server 3000 and management information regarding the partial content data (information shown in FIG. 10), like the content storage unit 304 of Embodiment 1.

The storage unit 304 of Embodiment 1 records therein pieces of partial content data corresponding to all pieces of content data recorded on the recording medium 10. In the same way, the content storage unit 3004 of the present embodiment records therein pieces of partial content data corresponding to all pieces of content data recorded on the recording medium 1000 so as to allow appropriate pieces of partial content data to be delivered if the playback terminal 2000 fails in data reading at any location on the recording medium 1000.

The content storage unit 3004 records therein pieces of replacement content data and management information regarding the pieces of replacement content data, in addition to the information of FIG. 10.

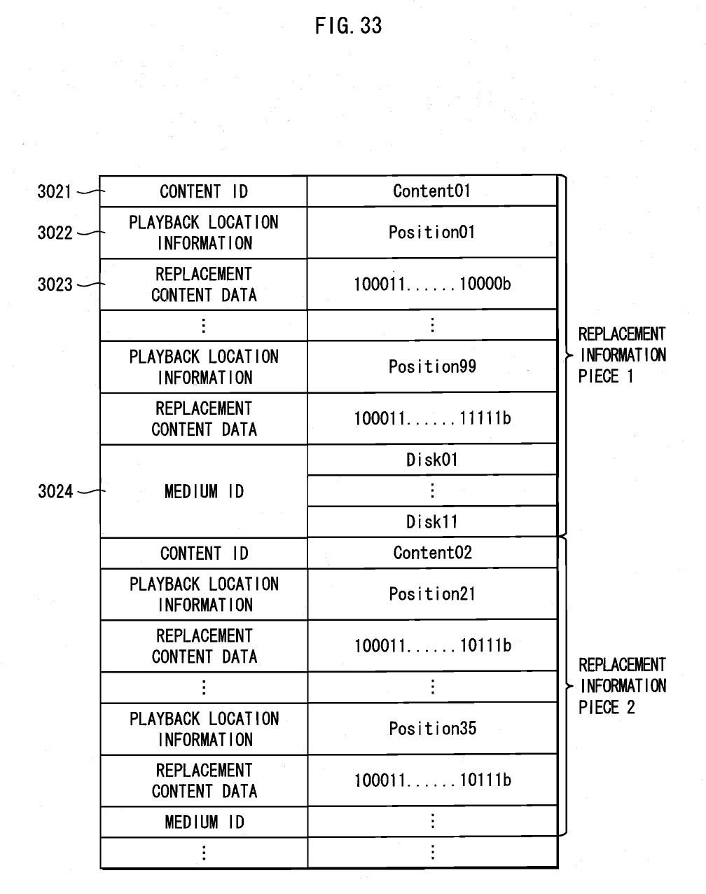

FIG. 33 shows data structures of replacement content data and management information recorded in the content storage unit 3004. As shown in the figure, multiple pieces of replacement information, including replacement information pieces 1 and 2, are recorded in the content storage unit 3004. Each piece of replacement information includes a content ID, multiple pieces of playback location information, multiple pieces of replacement content data and one or more medium IDs.

The content ID included in each piece of replacement information has the same format as that of the content ID 1002 recorded in the recording medium 1000. Also, each piece of playback location information included in a piece of replacement information has the same format as that of each piece of playback location information recorded in the recording medium 1000. Furthermore, the medium IDs included in a piece of replacement information has the same format as that of the medium ID 1001 recorded in the recording medium 1000.

The content ID is information for identifying content which can be delivered by the content distribution server 3000. In the specific example shown in FIG. 33, the content ID 3021 included in the replacement information piece 1 is “Content01”.

Pieces of playback location information and pieces of replacement content data here are the same as those explained in the description of FIG. 30. Namely, pieces of playback location information are in one-to-one correspondence with pieces of replacement content data. Pieces of replacement content data are data created by dividing the content into predetermined units, and a piece of playback location information indicates where in the playback order its corresponding piece of replacement content data is located. For example, in the specific example of FIG. 33, a playback location information piece 3022 corresponds to a replacement content data piece 3023, and indicates where in the playback order the replacement content data piece 3023 is located.

The medium IDs included in a piece of replacement information are information for identifying recording media having content recorded thereon. According to the replacement information piece 1 of FIG. 33, it can be seen that content identified by the content ID “Content01” (3021) is recorded on a recording medium identified by the medium ID “Disk01”, a recording medium identified by the medium ID “Disk11” and so on. The medium IDs included in a piece of replacement information is used to judge whether a replacement data request has been transmitted from a playback terminal that is playing a valid recording medium. A detailed explanation of the judgment is given hereinafter.

As to pieces of replacement content data, the content storage unit 3004 does not have to record therein pieces of replacement content data corresponding to all pieces of content data recorded on the recording medium 1000, unlike in the case of pieces of partial content data. It is sufficient if the content storage unit 3004 records only pieces of replacement content data corresponding to pieces of content data necessary to be replaced.

The content storage unit 3004 reads, from among recorded pieces of partial content data and replacement content data, pieces of partial content data and replacement content data to be transmitted to the playback terminal 2000 in accordance with instructions from the server control unit 3005.

(4) Replacement Table Update Data Storage Unit 3006

The replacement table update data storage unit 3006 is realized by a hard disk or a flash memory. The replacement table update data storage unit 3006 is a component characteristic of Embodiment 4, and records therein data necessary to update the content replacement table and content replacement table expiration date recorded in the terminal information storage unit 2004 of the playback terminal 2000.

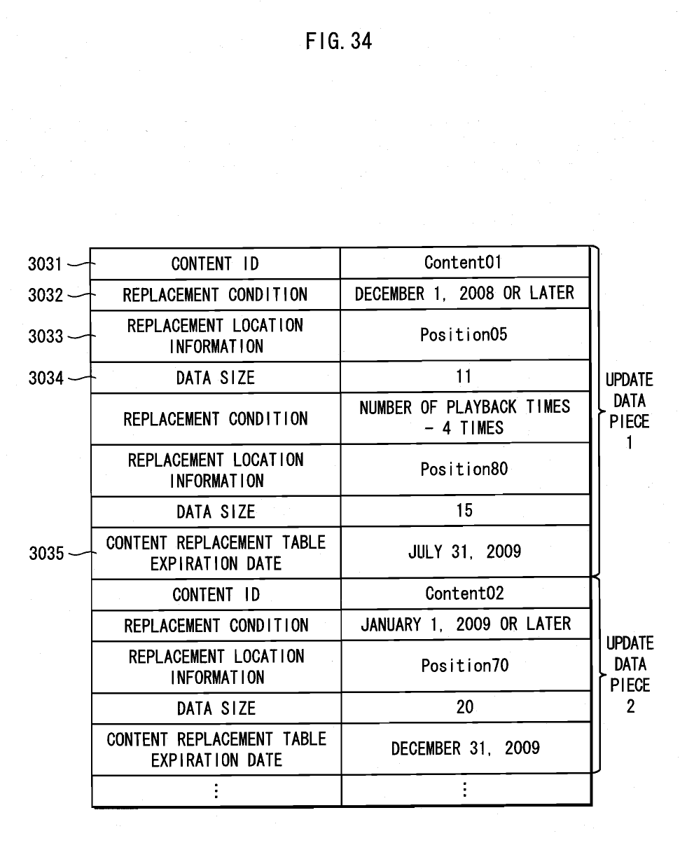

FIG. 34 shows a data structure of information recorded in the replacement table update data storage unit 3006.

As shown in the figure, the replacement table update data storage unit 3006 records therein multiple pieces of update data, including update data pieces 1 and 2. Each piece of update data includes a content ID, a content replacement table expiration time and one or more groups made up of a replacement condition, replacement location information and a data size.

The update data piece 1 shown in FIG. 34 is data used for updating the content replacement table 2023 and content replacement table expiration data 2024 recorded on the terminal information storage unit 2004.

The update data piece 1 includes: the a content ID “Content01” (3031); a replacement condition “Dec. 1, 2008 or later” (3032); replacement location information “Position05” (3033); a data size “11” (3034), . . . , and a content replacement table expiration time “Jul. 31, 2009” (3035).

The content ID “Content01” (3031) is identification information for identifying content whose content replacement table and content replacement table expiration time information are to be updated using the update data piece 1.

The replacement condition “Dec. 1, 2008 or later” (3032), replacement location information “Position05” (3033), and data size “11” (3034) are information necessary to generate one piece of replacement information (see the pieces of replacement information 1011 and 1012 in FIG. 27). Similarly, the replacement information “the number of playback times is four times or more”, replacement location information “Position80” and data size “15” are information necessary to generate one piece of replacement information.

The content replacement table expiration time information “Jul. 31, 2009” (3035) is information indicating an expiration time of a content replacement table after an update using the update data piece 1.

As has been described, the update process of the content replacement table 2023 and content replacement table expiration time 2024 is performed by the data access unit 2014 of the playback terminal 2000.

(5) Server Control Unit 3005

The server control unit 3005 controls the entire content distribution server 3000. The server control unit 3005 realizes various functions by executing a control program recorded in, for example, the ROM using the CPU and RAM. In addition, the server control unit 3005 may be implemented by hardware.

The server control unit 3005 includes, as shown in FIG. 32, a request judgment unit 3011, a registration unit 3012, a registration data transmitting judgment unit 3013, a transmission data generation unit 3014, a terminal information update unit 3015 and a data update unit 3016.

The request judgment unit 3011 receives a request received by the reception unit 3001 from the playback terminal 2000, and judges the received request is which one of the following: a registration request; a restoration data request; a replacement data request; and an update data request. If terminal location information is not included in the received request, the request judgment unit 3011 determines that the received request is a registration request. In the present embodiment, with respect to each restoration data request, replacement data request and update date request, information indicating what type of request it is attached thereto. Accordingly, in the case where terminal location information is included in a received request, the request judgment unit 3011 judges which one of the following the received request is: a restoration data request; a replacement data request; and an update data request.

As a result of the judgment, if it is a registration request, the request judgment unit 3011 outputs the received request to the registration unit 3012. As a result of the judgment, if it is a restoration data request, a replacement data request or an update data request, the request judgment unit 3011 outputs the received request to the restoration data transmitting judgment unit 3013 as well as the transmission data generation unit 3014.

When receiving a registration request from the request judgment unit 3011, the registration unit 3012 performs a registration process the same as the process performed by the registration unit 332 of Embodiment 1.

When receiving a restoration data request, replacement data request or update data request from the request judgment unit 3011, the restoration data transmitting judgment unit 3013 judges whether the requested restoration data, replacement data or update data can be transmitted to the playback terminal 2000.

The judgment for a restoration data request is the same as in Embodiment 1, and therefore the explanation is omitted here. The following describes a judgment in the case of receiving a replacement data request and an update data request.

The restoration data transmitting judgment unit 3013 checks whether the same information as a terminal ID and a medium ID included in a replacement data or an update data request is recorded in the playback terminal information storage unit 3003.

The same information being not recorded means that replacement data or update data for a non-registered recording medium has been requested from a non-registered playback terminal. Accordingly, the restoration data transmission judgment unit 3013 judges the request to be invalid and determines to refuse transmission of replacement data or update data.

In the case of determining that the same information has been recorded therein, the restoration data transmission judgment unit 3013 judges the request to be valid and determines to consent to transmission of replacement data or update data.

After finishing the judgment of whether restoration data, replacement data, or update data can be transmitted, the restoration data transmission judgment unit 3013 notifies the transmission data generation unit 3014 of the judgment result. Here, in the case of sending a notification indicating transmission consent, the restoration data transmission judgment unit 3013 outputs, to the transmission data generation unit 3014, a restoration data request, replacement data request, or update data request together with the notification.

When receiving the notification of consent to transmit restoration data, replacement data or update data from the restoration data transmitting judgment unit 3013, the transmission data generation unit 3014 performs a process for generating information to be transmitted to the playback terminal 2000. Note that the process of generating restoration data performed by the transmission data generation unit 3014 is the same as the process performed by the restoration data generation unit 334 of Embodiment 1, and therefore the explanation is omitted here. The following describes a replacement data generation process and an update data generation process.

In the replacement data generation process, the transmission data generation unit 3014 determines, within the content storage unit 3004, a piece of replacement information having a content ID included in the replacement data request. After determining a piece of replacement information, the transmission data generation unit 3014 reads from the determined piece of replacement information, the number of pieces of replacement content data corresponding to the data size included in the replacement data request at a location starting from a playback location indicated by the playback location information included in the replacement data request. Then, the transmission data generation unit 3014 reads, from the pieces of replacement information, pieces of playback location information corresponding to all the read pieces of replacement content data.

Subsequently, the transmission data generation unit 3014 generates replacement data including the read pieces of replacement content data and playback location information. Then, the transmission data generation unit 3014 outputs to the transmission unit 3002, the generated replacement data and terminal location information included in the replacement data request.

In the update data generation process, the transmission data generation unit 3014 determines, within the replacement table update data storage unit 3006, a piece of update data having a content ID included in the update data request. After determining a piece of update data, the transmission data generation unit 3014 reads, from the determined piece of update data, all replacement conditions, replacement location information, and data sizes as well as a content replacement table expiration time.

Subsequently, the transmission data generation unit 3014 generates update data including the read replacement conditions, replacement location information, and data sizes as well as content replacement table expiration time information. Then, the transmission data generation unit 3014 outputs to the transmission unit 3002, the generated update data and terminal location information included in the update data request.

On the other hand, when the transmission data generation unit 3014 receives a notification of transmission refusal for replacement data and update data from the restoration data transmitting judgment unit 3013, the transmission data generation unit 3014 generates refusal data. Subsequently, the transmission data generation unit 3014 outputs the generated refusal data to the transmission unit 3002 together with the terminal location information included in the replacement data request or update data request.

The terminal information update unit 3015 has the same function as that of the terminal information update unit 335 of Embodiment 1, and therefore the explanation is omitted.

The data update unit 3016 is a component characteristic of Embodiment 4, and has input devices, such as a keyboard and a mouse.

The data update unit 3016 receives a data update instruction from outside via an input device. There are two types of data update instructions that the data update unit 3016 receives.

As to one of the two types, the data update unit 3016 receives an instruction to update replacement content data (see FIG. 33) recorded in the content storage unit 3004. In this data update instruction, information necessary to update replacement content data is included. When receiving the date update instruction, the data update unit 3016 updates replacement content data recorded in the content storage unit 3004 using information included in the data update instruction.

As to the other type, the data update unit 3016 receives an instruction to update data (see FIG. 34) recorded in the replacement table update data storage unit 3006. In this data update instruction, information necessary to update data is included. When receiving the data update instruction, the data update unit 3016 updates update data recorded in the replacement table update data storage unit 3006 using information included in the data update instruction.

By having the data update unit 3016, the content distribution server 3000 is able to always transmit appropriate pieces of replacement content data when transmitting, to the playback terminal 2000, pieces of replacement content data which are to replace pieces of content data recorded on the recording medium 1000.

The structure of the server control unit 3005 having been described can be incorporated into an integrated circuit. Also, when the playback terminal information storage unit 3003, content storage unit 3004 and replacement table update data storage unit 3006 are realized by not a hard disk but a flash memory or the like, it is possible to incorporate also these units into an integrated circuit.

<Operation>

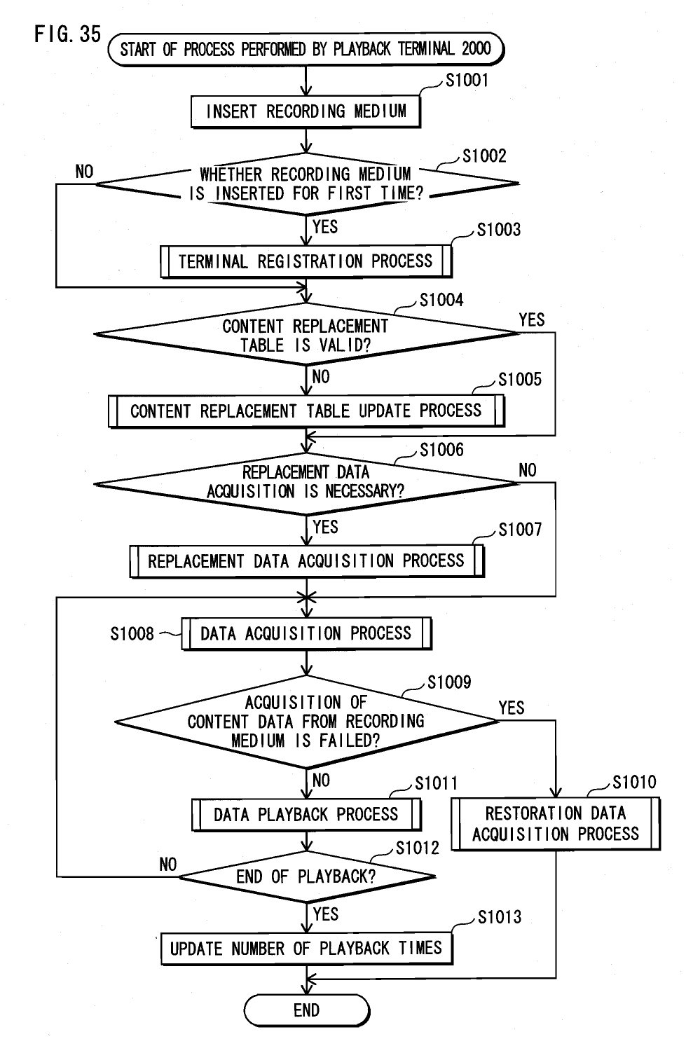

Here, operation of the content playback system 4 is described with the use of flowcharts shown in FIGS. 35-43.

1. Operation of Playback Terminal 2000

(Operation of Overall Processes Performed by Playback Terminal 2000)

FIG. 35 is a flowchart showing operation of the overall processes performed by the playback terminal 2000.

When the recording medium 1000 is inserted into the playback terminal 2000 (Step S1001), the playback check unit 2011 checks whether the recording medium 1000 is to be played back for the first time.

In the case where the recording medium 1000 is to be played back for the first time (Step S1002: YES), the request unit 2013 performs a terminal registration process (Step S1003) and moves onto Step S1004.

In the case where the recording medium 1000 is to be played back not for the first time (Step S1002: NO), after the terminal registration process of Step S1003 is finished, the playback check unit 2011 reads, from the terminal information storage unit 2004, a content replacement table expiration time recorded in correspondence with a medium ID by which the recording medium 1000 is identified. Then, the playback check unit 2011 judges whether the content replacement table is valid, by comparing the content replacement table expiration time with the current date.

When the content replacement table is expired (Step S1004: NO), the playback check unit 2011 outputs, to the request unit 2013, an instruction to generate an update data request. Subsequently, the request unit 2013 performs the content replacement table update process (Step S1005).

When the content replacement table is valid (Step S1004: YES), after the content replacement table update process of Step S1005 is finished, the playback check unit 2011 judges the necessity of acquiring pieces of replacement data from the content distribution server 3000.

Specifically speaking, the playback check unit 2011 reads, from the terminal information storage unit 2004, a content replacement table recorded in correspondence with the medium ID of the recording medium 1000. Then, the playback check unit 2011 judges the necessity of acquiring pieces of replacement data with respect to each piece of replacement information included in the content replacement table.

The following description is given using a specific example in which the content replacement table 1006a of FIG. 27 is recorded in the terminal information storage unit 2004.

First, the playback check unit 2011 judges the necessity of acquiring pieces of replacement data, using the piece of replacement information 1011 of the content replacement table 1006a. Since the replacement condition included in the piece of replacement information 1011 is a condition regarding the playback time, the playback check unit 2011 judges whether the current date and time satisfy the replacement condition. When the current date and time satisfy the replacement condition, the playback check unit 2011 determines the necessity of acquiring pieces of replacement data. When the current date and time do not satisfy the replacement condition, the playback check unit 2011 determines that the acquisition of pieces of replacement data is not necessary.

Next, the playback check unit 2011 judges the necessity of acquiring pieces of replacement data, using the piece of replacement information 1012 of the content replacement table 1006a. The replacement condition included in the piece of replacement information 1012 is a condition about the number of playback times, and therefore the playback check unit 2011 judges whether the number of playback times recorded in the terminal information storage unit 2004 meets the replacement condition. When the number of playback times meets the replacement condition, the playback check unit 2011 determines the necessity of acquiring pieces of replacement data. When the number of playback times does not meet the replacement condition, the playback check unit 2011 determines that the acquisition of pieces of replacement data is not necessary.

When finishing the judgment with respect to all pieces of replacement information included in the content replacement table 1006a and determining, for all the pieces of replacement information, that the acquisition of pieces of replacement data is not necessary (Step S1006: NO), the playback check unit 2011 moves to Step S1008. When determining the necessity of acquiring pieces of replacement data for some pieces of replacement information (Step S1006: YES), the playback check unit 2011 performs the replacement data acquisition process (Step S1007).

In the case where the acquisition of pieces of replacement data is not necessary, the playback terminal 2000 performs the data acquisition process after the replacement data acquisition process is finished (Step S1008).

When failing in data reading during acquisition of content data from the recording medium 1000 (Step S1009: YES), the playback terminal 2000 performs the restoration data acquisition process (Step S1010), and then finished the process. Note that the process of Step S1010 is the same as that shown in the flowchart of FIG. 16, and accordingly the description is omitted here.

In the case of not failing data reading during acquisition of content data from the recording medium 1000 (Step S1009: NO), the playback terminal 2000 performs the data playback process (Step S1011). Subsequently, the playback terminal 2000 judges whether content playback has been finished. In the case where content playback has been finished (Step S1012: YES), the playback terminal 2000 adds one to the number of playback times recorded in the terminal information storage unit 2004 to thereby update the number of playback times (Step S1013), and then finishes the process. In the case where content playback has not been finished (Step S1012: NO), the playback terminal 2000 proceeds the playback location and continues the data acquisition process of Step S1008. Note that the process of proceeding the playback location is realized as common content playback control executed by the terminal control unit 2006, as in the case of Embodiment 1.

(Operation of Terminal Registration Process)

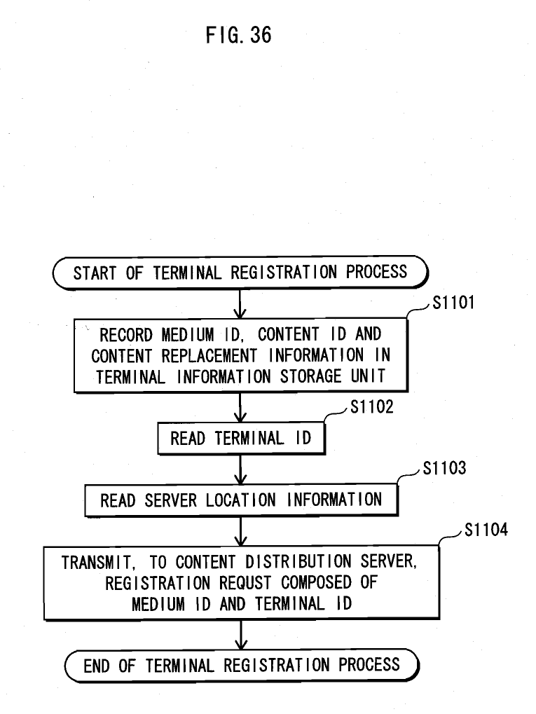

FIG. 36 is a flowchart showing operation of the terminal registration process performed by the playback terminal 2000. Note that the operation shown in this figure is a detail of Step S1003 of FIG. 35.

First, the playback check unit 2011 adds the medium ID 1001 of the recording medium 1000 to the registered medium ID of the terminal information storage unit 2004. Furthermore, the playback check unit 2011 sets the medium ID 1001 of the recording medium, content ID 1012 and content replacement information 1006 in correspondence with one another, and then records them in the terminal information storage unit 2004 (Step S1101).

Subsequently, the request unit 2013 reads the terminal ID recorded in the terminal information storage unit 2004 (Step S1102), and creates a registration request composed of the read terminal ID and the medium ID 1001 of the recording medium 1000.

Next, the medium reading unit 2001 reads the server location information 1003 from the recording medium 1000 (Step S1103).

Subsequently, the transmission unit 2003 transmits a registration request composed of the terminal ID and medium ID 1001 to the content distribution server 3000 indicated by the server location information 1003 (Step S1104).

(Operation of Content Replacement Table Update Process)

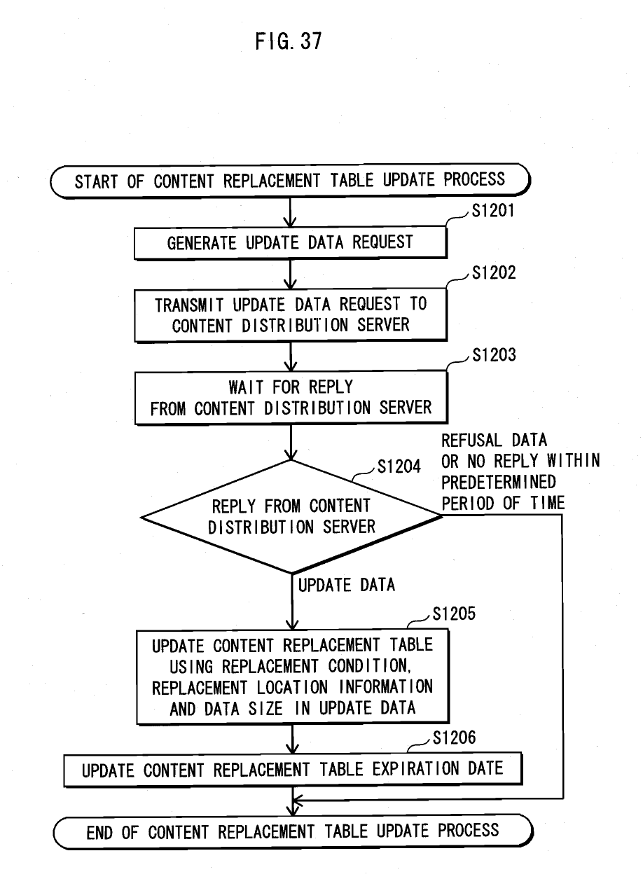

FIG. 37 is a flowchart showing operation of the content replacement table update process performed by the playback terminal 2000. Note that the operation shown in this figure is a detail of Step S1005 of FIG. 35.

First, the request unit 2013 reads, from the content replacement table in the terminal information storage unit 2004, a content ID corresponding to a content replacement table necessary to be updated, and then reads the terminal ID and terminal location information from the terminal information storage unit 2004. The request unit 2013 generates an update data request including the content ID, terminal ID and terminal location information (Step S1201). Assume that, to an update data request, information indicating that the request is an update data request is attached.

The transmission unit 2003 transmits an update data request generated at Step S1201 to the content distribution server 3000 (Step S1202).

Subsequently, the playback terminal 2000 waits for a reply from the content distribution server 3000 (Step S1203).

In the case when the reply from the content distribution server 3000 is refusal data, or when no reply is made from the content distribution server 3000 within a predetermined period of time (Step S1204: “refusal data, or no reply within a predetermined period of time”), the playback terminal 2000 ends the process.

In the case when the reply from the content distribution server 3000 is update data (“update data” at Step S1204), the data access unit 2014 generates replacement information using all of the replacement condition, replacement location information and data size included in the update data. Then, using the generated replacement information, the data access unit 2014 updates content replacement table having been recorded in the terminal information storage unit 2004 up to then (Step S1205).

Further, the data access unit 2014 updates a content replacement table expiration time having been recorded in the terminal information storage unit 2004 up to then using a content replacement table expiration time included in the update data (Step S1206).

Note that in the case where the replay from the content distribution server 3000 is refusal data, the output unit 2007 may make, to the user, a notification indicating failure in acquiring the update data before the playback terminal 2000 ends the process.

Also in the case where no reply is made from the content distribution server 3000 within a predetermined period of time, the output unit 2007 may make, to the user, a notification indicating failure in communicating with the content distribution server 3000 before the playback terminal 2000 ends the process.

Furthermore, in the case where the reply from the content distribution server 3000 is update data, the output unit 2007 may make, to the user, a notification indicating success in acquiring the update data and a notification indicating the update process of-the content replacement table has been completed normally.

(Operation of Replacement Data Acquisition Process)

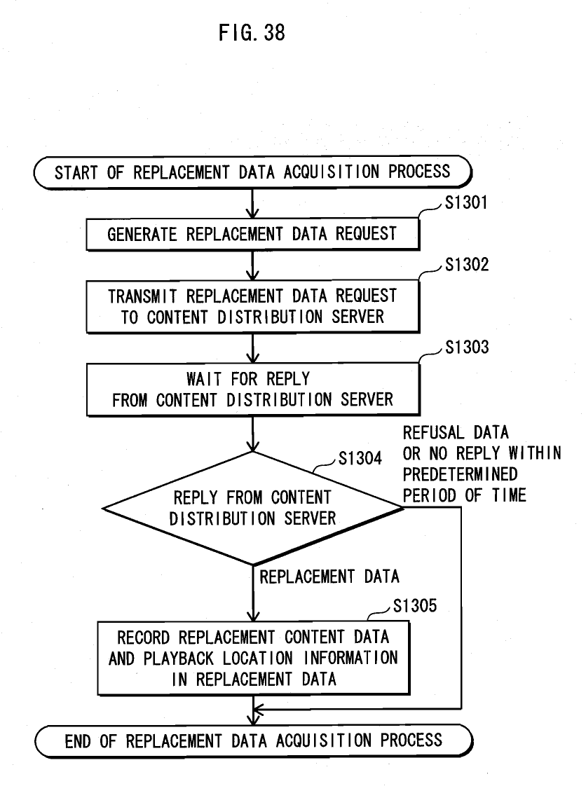

FIG. 38 is a flowchart showing operation of the replacement data acquisition process performed by the playback terminal 2000. Note that the operation shown in this figure is a detail of Step S1007 of FIG. 35.

First, the request unit 2013 reads, from the content replacement table in the terminal information storage unit 2004, a content ID of content for which it is necessary to acquire replacement data, the medium ID of the recording medium 1000, replacement location information and data size, and also reads the terminal ID and terminal location information from the terminal information storage unit 2004, and then generates a replacement data request including those (Step S1301). Assume that, to a replacement data request, information indicating that the request is a replacement data request is attached.

The transmission unit 2003 transmits a replacement data request generated at Step S1301 to the content distribution server 3000 (Step S1302).

Subsequently, the playback terminal 2000 waits for a replay from the content distribution server 3000 (Step S1303).

In the case when the reply from the content distribution server 3000 is refusal data, or when no reply is made from the content distribution server 3000 within a predetermined period of time (Step S1304: “refusal data, or no reply within a predetermined period of time”), the playback terminal 2000 ends the process.

In the case when the reply from the content distribution server 3000 is replacement data (“replacement data” at Step S1304), the data access unit 2014 records, in the restoration data/replacement data storage unit 2005, replacement content data and playback location information included in the replacement data (Step S1305).

Note that in the case where the replay from the content distribution server 3000 is refusal data, the output unit 2007 may make, to the user, a notification indicating failure in acquiring the replacement data before the playback terminal 2000 ends the process.

Also in the case where no reply is made from the content distribution server 3000 within a predetermined period of time, the output unit 2007 may make, to the user, a notification indicating failure in communicating with the content distribution server 3000 before the playback terminal 2000 ends the process.

Furthermore, in the case where the reply from the content distribution server 3000 is replacement data, the output unit 2007 may make, to the user, a notification indicating success in acquiring the replacement data.

(Operation of Data Acquisition Process)

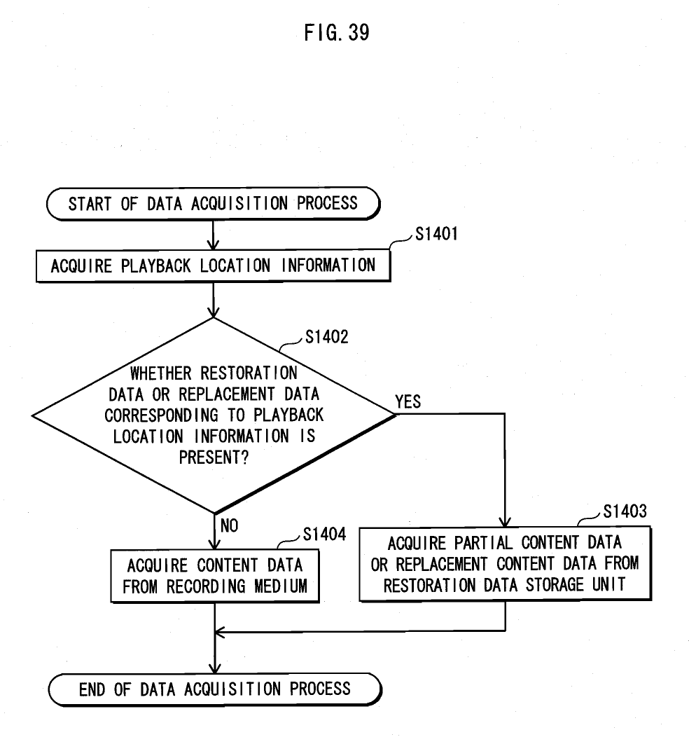

FIG. 39 is a flowchart showing operation of the data acquisition process performed by the playback terminal 2000. Note that the operation shown in this figure is a detail of Step S1008 of FIG. 35.

First, the playback terminal 2000 acquires a piece of playback location information indicating a location, within the content, being currently played back (Step S1401). Here, the process of acquiring playback location information is realized as common content playback control executed by the terminal control unit 2006, and the medium reading unit 2001 or data access unit 2014 performs the process in accordance with instructions from the terminal control unit 2006.

More specifically, when content data read from the recording medium 1000 is being played back, the medium reading unit 2001 performs the process of acquiring the playback location information, and when partial content data and replacement content data read from the restoration data/replacement data storage unit 2005 is being played back, the data access unit 2014 performs the process of acquiring the playback location information.

The checking process performed by the data acquisition unit 2015 is, specifically speaking, realized by checking if both the medium ID and playback location information received from the medium reading unit 2001 have been recorded in the restoration data/replacement data storage unit 2005.

In the case where pieces of partial content data or pieces of replacement content data corresponding to the playback location information are present in the restoration data/replacement data storage unit 2005 (Step S1402: YES), the data acquisition unit 2015 acquires them from the restoration data/replacement data storage unit 2005 (Step S1403) and then outputs them to the decoding data control unit 2016.

On the other hand, in the case where pieces of partial content data or pieces of replacement content data corresponding to the playback location information are not present in the restoration data/replacement data storage unit 2005 (Step S1402: NO), the data acquisition unit 2015 acquires pieces of content data corresponding to the playback location information from the recording medium 1000 (Step S1404) and outputs them to the decoding data control unit 2016.

Note that in the case where both pieces of partial content data and pieces of replacement content data corresponding to the playback location information are present in the restoration data/replacement data storage unit 2005, the data acquisition unit 2015 acquires the pieces of replacement content data and outputs them to the decoding control unit 2016.

As has been described above, each piece of partial content data has the same content as a corresponding piece of content data recorded in the recording medium 1000. On the other hand, each piece of replacement content data has a content that is different from that of a corresponding piece of content data recorded in the recording medium 1000. Specifically speaking, pieces of replacement content data are new data created by updating the content data recorded in the recording medium 1000 in a manner that the new data reflects intentions of the content provider and becomes suitable for playback. Accordingly, the data acquisition unit 2015 acquires pieces of replacement content data, which is new data suitable for playback, in priority to pieces of partial content data.

The data update unit 3016 receives an instruction to update pieces of replacement content data (see FIG. 33) recorded in the content storage unit 3004. This data update instruction includes information necessary for updating pieces of replacement content data. Receiving a data update instruction, the data update unit 3016 updates pieces of replace content data recorded in the content storage unit 3004 using information included in the data update instruction.

(Operation of Data Playback Process)

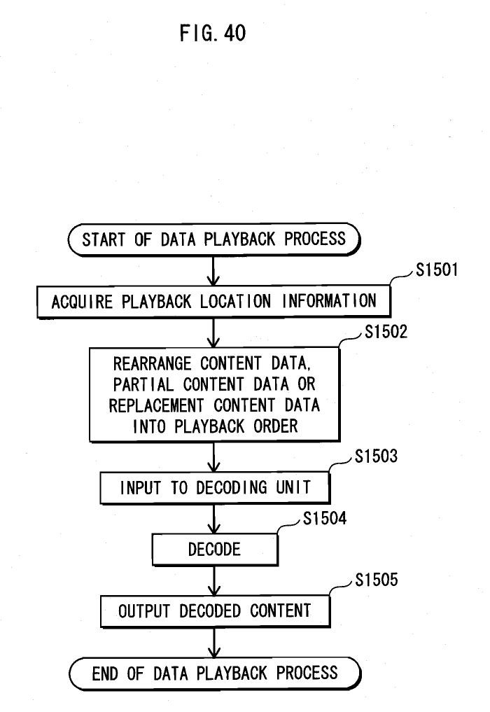

FIG. 40 is a flowchart showing operation of the data playback process performed by the playback terminal 2000. Note that the operation shown in this figure is a detail of Step S1011 of FIG. 35.

First, the decoding data control unit 2016 acquires playback location information of buffered pieces of content data, partial content data and replacement content data (Step S1501).

Subsequently, according to the acquired playback location information, the decoding data control unit 2016 rearranges those pieces of content data, partial content data and replacement content data into a proper playback order (Step S1502). Then, the pieces of content data, partial content data and replacement content data are input to the decoding unit 2017 in the proper playback order (Step S1503).

The decoding unit 2017 decodes received pieces of content data, partial content data and replacement content data (Step S1504), and outputs them to the output apparatus 4000 (Step S1505).

Note that, as in Embodiment 1, if a steady amount of data is always sent from the data acquisition unit 2015 in accordance with the playback order, the buffering and rearranging processes by the decoding data control unit 2016 are not required. In such a case, Steps S1501 and S1502 can be omitted.

2. Operation of Content Distribution Server 3000

(Operation of Overall Process Performed by Content Distribution Serve 3000)

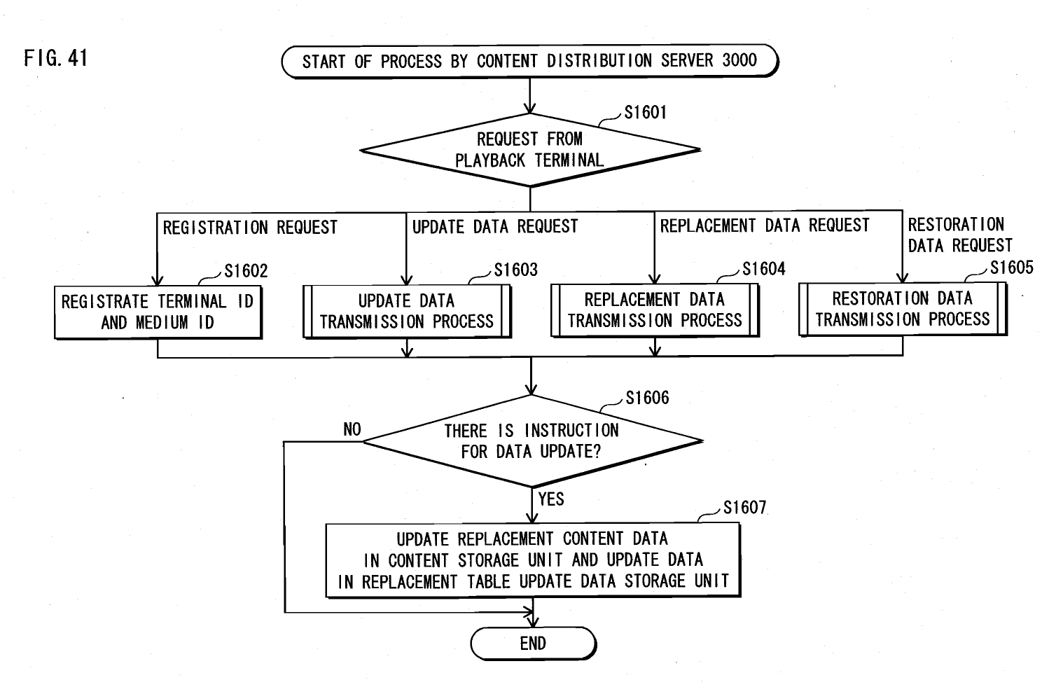

FIG. 41 is a flowchart showing operation of overall processes performed by the content distributions server 3000.

The content distribution server 3000 waits for a request from the playback terminal 2000, and when the content distribution server 3000 receives a request from the playback terminal 2000, the request judgment unit 3011 judges whether the request is a registration request, a restoration data request, a replacement data request or an update data request.

The request received from the playback terminal 2000 is a registration request (Step S1601: “registration request”), the registration unit 3012 records a terminal ID and a medium ID included in the registration request in the playback terminal information storage unit 3003 (Step S1602).

In the case where the request received from the playback terminal 2000 is an update data request (Step S1601: “update data request”), the content distribution server 3000 performs an update data transmission process (Step S1603).

In the case where the request received from the playback terminal 2000 is a replacement data request (Step S1601: “replacement data request” at Step S1601), the content distribution server 3000 performs a replacement data transmission process (Step S1604).

In the case where the request received from the playback terminal 2000 is a restoration data request (Step S1601: “restoration data request” at Step S1601), the content distribution server 3000 performs a restoration data transmission process (Step S1605). Since details of Step S1605 are the same as those shown in the flowchart of FIG. 18, their descriptions are omitted here.

Subsequently, the data update unit 3016 of the content distribution server 3000 judges whether an instruction for data update has been received. In the case where no data update instruction has been received (Step S1606: NO), the content distribution server 3000 ends the process. In the case where a data update instruction has been received (Step S1606: YES), the data update unit 3016 updates, in accordance with the data update instruction, pieces of replacement content data recorded in the content storage unit 3004 and pieces of update data recorded in the replacement table update data storage unit 3006, and then ends the process.

Although, in the present embodiment, data is not sent back to the playback terminal 2000 in response to a registration request, it may instead be designed to have a structure in which a notification indicating the registration has been normally completed is made to the playback terminal 2000 after the completion of the process of the registration unit 3012.

Also, the processes of Step S1606 and Step S1607 may be performed prior to the process of Step S1601.

(Operation of Update Data Transmission Process)

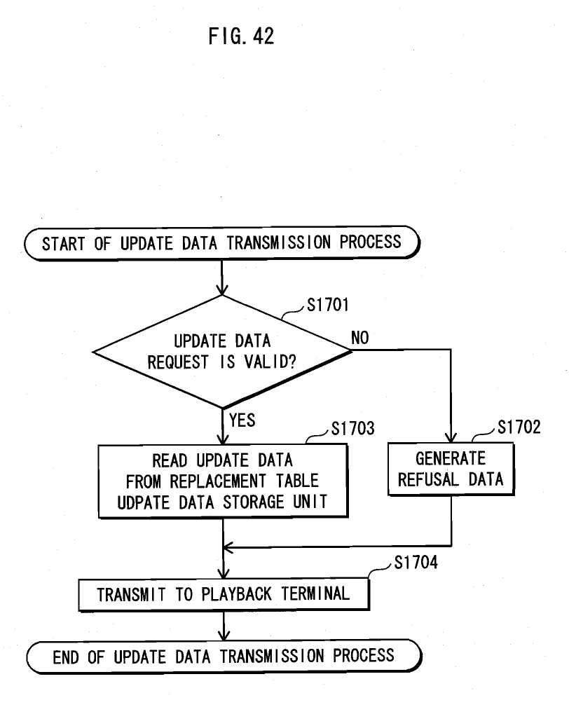

FIG. 42 is a flowchart showing operation of the update data transmission process performed by the content distribution server 3000. Note that the operation shown in this figure is a detail of Step S1603 of FIG. 41.

First, the restoration data transmitting judgment unit 3013 judges validity of an update data request. Specifically speaking, the restoration data transmitting judgment unit 3013 judges if the terminal ID and medium ID included in the update data request have been recorded in the playback terminal information storage unit 3003. Either one of them is not recorded, the restoration data transmitting judgment unit 3013 determines the update data request to be invalid.

In the case where the update data request is determined to be invalid (Step S1701: NO), the restoration data transmitting judgment unit 3013 sends a notification indicating a refusal of update data transmission to the transmission data generation unit 3014, and then moves onto Step S1702.

Receiving a notification indicating a refusal of update data transmission, the transmission data generation unit 3014 generates refusal data (Step S1702), and outputs the generated refusal data to the transmission unit 3002.

In the case where the update data request is determined to be valid (Step S1701: YES), the restoration data transmitting judgment unit 3013 sends a notification indicating consent for the transmission data generation unit 3014 to transmit update data.

The transmission data generation unit 3014 having received a notification of consent to update data transmission reads, from the replacement table update data storage unit 3006, update data corresponding to the content ID included in the update data request (Step S1703). The transmission data generation unit 3014 outputs the read update data to the transmission unit 3002.

Then, the transmission unit 3002 transmits update data or refusal data to the playback terminal 2000 (Step S1704).

(Operation of Replacement Data Transmission Process)

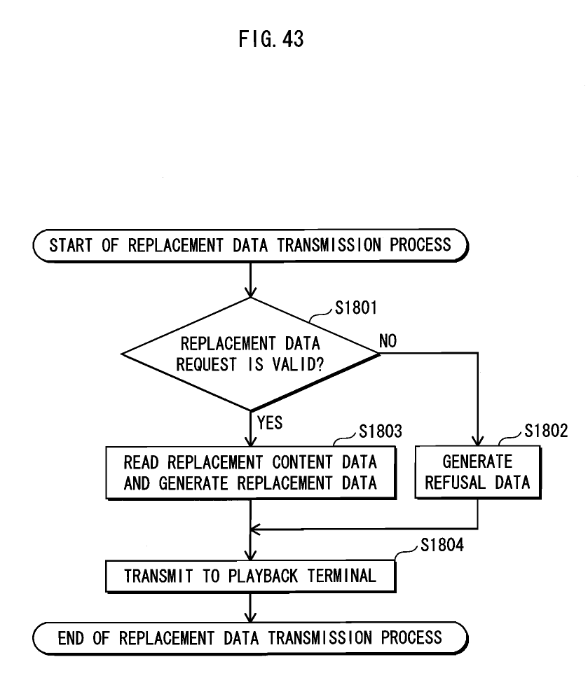

FIG. 43 is a flowchart showing operation of the replacement data transmission process performed by the content distribution server 3000. Note that the operation shown in this figure is a detail of Step S1604 of FIG. 41.

First, the restoration data transmitting judgment unit 3013 judges validity of a replacement data request. Specifically speaking, the restoration data transmitting judgment unit 3013 judges if the terminal ID and medium ID included in the replacement data request have been recorded in the playback terminal information storage unit 3003. Either one of them is not recorded, the restoration data transmitting judgment unit 3013 determines the restoration data request to be invalid.

Further, the restoration data transmitting judgment unit 3013 judges whether the content ID and medium ID included in the replacement data request are recorded in correspondence with each other in the content storage unit 3004. In the case they are recorded with no correspondence with each other, the restoration data transmitting judgment unit 3013 judges the replacement data request to be invalid.

In the case where the replacement data request is determined to be invalid (Step S1801: NO), the restoration data transmitting judgment unit 3013 sends a notification indicating a refusal of replacement data transmission to the transmission data generation unit 3014, and then moves onto Step S1802.

Receiving a refusal of replacement data transmission, the transmission data generation unit 3014 generates refusal data (Step S1802), and outputs the generated refusal data to the transmission unit 3002.

In the case where the replacement data request is determined to be valid (Step S1801: YES), the restoration data transmitting judgment unit 3013 sends a notification indicating consent for the transmission data generation unit 3014 to transmit replacement data.

The transmission data generation unit 3014 having received a notification of consent to replacement data transmission reads, from the content storage unit 3004, a piece of replacement content data corresponding to the replacement location information and data size included in the replacement data request, and further reads a piece of playback location information corresponding to the piece of replacement content data from the content storage unit 3004. The transmission data generation unit 3014 generates replacement data from the read piece of replacement content data and playback location information (Step S1803). The transmission data generation unit 3014 outputs the generated replacement data to the transmission unit 3002.

Subsequently, the transmission unit 3002 transmits replacement data or refusal data to the playback terminal 2000 (Step S1804).

As has been described, like the content playback system 1 according to Embodiment 1, the content playback system 4 records, in the restoration data/replacement data storage unit 2005, pieces of partial content data for locations at and following failure in data reading from the recording medium 1000, and thereby is capable of playing back the entire content using pieces of content data recorded in the recording medium 1000 and pieces of partial content data recorded in the restoration data/replacement data storage unit 2005.

Furthermore, in the content playback system 4, in the case where the content data of the recording medium 1000 needs to be replaced with other data, replacement content data is acquired from the content distribution server 3000 and then recorded in the restoration data/replacement data storage unit 2005. Then, if the location, within the content, being currently played back is a location for which replacement data is present, the playback terminal 2000 switches playback to replacement content data recorded in the restoration data/replacement data storage unit 2005.

Herewith, according to the content playback system 4, even if the recording medium 1000 includes content data having become inappropriate for playback over time, it is possible to perform playback by replacing inappropriate pieces of content data with appropriate pieces of replacement content data.

### Embodiment 5

Here is described a content playback system 5 as Embodiment 5 of the present invention.

According to Embodiment 4, like Embodiment 1, the playback terminal 2000 requests the content distribution server 3000 for restoration data when failing in data reading during content playback, and records therein the acquired restoration data. Herewith, the playback terminal 20 is able to play back content seamlessly in subsequent playbacks after the playback with failure in reading the recording medium 1000.

However, according to Embodiment 4, when reading failure occurs for the first time, content playback becomes suddenly interrupted in the middle. In this view, similarly to Embodiment 2, Embodiment 5 shows a content playback system capable of seamlessly playing back the entire content from the beginning to the end even if reading failure occurs for the first time.

Specifically speaking, similarly to the content playback system 2 of Embodiment 2, the content playback system 5 of Embodiment 5 checks whether reading failure occurs prior to start of content playback.

<Structure>

1. Overall Structure of Content Playback System 5

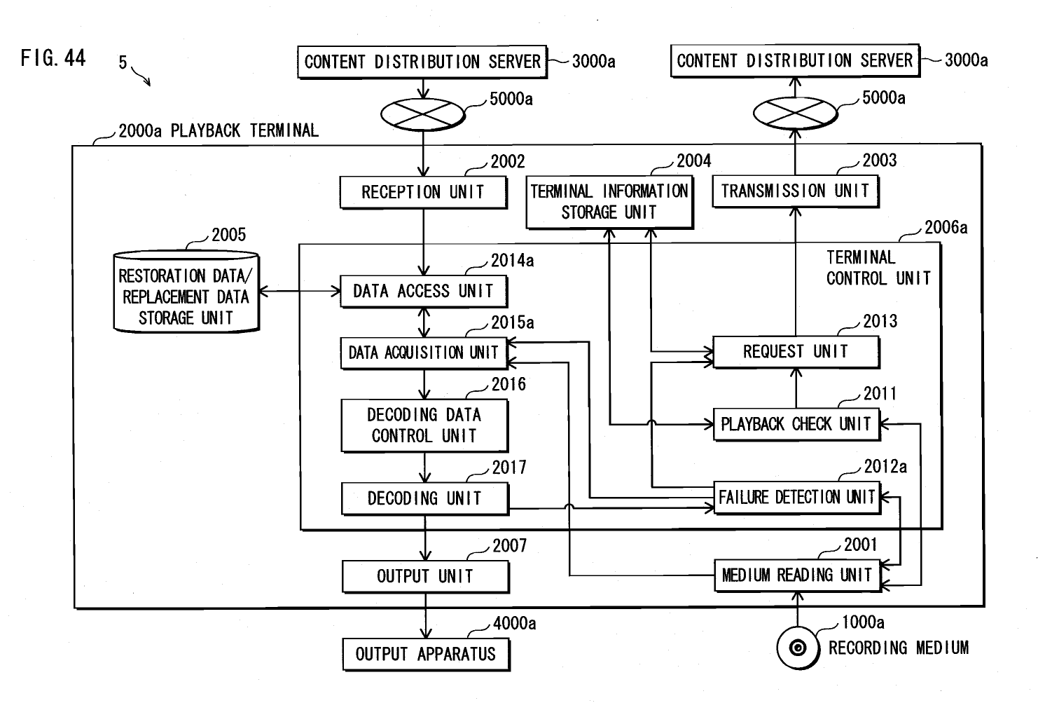

The content playback system 5 of Embodiment 5 includes a recording medium 1000a, a playback terminal 2000a, a content distribution server 3000a and an output apparatus 4000a. The playback terminal 2000a and content distribution server 3000a are connected via a communication channel 5000a (See FIG. 44).

Since the recording medium 1000a, content distribution server 3000a, output apparatus 4000a and communication channel 5000a have the same structure and function as the recording medium 1000, content distribution server 3000, output apparatus 4000 and communication channel 5000, respectively, of Embodiment 4, their descriptions are omitted here.

The following describes the structure of the playback terminal 2000a, which has a function different from its counterpart of Embodiment 4.

2. Structure of Playback Terminal 2000a

FIG. 44 is a functional block diagram functionally showing the structure of the playback terminal 2000a. Components to which the same reference symbols are given as in FIGS. 28 and 31 are functionally identical with those in Embodiment 4, and therefore their descriptions are omitted here. The playback terminal 2000a is different from Embodiment 4 in the structures of a failure detection unit 2012a, a data access unit 2014a and data acquisition unit 2015a.

(1) Failure Detection Unit 2012a

When the recording medium 1000a is inserted into the playback terminal 2000a, the failure detection unit 2012a instructs the medium reading unit 2001 to read content data recorded on the recording medium 1000a.

Then, the failure detection unit 2012a monitors the data reading performed by the medium reading unit 2001. In the case when the medium reading unit 2001 fails in content data reading, the failure detection unit 2012a indicates the request unit 2013 to create a restoration data request, as the failure detection unit 2012 of Embodiment 4.

When reading of all the content data has been completed normally, the failure detection unit 2012a informs the data acquisition unit 2015a accordingly; when an abnormal termination occurs as a result of reading failure, the failure detection unit 2015a informs the data acquisition unit 2015a accordingly.

(2) Data Access Unit 2014a

Having the same function as the data access unit 2014 of Embodiment 4, the data access unit 2014a also has a function of, when recording of restoration data is completed, informing the data acquisition unit 2015a accordingly.

(3) Data Acquisition Unit 2015a

Having the same function as the data acquisition unit 2015 of Embodiment 4, the data acquisition unit 2015a also has a function of controlling the timing of the start of data acquisition.

Specifically speaking, the data acquisition unit 2015a starts acquiring data in the case of receiving, from the failure detection unit 2012a, a notification indicating that the data reading has been completed normally as well as receiving, from the data access unit 2014a, a notification indicating completion of restoration data recording. This is in order to prevent content from being played back before completion of restoration data recording in the case where the restoration data is necessary for content playback.

Note that, in the case of no failure in data reading from the recording medium 1000, the data acquisition unit 2015a needs no partial content data, and therefore playback of content data of the recording medium 1000 is started soon after the failure detection unit 2012a finishes checking the recording medium 1000.

<Operation>

Here is described operation of the content playback system 5 according to Embodiment 5.

As has been described above, the content playback system 5 differs from the content playback system 4 of Embodiment 4 in the structure of the playback terminal 2000a. Accordingly, the following describes only the operation of the playback terminal 2000a.

(Operation of Overall Processes Performed by Playback Terminal 2000a)

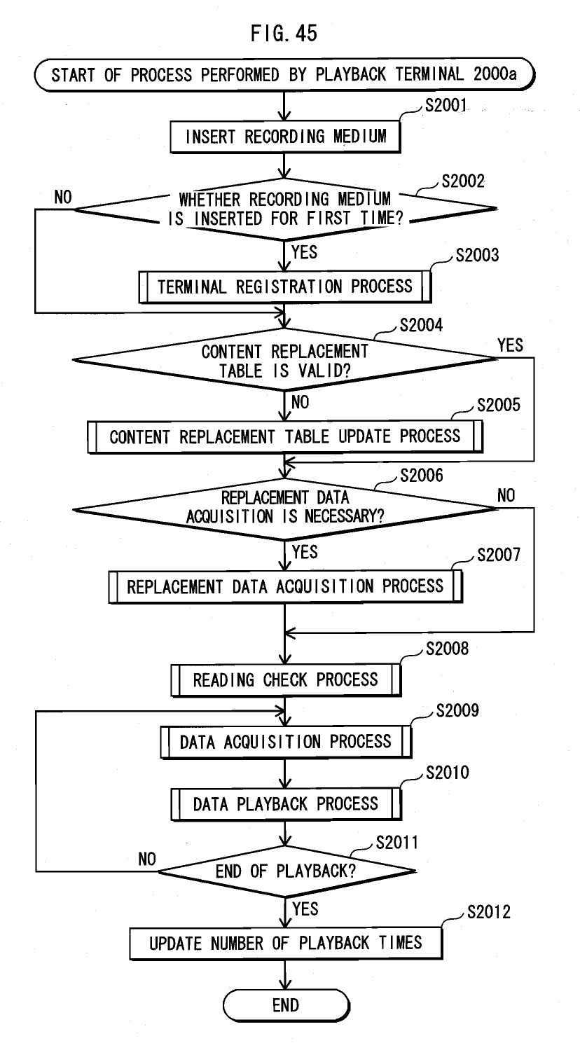

FIG. 45 is a flowchart showing operation of overall processes of the playback terminal 2000a.

When the recording medium 1000a is inserted into the playback terminal 2000a (Step S2001), the playback check unit 2011 checks whether the recording medium 1000a is to be played back for the first time.

In the case where the recording medium 1000a is to be played back for the first time (Step S2002: YES), the request unit 2013 performs the terminal registration process (Step S2003) and moves onto Step S2004. Note that the process of Step S2003 is the same as that shown in the flowchart of FIG. 36, and accordingly the detailed description is omitted here.

In the case where the recording medium 1000a is to be played back not for the first time (Step S2002: NO), after the terminal registration process of Step S2003 is finished, the playback check unit 2011 reads, from the terminal information storage unit 2004, a content replacement table expiration time recorded in correspondence with a medium ID identifying the recording medium 1000a. Then, the playback check unit 2011 judges whether the content replacement table is valid by comparing the content replacement table expiration time and the current date.

When the content replacement table is expired (Step S2004: NO), the playback check unit 2011 outputs, to the request unit 2013, an instruction to generate an update data request. Subsequently, the request unit 2013 performs the content replacement table update process (Step S2005). Note that the process of Step S2005 is the same as that shown in the flowchart of FIG. 37, and accordingly the detailed description is omitted here.

When the content replacement table is valid (Step S2004: YES), after the content replacement table update process of Step S2005 is finished, the playback check unit 2011 judges the necessity of acquiring pieces of replacement data from the content distribution server 3000a.

Specifically speaking, the playback check unit 2011 reads, from the terminal information storage unit 2004, a content replacement table recorded in correspondence with the medium ID of the recording medium 1000a. Then, the playback check unit 2011 judges the necessity of acquiring pieces of replacement data with respect to each piece of replacement information included in the content replacement table.

When finishing the judgment with respect to all pieces of replacement information included in the content replacement table and determining, for all the pieces of replacement information, that the acquisition of pieces of replacement data is not necessary (Step S2006: NO), the playback check unit 2011 moves to Step S2008. When determining the necessity of acquiring pieces of replacement data for some pieces of replacement information (Step S2006: YES), the playback check unit 2011 performs the replacement data acquisition process (Step S2007). Note that the process of Step S2007 is the same as that shown in the flowchart of FIG. 38, and accordingly the detailed description is omitted here.

In the case where the acquisition of pieces of replacement data is not necessary, the playback terminal 2000a performs the reading check process after the replacement data acquisition process is finished (Step S2008). Note that the process of Step S2008 is the same as that shown in the flowchart of FIG. 21, and accordingly the detailed description is omitted here.

Then, the playback terminal 2000a performs the data acquisition process of acquiring pieces of content data, partial content data or replacement content data to be played back from the recording medium 1000a or restoration data/replacement data storage unit 2005 (Step S2009).

The process of Step S2009 is almost the same as that shown in the flowchart of FIG. 39, and accordingly the detailed description is omitted here. Note however that the timing for the data acquisition unit 2015a to start the acquisition process is different from in Embodiment 4. That is, as in Embodiment 2, in the reading check process at Step S2008, if the data acquisition unit 2015a receives from the failure detection unit 2012a a notification indicating that reading of all the content data has been completed normally, the data acquisition unit 2015a starts the data acquisition process right away. In the reading check process, if receiving from the failure detection unit 2012a a notification indicating an occurrence of failure in content data reading, the data acquisition unit 2015a waits for execution of the data acquisition process until receiving from the data access unit 2014a a notification indicating completion of restoration data recording.

Subsequently, the playback terminal 2000a performs the data playback process (Step S2010). Then, the playback terminal 2000a judges whether content playback has been finished. In the case where content playback has been finished (Step S2011: YES), the playback terminal 2000a adds one to the number of playback times recorded in the terminal information storage unit 2004 to thereby update the number of playback times (Step S2012), and then finishes the process. In the case where content playback has not been finished (Step S2011: NO), the playback terminal 2000a proceeds the playback location and continues the data acquisition process of Step S2009. Note that the process of proceeding the playback location is realized as common content playback control executed by the terminal control unit 2006a, as in the case of other embodiments having been described.

### Embodiment 6

Here is described a content playback system 6 as Embodiment 6 of the present invention.

According to Embodiment 6, like Embodiment 3, when reading failure occurs during content playback and when data replacement is judged to be necessary during content playback, the playback terminal sequentially receives pieces of partial content data or replacement content data from the content distribution server and sequentially streams the received pieces of partial content data or replacement content data.

Herewith, the content playback system 6 is able to play back content seamlessly without requiring the playback terminal to accumulating restoration data and replacement data.

<Structure>

1. Overall Structure of Content Playback System 6

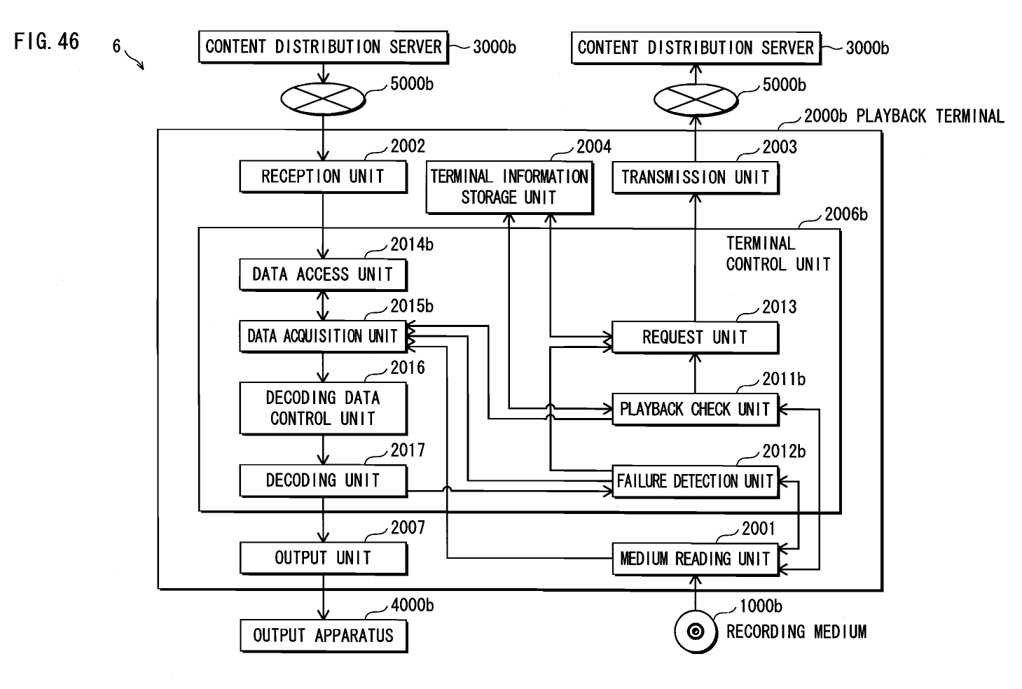

The content playback system 6 of Embodiment 6 includes a recording medium 1000b, a playback terminal 2000b, a content distribution server 3000b and an output apparatus 4000b. The playback terminal 2000b and content distribution server 3000b are connected via a communication channel 5000b (See FIG. 46).

Since the recording medium 1000b, content distribution server 3000b, output apparatus 4000b and communication channel 5000b have the same structure and function as the recording medium 1000, content distribution server 3000, output apparatus 4000 and communication channel 5000, respectively, of Embodiment 4, their descriptions are omitted here.

The following describes the structure of the playback terminal 2000b, which has a function different from its counterpart of Embodiment 4.

2. Structure of Playback Terminal 2000b

FIG. 46 is a functional block diagram functionally showing the structure of the playback terminal 2000b. Components to which the same reference symbols are given as in FIGS. 28 and 31 are functionally identical with those in Embodiment 4, and therefore their descriptions are omitted here.

The playback terminal 2000b of the present embodiment is different from Embodiment 4 in the structures of a playback check unit 2011b, a failure detection unit 2012b, a data access unit 2014b and a data acquisition unit 2015b. Also according to the present embodiment, unlike Embodiments 4 and 5, the playback terminal 2000b does not have to record restoration data and replacement data since it plays back partial content data and replacement content data immediately after the reception. Accordingly, the playback terminal 2000b does not have the restoration data/replacement data storage unit 2005.

(1) Playback Check Unit 2011b

The playback check unit 2011 of Embodiment 4 checks the necessity of acquiring pieces of replacement data using a content replacement table prior to content playback of the recording medium 1000. On the other hand, the playback check unit 2011b according to Embodiment 6 checks the necessity of acquiring pieces of replacement data using a content replacement table in the data acquisition process for acquiring content from the recording medium 1000b.

Specifically speaking, the playback check unit 2011b acquires, from the medium reading unit 2001, pieces of playback location information read from the recording medium 1000b. The playback check unit 2011b refers to a content replacement table recorded in the terminal information storage unit 2004 and judges the necessity of replacing pieces of content data indicated by the acquired pieces of playback location information. When determining replacement of pieces of content data is necessary, the playback check unit 2011b outputs a notification of data replacement to the data acquisition unit 2015b.

Note that, in addition to the above-mentioned function, the playback check unit 2011b also has other functions provided with the playback check unit 2011 of Embodiment 4.

(2) Failure Detection Unit 2012b

Having the same function as the failure detection unit 2012 of Embodiment 4, the failure detection unit 2012b also has a function of, when detecting reading failure, outputting a notification of reading failure to the data acquisition unit 2015b.

(2) Data Access Unit 2014b

The data access unit 2014b acquires restoration data and replacement data from the content distribution server 3000b via the reception unit 2002, and sequentially sends out the acquired restoration data and replacement data to the data acquisition unit 2015b.

Restoration data and replacement data do not necessarily reach the data access unit 2014b from the content distribution server 3000b in accordance with the rate of content playback, and therefore it is desirable that the data access unit 2014b have a buffer for temporarily accumulating restoration data and replacement data in order to eliminate fluctuation of the rate of restoration data and replacement data reaching.

(3) Data Acquisition Unit 2015b

The data acquisition unit 2015b acquires content data, partial content data or replacement content data to be played back by the playback terminal 2000b. Playing back any one of content data, partial content data and replacement content data depends on whether there is a notification of reading failure from the failure detection unit 2012b and whether there is a notification of data replacement from the playback check unit 2011b.

Specifically speaking, until receiving a notification of reading failure from the failure detection unit 2012b, the data acquisition unit 2015b acquires content data and playback location information read by the medium reading unit 2001 from the recording medium 1000b.

After receiving a notification of reading failure from the failure detection unit 2012b, the data acquisition unit 2015b acquires partial content data and playback location information from restoration data sequentially sent out from the data access unit 2014b.

Furthermore, after receiving a notification of data replacement from the playback check unit 2011b, the data acquisition unit 2015b acquires replacement content data and playback location information from replacement data sequentially sent out from the data access unit 2014b.

<Operation>

Here is described operation of the content playback system 6 according to Embodiment 6.

As has been described above, the content playback system 6 differs from the content playback system 4 of Embodiment 4 only in the structure of the playback terminal 2000b. Accordingly, the following describes only the operation of the playback terminal 2000b.

(Operation of Overall Processes Performed by Playback Terminal 2000b)

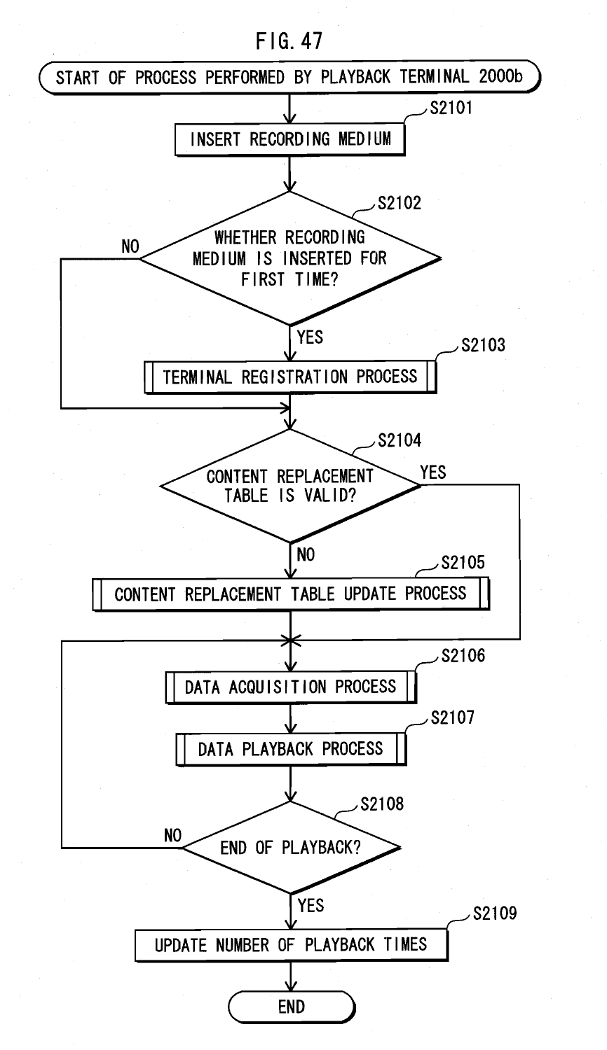

FIG. 47 is a flowchart showing operation of overall processes of the playback terminal 2000b.

When the recording medium 1000b is inserted into the playback terminal 2000b (Step S2101), the playback check unit 2011b checks whether the recording medium 1000b is to be played back for the first time.

In the case where the recording medium 1000b is to be played back for the first time (Step S2102: YES), the playback terminal 2000b performs the terminal registration process (Step S2103) and moves onto Step S2104. Note that the process of Step S2103 is the same as that shown in the flowchart of FIG. 36, and accordingly the detailed description is omitted here.

In the case where the recording medium 1000b is to be played back not for the first time (Step S2102: NO), after the terminal registration process of Step S2103 is finished, the playback terminal 2011b reads, from the terminal information storage unit 2004, a content replacement table expiration time recorded in connection with a medium ID for identifying the recording medium 1000b. Then, the playback check unit 2011b judges whether the content replacement table is valid, by comparing the content replacement table expiration time with the current date.

When the content replacement table is expired (Step S2104: NO), the playback check unit 2011b outputs, to the request unit 2013, an instruction to generate an update data request. Subsequently, the request unit 2013 performs the content replacement table update process (Step S2105). Note that the process of Step S2005 is the same as that shown in the flowchart of FIG. 37, and accordingly the detailed description is omitted here.

Next, the playback terminal 2000b performs the data acquisition process of acquiring, from the recording medium 1000b or restoration data/replacement data storage unit 2005, pieces of content data, partial content data and replacement content data to be played back (Step S2106).

Subsequently, the playback terminal 2000b performs the data playback process (Step S2107). Note that the process of Step S2107 is the same as that shown in the flowchart of FIG. 15, and accordingly the detailed description is omitted here.

Then, the playback terminal 2000b judges whether content playback has been finished. In the case where content playback has been finished (Step S2108: YES), the playback terminal 2000b adds one to the number of playback times recorded in the terminal information storage unit 2004 to thereby update the number of playback times (Step S2109), and then finishes the process. In the case where content playback has not been finished (Step S2108: NO), the playback terminal 2000b proceeds the playback location and continues the data acquisition process of Step S2106. Note that the process of proceeding the playback location is realized as common content playback control executed by the terminal control unit 2006b, as in the case of other embodiments having been described.

(Operation of Data Acquisition Process)

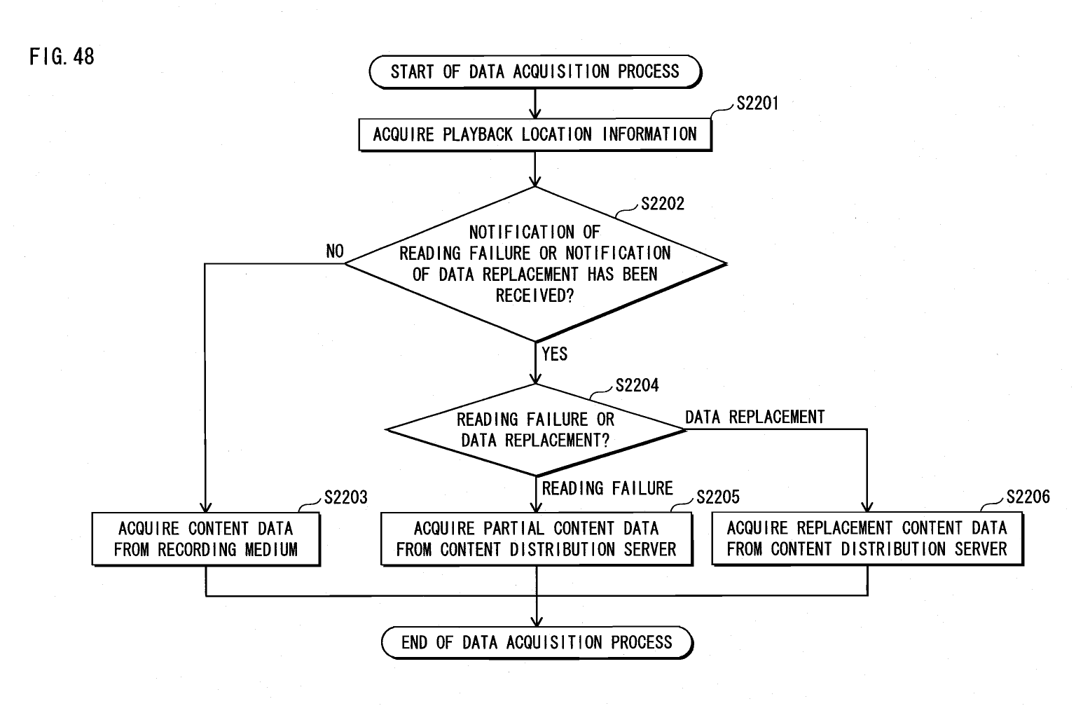

FIG. 48 is a flowchart showing operation of the data acquisition process performed by the playback terminal 2000b. Note that the operation shown in this figure is a detail of Step S2016 of FIG. 47.

First, the playback terminal 2000b acquires playback location information which indicates a location, within content, currently being played back (Step S2201). When content data read from the recording medium 1000b is being played back, the process of acquiring playback location information is performed by the medium reading unit 2001; and when partial content data and replacement content data acquired from the content distribution server 3000b are being played back, the process of acquiring playback location information is performed by the data access unit 2014b.

Subsequently, the data acquisition unit 2015b checks whether a notification indicating reading failure on the recording medium 1000b has been received from the failure detection unit, or whether a notification of data replacement has been received from the playback check unit 2011b.

When neither a notification of reading failure nor a notification of data replacement is received (Step S2202: NO), the data acquisition unit 2015b acquires, from the recording medium 1000b, a piece of content data corresponding to the playback location information, and outputs the piece of content data to the decoding data control unit 2016 (Step S2203).

When a notification of reading failure or a notification of data replacement has been received (Step S2202: YES), the data acquisition unit 2015b checks the received notification is either one of a reading failure notification and a data replacement notification.

In the case where the received notification is a reading failure notification (Step S2204: “reading failure”), the data acquisition unit 2015b acquires pieces of partial content data corresponding to the playback location information from the content distribution server 3000b via the data access unit 2014b, and outputs them to the decoding data control unit 2016.

In the case where the received notification is a data replacement notification (Step S2204: “data replacement”), the data acquisition unit 2015b acquires pieces of replacement content data corresponding to the playback location information from the content distribution server 3000b via the data access unit 2014b and outputs them to the decoding data control unit 2016.

As has been described, the playback terminal 2000b of Embodiment 6 sequentially streams pieces of partial content data and replace content data acquired from the content distribution server 30b during playback. Accordingly, when failure in data reading from the recording medium 1000b occurs as well as when data replacement is necessary, it is possible to normally and seamlessly play back content without accumulation of restoration data and replacement data.

In the present embodiment, the playback terminal 2000b acquires playback location information from the content distribution server 3000b along with partial content data and replacement content data; however, the present invention is not limited to this structure. The playback terminal 2000b may be designed not to acquire playback location information from the content distribution server 3000b. It is because, in the present embodiment, data to be played back needs not to be rearranged since a piece of partial content data at a location of reading failure on the recording medium 1000b and a piece of replacement content data at a position requiring data replacement are acquired as needed.

In the present embodiment, the playback terminal 2000b does not record acquired pieces of partial content data; however, the present invention is not limited to this case. In order to eliminate fluctuation of the rate of pieces of partial content data reaching, a buffer may be provided to temporarily store therein the reached pieces of partial content data.

[Other Modifications]

The present invention has been explained based on the above embodiments; however, it is a matter of course that the present invention is not limited to these embodiments, and the following cases are also within the scope of the invention.

(1) In Embodiments 1-6 above, the recording medium is considered to be a BD-ROM; however, the recording medium of the present invention is not limited to a BD-ROM. For example, it may be a recordable disk like a BD-R, or a rewritable disk like a DVD-RAM, other than a BD-ROM. Further, the configuration of the recording medium is not limited to a disk, and it is possible to use a recording medium of a different configuration, such as a SD card.

Content recorded on the recording medium is considered to be video and audio digital data; however, it is not limited to such. The content of the present invention may be video only or audio only. Furthermore, content of the present invention may be an application program or the like.

The playback apparatus is considered to be a BD player; however, the playback apparatus of the present invention is not limited to a BD player, and various types of apparatuses can be used in accordance with types of recording media. For example, if a DVD-ROM is used as a recording medium, a DVD player is used as the playback apparatus.

The communication channel is considered to be the Internet; however, the present invention is not limited to this case. The communication channel of the present invention may be a telephone line or a different communication channel as long as it allows information communication between the playback terminal and content distribution server.

(2) In Embodiments 4 and 5 above, the playback terminal checks the necessity of acquiring replacement content data before content playback; however, the present invention is not limited to this structure. The playback terminal of the present invention may be designed to check the necessity of acquisition of replacement content data during content playback. In this case, after acquiring playback location information of content data to be played back, the playback terminal checks replacement location information included in the content replacement table, and checks the necessity of replacing content data corresponding to the playback location information. That is, the playback terminal causes the playback check unit to check the necessity of acquiring replacement content data during content playback, and also causes the failure detection unit to check the necessity of acquiring partial content data.

(3) In Embodiments 4-6 above, the playback terminal is designed to acquire both partial content data and replacement content data from the content distribution server; however, the playback terminal of Embodiments 4-6 may be designed to acquire only replacement content data from the content distribution server.

In the case where the playback terminal acquires only replacement content data, the present invention is not limited to the case where replacement content data is acquired from the content distribution server at the same timing as in Embodiments 4-6, and includes the case where it is acquired at a different timing from in these embodiments.

For example, it is also within the scope of the present invention to design, in each of Embodiments 1-3 having been described above, the playback terminal to acquire replacement content data from the content distribution server, in place of partial content data.

In the case where, in Embodiment 1, replacement content data is acquired instead of partial content data, when the playback terminal determines the necessity of replacement content data during playback of content data recorded on the recording medium, the playback terminal stops the process of playing back the content data, then acquires replacement content data from the content distribution server, and subsequently ends the process. From the second playback session onward, the playback terminal is able to play back content seamlessly to the end using content data recorded in the recording medium and replacement content data stored in the playback terminal.

In the case where, in Embodiment 2, replacement content data is acquired instead of partial content data, the playback terminal judges the necessity of replacement content data before playback of the content data recorded on the recording medium. When determining the necessity, the playback terminal withholds playback of the content data until the acquisition of replacement content data is completed. Then, after completing the acquisition of replacement content data, the playback terminal starts playing back the content data.

In the case where, in Embodiment 3, replacement content data is acquired instead of partial content data, when the playback terminal determines the necessity of replacement content data during playback of content data recorded on the recording medium, the playback terminal acquires replacement content data from the content distribution server as needed, and performs streaming without storing the acquired replacement content data therein.

(4) In Embodiments 1-6 above, the playback terminal acquires, from the content distribution server, partial content data for locations at and following failure in reading from the recording medium; however, the present invention is not limited to this case.

For example, the playback terminal may be designed to, even if the playback terminal fails in reading from the recording medium, continue the reading from the recording medium and search for subsequent locations successful in reading. In this case, if a location successful in reading is found again, the playback terminal acquires pieces of partial content data only for the section starting from a reading failure and ending at the location successful in reading.

According to this structure, the playback terminal is able to reduce the amount of backup data (restoration data) recorded therein.

In this case, the playback terminal plays back, in the content playback process, pieces of partial content data recorded in the restoration data storage unit with respect to the above-mentioned section, while playing back pieces of content data read from the recording medium with respect to the remaining sections.

(5) In Embodiments 1, 2, 4 and 5 above, the data acquisition unit and data access unit of the playback terminal judge whether the location being currently played back is a location at which playback failure has previously occurred, based on whether playback location information indicating the location being currently played back is recorded in the restoration data storage unit and the restoration data/replacement data storage unit. However, the present invention is not limited to this case.

For example, the playback terminal may be designed to record a location at which playback failure has occurred and then always acquire partial content data for locations at and following the playback failure from the restoration data storage unit and the restoration data/replacement data storage unit.

(6) In Embodiments 1, 2, 4 and 5 above, the content distribution server counts the count of transmitted pieces of partial content with respect to each playback terminal and recording medium; however, the present invention is not limited to this structure. Various embodiments are possible according to the intention of the operator of the content distribution server.

For example, the content distribution server may be designed to set the upper limit of the count of transmitted pieces of partial content data with respect to each playback terminal and then count transmitted pieces of partial content with respect to each playback terminal. In this case, the count of transmitted pieces of partial content 313 of FIG. 9 is recorded in correspondence with only the terminal ID 311. Here, the terminal information update unit updates the count of transmitted pieces of partial content data with respect to each terminal ID. In this modification, the count of transmitted pieces of partial content is counted based only on the playback terminal, and therefore it is possible to impose some restrictions on ill-intentioned users who intentionally damages the recording medium to thereby collect partial content data.

Further, the content distribution server may be designed to set the upper limit of the count of transmitted pieces of partial content data with respect to each recording medium and then count transmitted pieces of partial content with respect to each recording medium. In this case, the count of transmitted pieces of partial content 313 of FIG. 9 is recorded in correspondence with the medium ID 312. Here, the terminal information update unit updates the count of transmitted pieces of partial content with respect to each medium ID. In this modification, transmitted pieces of partial content are counted independently of the playback terminal, and therefore it is possible to properly count transmitted pieces of partial content, for example, in the occasion where the recording medium is borrowed and lent between friends.

In addition, it is a matter of course that transmitted pieces of partial content can be count with respect to each content ID, instead of a medium ID.

(7) In Embodiments 1-6 above, the content distribution server uses, as the count of transmitted pieces of partial content, the total number of pieces of partial content data having been transmitted; however, the present invention is not limited to this case. Various embodiments are possible according to the intention of the operator of the content distribution server.

For example, the content distribution server may be designed not to perform the addition update of the count of transmitted pieces of partial content when pieces of partial content data are to be transmitted again in response to a restoration data request including the same medium ID as a medium ID which was included in a past restoration data request.

This is because, as to a recording medium in relation to which restoration data has previously been requested, it is highly likely that reading failure due to other factors occur again at a different location. In this case, if the total number of pieces of partial content data having been transmitted is used as the count of transmitted pieces of partial content is counted, the count of transmitted pieces of partial content would exceed the transmission upper limit count although the playback terminal is to play back content of the same recording medium. As a result, transmission of partial content data may suddenly become disapproved.

Such an incident is not desirable for the user since significant restrictions are imposed on the use of content, as compared to a recording medium with which content can be played back any number of times unless the recording medium is damaged. Accordingly, by providing the above-mentioned structure, it is possible to secure the user's convenience.

In Embodiments 1-6 above, the content distribution server counts pieces of partial content data having been transmitted to the playback terminal, and judges whether to further transmit partial content data in accordance with the data amount of transmitted pieces of partial content data. According to this structure, in the case where the playback terminal fails in content data reading at somewhere closer to the beginning of the content data, the amount of partial content data to be transmitted is larger than the case of failure in content data reading at somewhere closer to the end of the content data. In such a case, even though the same content data is being played back, unfairness occurs from differences in locations of playback failure.

Accordingly, in the present invention, the content distribution server may count the number of times of restoration data transmission, instead of counting pieces of partial content data having been transmitted to the playback terminal. In this case, whether to further transmit partial content data is determined not based on the data amount of partial content data having been transmitted to the playback terminal, but based on the number of times that the content distribution server has transmitted restoration data.

According to this structure, it is possible to perform the judgment on whether to transmit partial content data, for example, independent of a location on the recording medium, at which the content data is damaged. Accordingly, partial content data can be acquired independent of reading failure locations for playback of the same content data, whereby giving the user a sense of fairness in acquisition of partial content data.

(8) In Embodiments 1-6 above, when receiving a registration request from the playback terminal, the registration unit of the content distribution server performs registration of the playback terminal with no particular judgment; however, the present invention is not limited to this case. For example, usage fee of the content distribution system may be charged in time of registration of a playback terminal.

Further, in Embodiments 1-6 above, any particular condition is established for transmission of restoration data; however, charging or other conditions may be established in this case as well.

(9) In Embodiment 1-6 above, the transmission upper limit count is determined in advance; however, the present invention is not limited to this case. For example, the transmission upper limit count may be increased on the basis of payment.

The transmission upper limit count does not have to be uniform within the entire system. For example, from a standpoint of image quality or popularity of the content, the transmission upper limit count may be set to be smaller for high-value content while being set to be larger for low-value content.

Furthermore, the content distribution server may be provided with a function of calculating popularity of the content as needed based on users questionnaire or the like and changing the transmission upper limit count by reflecting the calculated popularity.

(10) In Embodiments 1-6 above, the present invention is described taking content playback as an example. However, it is a matter of course that the present invention can be applied to special playback, such as fast-forward and rewind.

(11) In Embodiments 2, 3, 5 and 6 above, acquisition of partial content data is performed during or before playback of the recording medium, and thereby content can be played back seamlessly. Accordingly, the user may be unaware that the playback terminal has failed in reading the recording medium. In view of this, in Embodiments 2 and 3 above, failure in reading the recording medium may be notified to the user, for example, by displaying on the screen a message indicating the failure in reading the recording medium. Note that various timings are possible for making the notification. For example, the notification may be made when content playback is finished, or when playback is switched from the content data to partial content data.

(12) In Embodiments 2 and 5 above, because reading success is checked before content playback, it takes some time before actual playback starts. Therefore, in Embodiments 2 and 5 above, the reading check process is not implemented for all data, but implemented only for main data to thereby reduce the time required prior to the start of playback. For example, in the case where the content is MPEG-2 video content, “I picture” may be used as the said main data. Note that, in the case reading failure is detected during actual playback after reading success is checked only for the main data, the playback process may be continued with only the main data, or partial content data may be acquired again from the content distribution server.

Further, the playback terminal of the present invention may be designed to start the process of content playback before finishing the reading check process for all content data, and thus perform the content playback process in parallel to the reading check process.

In this case, it is desirable to design the playback terminal so that, if partial content data becomes required after the reading check process is performed prior to the content playback process, the partial content data can be acquired from the content distribution server in time for the playback. To realize this, pieces of playback location information to be units of the reading check process should be changed to units allowing for seamless playback of content.

(13) The reading check process of Embodiments 2 and 5 above may be designed to, instead of performing only a reading test, record, in the storage unit of the playback terminal, content data read prior to playback and then, after the start of playback, play back the content data recorded during the reading test. Note that it is a matter of course to play back partial content data acquired from the content distribution server if necessary.

In general, the reading speed of the storage unit provided inside the playback terminal is faster than that of the medium reading unit. Accordingly, a more stable playback process is realized when reading is made from the storage unit. Also in this case, the rearrangement process performed by the decoding data control unit can be omitted by rearranging in advance pieces of content data and partial content data recorded inside the apparatus into a playback order.

(14) In Embodiments 3 and 6 above, the playback terminal does not have a restoration data storage unit and a restoration data/replacement data storage unit, and performs playback immediately after receiving restoration data and replacement data from the content distribution server without recording such data therein. However, the present invention is not limited to this structure.

In Embodiment 3, the playback terminal may be designed to have a restoration data storage unit; in Embodiment 6, the playback terminal may be designed to have a restoration data/replacement data storage unit. Then, restoration data and replacement data may be recorded in each storage unit in parallel to the playback process.

In this case, the restoration data storage unit and restoration data/replacement data storage unit can be employed as buffers used when data acquisition from the content distribution server is not steady. Also, the playback terminal is capable of, in subsequent content playbacks, reading partial content data and replacement content data from the restoration data storage unit and the restoration data/replacement data storage unit without communicating with the content distribution server.

Note that, in the case where reproduction of content data is not allowed because of a copyright protection mechanism or the like, it is effective to have a structure where partial content data is not recorded in the playback terminal, as in the case of Embodiments 3 and 6. Therefore, the playback terminal may be designed to switch whether to record partial content data or replacement content data in accordance with controls of the copyright protection mechanism on the content data.

(15) In Embodiments 1-6 above, the medium ID is recorded in the recording medium; however, the present invention is not limited to this case. For example, the content ID may be used in place of the medium ID. Herewith, the present invention can be implemented also in the case where the medium ID is not recorded in the recording medium.

(16) In Embodiments 1-6 above, the restoration data storage unit and the restoration data/replacement data storage unit are components provided inside the playback terminal, and the terminal information storage unit and the content storage unit are components provided inside the content distribution server.

However, in the present invention, these storage units do not have to be provided inside each apparatus, and may be provided externally.

(17) In Embodiments 1-6 above, the same format is used for all of the content ID and playback location information recorded in the recording medium, the content ID and playback location information of partial content data delivered from the content distribution server and the content ID and playback location information of replacement content data delivered from the content distribution server.

A different format may be used respectively for content data, partial content data and replacement content data. Note however that, in this case, content playback is interrupted in the middle unless differences in the formats are absorbed at the time of playback. Accordingly, in the case of using different formats, an appropriate structure of the playback terminal needs to be devised. For example, the data obtaining unit and decoding data control unit may be provided with a function of interpreting respective formats of content data, partial content data and replacement content data and outputting content seamlessly.

Also division units of content data, partial content data and replacement content data do not have to be the same. They may be divided into different units. Note however that, also in this case, an appropriate structure of the playback terminal needs to be devised. For example, the data acquisition unit and decoding data control unit may be provided with a function of adjusting the playback location of partial content data and replacement content data in accordance with a location of failure in reading content data and a location for which the necessity of acquiring replacement content data is determined.

(18) In the present invention, as to partial content data and replacement content data delivered to the playback terminal from the content distribution server, controls may be imposed in a manner that only specific data is allowed to be delivered and delivery of other data is not allowed at any given time.

Here, as criteria for allowing which data to be or not to be delivered, the image quality and value of the content (for example, a climax scene in the case of a movie) may be used. In this case, partial content data and replacement content data not allowed to be delivered do not have to be recorded in the content storage unit of the content distribution server.

(19) In Embodiments 1-6 above, the content data recorded in the recording medium and the partial content data delivered by the content distribution server are the same data; however, the present invention is not limited to this case.

For example, they may have the same content but have different image or audio qualities. That is, they may be any kinds of data as long as there is some correspondence between content data and partial content data.

When image or audio quality of partial content data is set lower than that of content data, the system of the present invention can be realized even if the communication rate of the communication channel is low. Also the amount of partial content data recorded can be reduced, and the time necessary for acquisition of partial content data can also be shortened.

Partial content data delivered by the content distribution server may have different content from content data recorded in the recording medium. For example, an image indicating failure of the recording medium or content including contact information at the time of the failure may be delivered to the playback terminal from the content distribution server and then displayed on the playback terminal.

(20) In Embodiments 1-6 above, the playback terminal acquires partial content data and replacement content data from the content distribution server to which the playback terminal is connected via a communication channel; however, the present invention is not limited to this case.

For example, the playback terminal may acquire partial content data and replacement content data from a second recording medium on which the partial content data and replacement content data are recorded, or may acquire such data from both the content distribution server and second recording medium.

In this case, the second recording medium may be a hard disk provided in the playback terminal, or may be a portable recording medium. More specifically speaking, the case may be considered in which the playback terminal reads partial content data recorded in an SD card, in place of content data for a location of failure in reading from the BD-ROM. Then, the partial content data read from the SD card may be recorded in the hard disk of the playback terminal.

In the case where there is a difference in storage capacity between the recording medium (content data is recorded therein) of the respective embodiments above and the second recording medium (partial content data or replacement content data is recorded therein), content data, partial content data and replacement content data have respectively a different image or audio quality, as shown in Modification (19).

(21) In Embodiments 4-6 above, the content replacement table and content replacement table expiration data are recorded in advance in the recording medium, and the playback terminal reads the content replacement table and content replacement table expiration data from the recording medium.

However, the present invention is not limited to this structure. It is not essential for the content replacement table and content replacement table expiration data are recorded in the recording medium. The content replacement table and content replacement table expiration data may be recorded in the content distribution server.

In the case where the content replacement table and content replacement table expiration data are not recorded in the recording medium, the playback terminal may be designed to acquire them from the content distribution server.

In addition, the replacement conditions described in Embodiments 4-6 above are mere examples. That is, the replacement conditions of the present invention are not limited to the date and time of content playback and the number of content playback times. The playback apparatus of the present invention is capable of determining the necessity of acquiring replacement content data based on various replacement conditions.

Also when the date and time of content playback and the number of content playback times are used as replacement conditions, the present invention is not limited to the case where the necessity of content data replacement is determined using separately the playback date and time and the number of playback times, which is the case of Embodiments 4-6. That is, both the playback date and time and the number of playback times may be used to determine the necessity of content data replacement.

(22) In Embodiments 4-6 above, the system may be designed to allow the user to choose which one of content data and replacement content data to be played back.

In addition, in the present invention, there may be multiple pieces of replacement content data with respect to one playback location of a single content.

In the case where there are multiple pieces of replacement content data with respect to one playback location of a single content, an ID for identifying each piece of replacement content data may be attached. Here, the playback terminal acquires the multiple pieces of content data from the content distribution server and records therein these pieces in correspondence with IDs. At the time of content playback, the playback terminal may allow the user to choose which one of the multiple pieces of replacement content data to be played back. Alternatively, as in Embodiments 4-6 above, a piece of replacement content data to be played back may be chosen using the content replacement table.

(23) Specifically speaking, each apparatus above is a computer system composed of a microprocessor, ROM, RAM, a hard-disk unit and the like. A computer program is stored in the RAM or hard-disk unit. The microprocessor operates according to the computer program, and thereby each apparatus fulfills its functions. Here, the computer program is structured by combining multiple instruction codes indicating commands to the computer to achieve predetermined functions.

(24) Part or all of the components making up the above individual apparatuses may be assembled as a single system LSI (Large Scale Integration). The system LSI is an ultra-multifunctional LSI produced by integrating multiple components on one chip, and more specifically, is a computer system composed of a microprocessor, ROM, RAM, and the like. A computer program is stored in the RAM. The microprocessor operates according to the computer program, and thereby the system LSI accomplishes its function.

In addition, individual components making up each apparatus above may respectively be made into discrete chips, or part or all of the components may be made into one chip.

Although referred to here as the system LSI, it may be also referred to as IC, LSI, super LSI, or ultra LSI, depending on the degree of integration. In addition, the method for assembling integrated circuits is not limited to LSI, and a dedicated communication circuit or a general-purpose processor may be used to achieve this. A FPGA (Field Programmable Gate Array), which is programmable after the LSI is produced, or a reconfigurable processor, which allows reconfiguration of the connection and setting of circuit cells inside the LSI, may be used.

If technology for forming integrated circuits that replaces LSIs is introduced, owing to advance in semiconductor technology or different technology derived therefrom, the integration of functional blocks may naturally be accomplished using such technology. There is also a possibility of application of biotechnology to the integrated circuit technology.

(25) Each element, part or all of the components making up the above individual apparatuses may be assembled as an IC card detachable from a device, or as a single module. The IC card/module is a computer system composed of a microprocessor, ROM, RAM, and the like. The IC card/module may include therein the above-mentioned ultra-multifunctional LSI. The microprocessor operates according to a computer program, and thereby the IC card/module accomplishes its function. The IC card/module may be tamper resistant.

(26) The present invention may be a method of accomplishing the above-described system. The present invention may be a computer program that achieves the method by a computer, or may be a digital signal representing the computer program.

The present invention may also be achieved by a computer-readable recording medium, such as a flexible disk, a hard disk, a CD-ROM, an MO disk, a DVD, a DVD-ROM, a DVD-RAM, a BD-ROM, or a semiconductor memory, on which the above-mentioned computer program or digital signal is recorded. The present invention may also be the digital signal recorded on such a storage medium.

The present invention may also be the computer program or digital signal to be transmitted via networks, as represented by telecommunications, wire/wireless communications, and the Internet, or via data broadcasting.

The present invention may also be a computer system having a microprocessor and memory, wherein the memory stores the computer program and the microprocessor operates according to the computer program.

The computer program or digital signal may be recorded on the above storage medium and transferred to an independent computer system, or alternatively, may be transferred to an independent computer system via the above network. Then, the independent computer system may execute the computer program or digital signal.

(27) The present invention includes a structure in which two or more of the above embodiment and modifications are combined.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A playback apparatus comprising:
a reading unit operable to read, from a portable recording medium, part of 1^{st} content recorded thereon;
a storage unit operable to store therein 2^{nd} content pertaining to the part of 1^{st} content;
a judgment unit operable to make a suitability judgment on whether the part of 1^{st} content is suitable for playback; and
a playback unit operable to (i) play back the part of 1^{st} content in a case where the suitability judgment is made affirmatively, and (ii) play back the 2^{nd} content in a case where the suitability judgment is made negatively.

2. The playback apparatus of claim 1 further comprising:
a detection unit operable to, during playback of the 1^{st} content, detect failure of the reading unit to read the 1^{st} content; and
an acquisition unit operable to, in a case where the failure is detected, externally acquire data corresponding to a location, within the 1^{st} content, at which the failure has occurred, and record the data in the storage unit as the 2^{nd} content.

3. The playback apparatus of claim 2 further comprising:
a replacement condition storage unit operable to store therein a replacement condition indicating a condition in which the part of 1^{st} content is to be replaced, wherein
the acquisition unit further makes a playback-state judgment on whether playback state of the 1^{st} content meets the replacement condition, and externally acquires replacement data corresponding to the part of 1^{st} content in a case where the playback-state judgment is made affirmatively and records the replacement data in the storage unit as 3^{rd} content, and
the playback unit further plays back the 3^{rd} content in the case where the suitability judgment is made negatively.

4. The playback apparatus of claim 3, wherein
the replacement condition storage unit further stores therein an expiration time of the replacement condition in correspondence with the replacement condition, and
the playback apparatus further comprising:
an update unit operable to judge validity of the replacement condition based on the expiration time, and externally acquire a new replacement condition in a case where the replacement condition is determined invalid and update the replacement condition stored in the replacement condition storage unit with the new replacement condition.

5. The playback apparatus of claim 1 further comprising:
a replacement condition storage unit operable to store therein a replacement condition indicating a condition in which the part of 1^{st} content is to be replaced; and
an acquisition unit operable to make a playback-state judgment on whether playback state of the 1^{st} content meets the replacement condition, and externally acquire replacement data corresponding to the part of 1^{st} content in a case where the playback-state judgment is made affirmatively and record the replacement data in the storage unit as the 2^{nd} content.

6. The playback apparatus of claim 5, wherein
the replacement condition includes a condition indicating an end of a playback available period with respect to the part of 1^{st} content, and
the acquisition unit makes the playback-state judgment affirmatively in a case where playback date and time, which are the playback state, exceed the end of the playback available period.

7. The playback apparatus of claim 5, wherein
the replacement condition indicates an available number of times that the part of 1^{st} content can be played back, and
the acquisition unit makes the playback-state judgment affirmatively in a case where a number of playback times of the 1^{st} content, which is the playback state, exceeds the available number of times.

8. The playback apparatus of claim 5, wherein
the replacement condition storage unit further stores therein an expiration time of the replacement condition in correspondence with the replacement condition, and
the playback apparatus further comprising:
an update unit operable to judge validity of the replacement condition based on the expiration time, and externally acquire a new replacement condition in a case where the replacement condition is determined invalid and update the replacement condition stored in the replacement condition storage unit with the new replacement condition.

9. The playback apparatus of claim 8, wherein
prior to playback of the 1^{st} content performed by the playback unit,
the update unit judges the validity of the replacement condition, and externally acquires the new replacement condition in the case where the replacement condition is determined invalid and update the replacement condition stored in the replacement condition storage unit with the new replacement condition, and
the acquisition unit makes the playback-state judgment using the replacement condition stored in the replacement condition storage unit and acquires the 2^{nd} content.

10. The playback apparatus of claim 5, wherein
the judgment unit makes the suitability judgment negatively in a case where the 2^{nd} content has been stored in the storage unit.

11. The playback apparatus of claim 1, wherein
the judgment unit makes the suitability judgment negatively in a case where the 2^{nd} content has been stored in the storage unit.

12. The playback apparatus of claim 1 further comprising:
a detection unit operable to, before playback of the 1^{st} content, detect failure of the reading unit to read the 1^{st} content; and
an acquisition unit operable to, in a case where the failure is detected, externally acquire the 2^{nd} content corresponding to a location, within the 1^{st} content, at which the failure has occurred, and record the 2^{nd} content in the storage unit, wherein
the judgment unit makes the suitability judgment negatively in a case where the 2^{nd} content has been stored in the storage unit, and
the playback unit starts playback of the 1^{st} content after the acquisition unit completes the acquisition of the 2^{nd} content.

13. A playback apparatus comprising:
a reading unit operable to read, from a portable recording medium, part of 1^{st} content recorded thereon;
a judgment unit operable to make a suitability judgment, during playback of the 1^{st} content, on whether the part of 1^{st} content is suitable for playback;
a receiving unit operable to receive 2^{nd} content pertaining to the part of 1^{st} content from an external server in a case where the suitability judgment is made negatively; and
a playback unit operable to (i) play back the part of 1^{st} content in a case where the suitability judgment is made affirmatively, and (ii) play back the received 2^{nd} content in a case where the suitability judgment is made negatively.

14. The playback apparatus of claim 13 further comprising:
a detection unit operable to, during the playback of the 1^{st} content, detect failure of the reading unit to read the 1^{st} content, wherein
the judgment unit makes the suitability judgment negatively in a case where the failure is detected.

15. The playback apparatus of claim 13 further comprising:
a replacement condition storage unit operable to store therein a replacement condition indicating a condition in which the part of 1^{st} content is to be replaced, wherein
the judgment unit makes, during the playback of the 1^{st} content, a playback-state judgment on whether playback state of the 1^{st} content meets the replacement condition, and makes the suitability judgment negatively in a case where the playback-state judgment is made affirmatively.

16. A distribution server for delivering data to a playback apparatus that plays back 1^{st} content recorded on a portable recording medium, the distribution server comprising:
a storage unit storing therein 2^{nd} content pertaining to the 1^{st} content;
a receiving unit operable to receive, from the playback apparatus, a data request that includes location information indicating a location within the 1^{st} content; and
a transmitting unit operable to transmit, to the playback apparatus, part of the 2^{nd} content corresponding to part of the 1^{st} content, the part of the 1^{st} content including the location indicated by the location information.

17. The distribution server of claim 16 further comprising:
a judgment unit operable to make a transmission judgment on whether to transmit the part of the 2^{nd} content to the playback apparatus, wherein
the transmitting unit transmits the part of the 2^{nd} content to the playback apparatus only when the transmission judgment is made affirmatively.

18. The playback apparatus of claim 17, wherein
the data request includes a piece of apparatus identification information used for identifying the playback apparatus and a piece of medium identification information used for identifying the recording medium,
the storage unit further stores the-rein one or more pieces of medium identification information respectively used for identifying one or more recording media used by the playback apparatus, the one or more pieces of medium identification information being stored in correspondence with the piece of apparatus identification information, and
the judgment unit makes the transmission judgment affirmatively in a case where the piece of medium identification information included in the data request is stored in the storage unit in correspondence with the piece of apparatus identification information.

19. The distribution server of claim 17, wherein
the data request includes a piece of apparatus identification information used for identifying the playback apparatus,
the storage unit further stores therein a data size of data having previously been transmitted to the playback apparatus, the data size being stored in correspondence with the piece of apparatus identification information, and
the judgment unit makes the transmission judgment affirmatively in a case where the data size is equal to or less than a predetermined value.

20. The distribution server of claim 16, wherein
the storage unit further stores therein a replacement condition that indicates a condition in which the part of 1^{st} content is to be replaced and corresponds to playback state of the 1^{st} content, and
the transmitting unit further transmits the replacement condition to the playback apparatus.

21. The distribution server of claim 16 further comprising:
a reception unit operable to receive an update instruction for updating the 2^{nd} content in the storage unit; and
a data update unit operable to update the 2^{nd} content in response to the update instruction.

22. A playback method used in a playback apparatus, wherein
the playback apparatus includes a storage unit operable to store therein 2^{nd} content pertaining to part of 1^{st} content, and
the playback method comprising the steps of:
reading, from a portable recording medium, the part of 1^{st} content recorded thereon;
making a judgment on whether the part of 1^{st} content is suitable for playback; and
playing back the part of 1^{st} content in a case the judgment is made affirmatively, and playing back the 2^{nd} content in a case where the judgment is made negatively.

23. A computer-readable recording medium on which a computer program used on a playback apparatus is recorded, wherein
the playback apparatus includes a storage unit operable to store therein 2^{nd} content pertaining to part of 1^{st} content, and
the computer program including the steps of:
reading, from a portable recording medium, the part of 1^{st} content recorded thereon;
making a judgment on whether the part of 1^{st} content is suitable for playback; and
playing back the part of 1^{st} content in a case where the judgment is made affirmatively, and playing back the 2^{nd} content in a case where the judgment is made negatively.

24. An integrated circuit comprising:
a reading unit operable to read, from a portable recording medium, part of 1^{st} content recorded thereon;
a storage unit operable to store therein 2^{nd} content pertaining to the part of 1^{st} content;
a judgment unit operable to make a judgment on whether the part of 1^{st} content is suitable for playback; and
a playback unit operable to (i) play back the part of 1^{st} content in a case where the judgment of the judgment unit is made affirmatively, and (ii) play back the 2^{nd} content in a case where the judgment of the judgment unit is made negatively.

25. A distribution method used in a distribution server that delivers data to a playback apparatus that plays back 1^{st} content recorded on a portable recording medium, wherein
the distribution server includes a storage unit storing therein 2^{nd} content pertaining to the 1^{st} content, and
the distribution method comprising the steps of:
receiving, from the playback apparatus, a data request that includes location information indicating a location within the 1^{st} content; and
transmitting, to the playback apparatus, part of the 2^{nd} content corresponding to part of the 1^{st} content, the part of the 1^{st} content including the location indicated by the location information.

26. A computer-readable recording medium on which a computer program used on a distribution server is recorded, the distribution server delivering data to a playback apparatus used for playing back 1^{st} content recorded on a portable recording medium, wherein
the distribution server includes a storage unit storing therein 2^{nd} content pertaining to the 1^{st} content, and
the computer program includes the steps of:
receiving, from the playback apparatus, a data request that includes location information indicating a location within the 1^{st} content; and
transmitting, to the playback apparatus, part of the 2^{nd} content corresponding to part of the 1^{st} content, the part of the 1^{st} content including the location indicated by the location information.

27. An integrated circuit used in a distribution server that distributes data to a playback apparatus used for playing back 1^{st} content recorded on a portable recording medium, the integrated circuit comprising:
a storage unit storing therein 2^{nd} content pertaining to the 1^{st} content;
a receiving unit operable to receive, from the playback apparatus, a data request that includes location information indicating a location within the 1^{st} content; and
a transmitting unit operable to transmit, to the playback apparatus, part of the 2^{nd} content corresponding to part of the 1^{st} content, the part of the 1^{st} content including the location indicated by the location information.
